(19) United States
(12) Patent Application Publication
(10) Pub. No.: US 2008/0248354 A1
(43) Pub. Date: Oct. 9, 2008

(54) Enzyme Electrode, and Device, Sensor, Fuel Cell and Electrochemical Reactor Employing the Enzyme Electrode

(75) Inventors: Wataru Kubo, Inagi-shi (JP); Tsuyoshi Nomoto, Tokyo (JP); Tetsuya Yano, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/571,687

(22) PCT Filed: Jul. 22, 2005
(86) PCT No.: PCT/JP2005/013896

§ 371 Date: Jun. 23, 2008

(30) Foreign Application Priority Data
Jul. 23, 2004 (JP) 2004-216287
Jan. 31, 2005 (JP) 2005-023520

(51) Int. Cl. H01M 8/02; G01N 27/26; B05D 5/12; H01M 4/02

(52) U.S. Cl. 429/27; 204/403.14; 204/242; 427/58

(57) ABSTRACT

An enzyme electrode has a conductive member and an enzyme, wherein the conductive member has a porous structure, and the enzyme is immobilized through a carrier in pores constituting the porous structure. An enzyme electrode device, comprises the enzyme electrode, and wiring connected to the conductive member of the enzyme electrode.

### TECHNICAL FIELD

The present invention relates to an enzyme electrode. More specifically, the present invention relates to an enzyme electrode having a carrier and an enzyme immobilized on an electroconductive member having voids. The present invention relates further to a process for producing the enzyme electrode, a device employing the enzyme electrode, and uses thereof.

### BACKGROUND ART

An enzyme, a proteinaceous biocatalyst formed in a living cell, is highly active under mild conditions in comparison with ordinary catalysts. Further, the enzyme is highly specific to a substrate undergoing an enzymatic reaction, and catalyzes a specific reaction of a specific substrate. Ideally, the enzyme having such properties will enable preparation of a highly selective electrode having a low overvoltage for a redox reaction on the electrode. However, the active centers of most redox enzymes (oxidoreductases) are usually enclosed in a deep interior of a three-dimensional structure of glycoprotein, so that direct high-speed electron transfer is difficult between the oxidoreductase and the electrode. To cancel the difficulty, a method is disclosed which connects electronically the enzyme with the electrode with interposition of a substance called a mediator. The connection of the oxidoreductase with the electrode through the mediator enables control of an enzymatic reaction by the electrode potential and performance as an energy conversion element. In particular, a device called a biofuel cell has a feature of a biological catalyst, unlike an ordinary fuel cell employing a metallic catalyst like platinum: in principle, any substrate utilized by a living body can be used in the biofuel cell, including sugars, alcohols, amines, and hydrogen on a negative electrode; and oxygen, nitrate ions, and sulfate ions on a positive electrode. In the early stage of the development, the enzyme and the mediator are dissolved in an electrolyte solution for simplicity of the experiment system and for freedom of the transfer thereof. Later, methods of immobilization thereof on the electrode are disclosed for improvement of the efficiency, prevention of leakage into the system, and continuous and long-term use of the electrode. In one method, a carrier is used for immobilizing an enzyme and a mediator on a conductive member. Generally, chemical or electrostatic immobilization of an enzyme and a mediator on a carrier retains effectively the enzyme and the mediator in comparison with immobilization by physical adsorption, preventing leakage out of the system, and enabling repeated use of the enzyme electrode.

An index of the performance of the enzyme electrode is an electric current density, which is an electric current intensity relative to a projected area of a conductive member. The higher current density enables improvement in detection sensitivity, simplification of a measurement portion, and miniaturization of detector portion when used in a sensor based on current intensity detection; improvement of output when used as an electrode of a fuel cell; and shortening of a reaction time when used as an electrochemical reactor, advantageously. The current density of the enzyme electrode can be increased by increase of a turnover number (a number of substrate molecules converted by an enzyme in a unit time), improvement of electron transfer rate and efficiency between the mediator and the electrode, the enzyme-holding density (the amount of the enzyme per projected area of the conductive member), and so forth.

A typical method for immobilization by use of a carrier is an entrapping immobilization (FIG. 1). In this method, an enzyme is entrapped in a carrier such as a polymer, and the carrier is immobilized on a surface of a conductive member. FIG. 1 is a sectional view showing schematically an entrapping immobilization of an enzyme. In FIG. 1, enzyme 2 is immobilized by entrapping in a layer of carrier 3 on a base plate 1 constituted of a conductive member to cause an electric charge flow as shown for example by the numeral 4. In this entrapping immobilization method, the charge formed by an enzyme/substrate reaction is taken out by the mediator in the carrier, transferred by electron hopping between the mediator molecules to the vicinity to the conductive member, and finally detected by transfer of the electric charge between the mediator and the conductive member. Generally, simple increase of amount of the enzyme on the carrier for increase of the enzyme held by the carrier for the projected area of the conductive member will lower the electron transfer rate between the enzyme/carrier, so that the increase of the current density is limited. In contrast, in the entrapping immobilization employing a mediator, even when the enzyme is immobilized in a density higher than the value of the enzyme occupation area divided by effective surface area of the conductive member, the electric charge can be transferred between the electrode and the enzyme through the carrier. Therefore, by increasing the amount of the immobilized enzyme and increasing the thickness of the carrier layer, the enzyme immobilization density per projected area of the conductive member (the amount of the immobilized enzyme in the carrier-containing layer) can be increased. Generally, however, since electron diffusion is slow in the carrier-containing layer, the velocity of electron diffusion through the carrier is limited and the electric charge transfer efficiency is lowered at a carrier-immobilized enzyme layer larger than a certain thickness. Therefore the carrier immobilization layer thickness is preferably less than a certain limit, so that the increase of the current density by increase of the immobilized enzyme per projected area of the conductive member is limited. A use of enzyme electrode utilizing the entrapping immobilization for a fuel cell is disclosed in U.S. Pat. No. 6,531,239 (Heller et al.) in which the enzyme electrode is prepared by immobilization of an enzyme by a polymer containing an mediator in the molecule.

The enzyme immobilization density can be increased effectively by increasing the effective surface area of the electrode. A typical method therefore is physical adsorption of an enzyme on a conductive member composed of a carbonaceous material particles and a binder polymer (FIG. 2). In FIG. 2, the enzyme electrode has a layer in which enzyme 2 is immobilized by use of binder polymer 6 on particulate carbon 5, the layer being placed on the surface of base plate 1. In this enzyme electrode, for example, electric charge can flow through particle boundaries 7 of carbon particles 5 as indicated by arrow mark 4. In this enzyme electrode, the resistance at contact point 7 between the carbon particles is high, and the total resistance increases with the thickness of the conductive member to increase the internal resistance of the enzyme electrode to lower the performance of the enzyme electrode. Therefore, the conductive member is preferably used in a thickness smaller than a certain thickness, which limits the increase of the current density by increase of the amount of the immobilized enzyme per projection area of the conductive member (increase by enlargement of the effective surface area of the electrode). Furthermore, in this enzyme electrode, no carrier is used differently from the entrapping immobilization electrode, resulting in low enzyme-retaining ability and limitation in repeated use of the enzyme electrode. Such an enzyme electrode is disclosed in U.S. Pat. No. 4,970,145 (Bennetto et al.) in which the conductive member is formed by immobilizing the carbon particles and the platinum-type metal particles together by a resin.

### DISCLOSURE OF THE INVENTION

In the aforementioned entrapping immobilization, the amount of the immobilized enzyme can be increased by increasing the thickness of the enzyme immobilization layer in which method an enzyme is immobilized in a layer containing a carrier without impairing the electronic connection between the enzyme and the conductive member. Generally, however, since the carrier has a low electron diffusion coefficient, the charge transfer efficiency drops above a certain thickness of the enzyme-immobilization layer. Therefore, the enzyme immobilization layer is preferably thinner than a certain level, and the increase of the enzyme immobilization density relative to the projected area of the enzyme electrode is limited. On the other hand, in the method of physical adsorption of the enzyme on an above-mentioned conductive member composed of a carbonaceous material and a binder polymer, the conductive member has preferably a thickness not larger than a certain limit since the resistance between the carbonaceous material particles is high and this resistance increases with the thickness of the enzyme-immobilizing layer containing the conductive member and the enzyme. Furthermore, in this method of using carbonaceous particles, a binder polymer is used for immobilizing the enzyme without using the carrier unlike in the entrapping immobilizing method, so that the enzyme-retaining ability is low and such type of enzyme electrode preferably is used for disposal type sensors. Therefore, this immobilization method is limited in improvement in electric charge transfer efficiency and expansion of the application fields.

The present invention intends to provide an enzyme electrode that can give a higher electric current density by increasing the enzyme immobilization density.

According to an aspect of the present invention, there is provided an enzyme electrode having a conductive member and an enzyme, wherein the conductive member has a porous structure, and the enzyme is immobilized through a carrier in pores constituting the porous structure.

The size of the pores on the surface side of porous structure of the conductive member is preferably larger than the size of the pores in the interior of the conductive member.

The enzyme electrode preferably contains a mediator for promoting transfer of electrons between the enzyme and the conductive member.

The conductive member preferably comprises at least one of materials selected from metals, conductive polymers, metal oxides, and carbonaceous materials.

The enzyme is preferably a redox enzyme.

The conductive member preferably has at least two working faces opposing each other, and a liquid is permeable through the numerous voids between the two faces.

According to another aspect of the present invention, there is provided an enzyme electrode device, comprising the directly above-mentioned enzyme electrode, and wiring connected to the conductive member of the enzyme electrode.

In the enzyme electrode device, plural enzyme electrodes are preferably laminated with the working faces thereof opposed.

According to still another aspect of the present invention, there is provided a sensor, employing the enzyme electrode device as a detector for detecting a substance.

According to a further aspect of the present invention, there is provided a fuel cell having an anode and a cathode, and a region for retaining an electrolytic solution between the anode and cathode, wherein at least one of the anode and the cathode is the enzyme electrode device.

According to a further aspect of the present invention, there is provided an electrochemical reactor having a reaction region, and an electrode for causing an electrochemical reaction of a source material introduced to the reaction region, wherein the electrode is the enzyme electrode device.

According to a further aspect of the present invention, there is provided a process for producing an enzyme electrode, comprising steps of:

providing a conductive member having numerous voids communicating with each other and communicating with the outside, and a carrier for immobilizing an enzyme for transfer of electrons to or from the conductive member; and
immobilizing the enzyme in the voids with immobilization of the carrier in the voids.

According to a further aspect of the present invention, there is provided a fuel cell, wherein an anode and a cathode have a porous structure, and at least one of the anode and the cathode is an enzyme electrode having an enzyme in pores constituting the porous structure.

The size of the pores on the surface side of the enzyme structure is preferably larger than the size of the pores in the interior of the enzyme electrode.

### EFFECT OF THE INVENTION

According to the present invention, an enzyme electrode can be provided which immobilizes an enzyme in a conductive member having numerous voids communicating with the outside of a conductive member having a large specific surface area at a high enzyme immobilization density by use of a carrier. In particular, in formation of a sheet-shaped or layered enzyme electrode, the electrode can be made thicker without increase of the interspace between the enzyme and the conductive member without lowering the electron transfer efficiency between the enzyme and the conductive member.

### BRIEF DESCRIPTION OF THE DRAWINGS

FIG. 1 is a schematic drawing of an enzyme electrode immobilizing an enzyme by entrapping.

FIG. 2 is a schematic drawing of an enzyme electrode employing carbon particles as a member.

FIG. 3 is a schematic drawing of an enzyme electrode employing a conductive member having voids.

FIG. 4 shows a structure of a three-electrode cell.

FIG. 5A and FIG. 5B show dependence of an electric current density on a substrate concentration in a sensor.

FIGS. 6A and 6B show dependence of an electric current density on a substrate concentration in a sensor.

FIG. 7 shows a structure of a two-electrode cell.

FIG. 8 shows a structure of a five-layer flow cell.

FIGS. 9A, 9B, 9C and 9D show examples of porous structure of the conductive members applicable in the present invention.

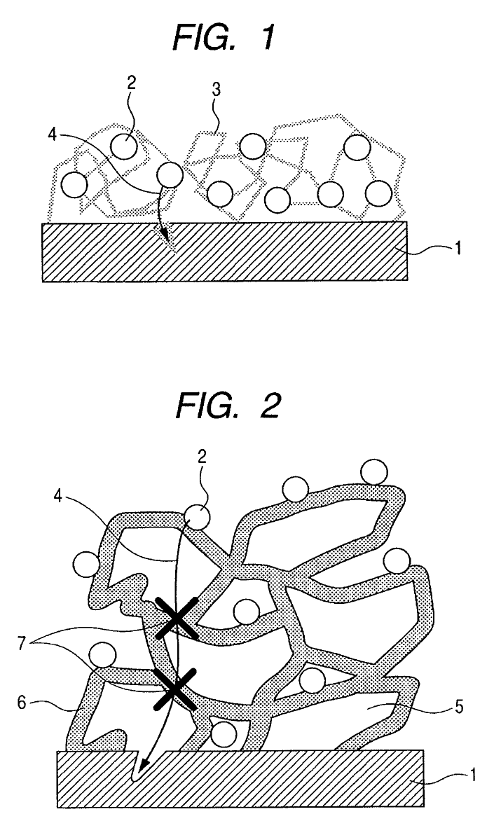

### BEST MODE FOR CARRYING OUT THE PRESENT INVENTION

Preferred embodiments of the present invention are described below in detail.

An enzyme electrode of a preferred embodiment of the present invention comprises a conductive member having voids; and an enzyme for transferring electrons to or from the conductive member and a carrier for immobilizing the enzyme in the voids. This electrode is capable of immobilizing the enzyme on the conductive member stably by use of the carrier, and is capable of immobilizing the enzyme at a higher immobilization density for the effective surface area of the conductive member to improve the stability and the current density. This enzyme electrode has at least two working faces at the front side and the back side, and a liquid is permeable between the faces through numerous communicating voids in the conductive member. For example, with a sheet-shaped (or film-shaped or layer-shaped) conductive member, openings of the voids are formed on the two faces (a front face and a back face) as the working face (contact face for contact with a liquid containing a component capable of interaction with the electrode), and the liquid is permeable from one operating face to the other operating face. The void openings may be formed also on a lateral side of the conductive member of the above shape to allow permeation of the liquid from the lateral face to the other face.

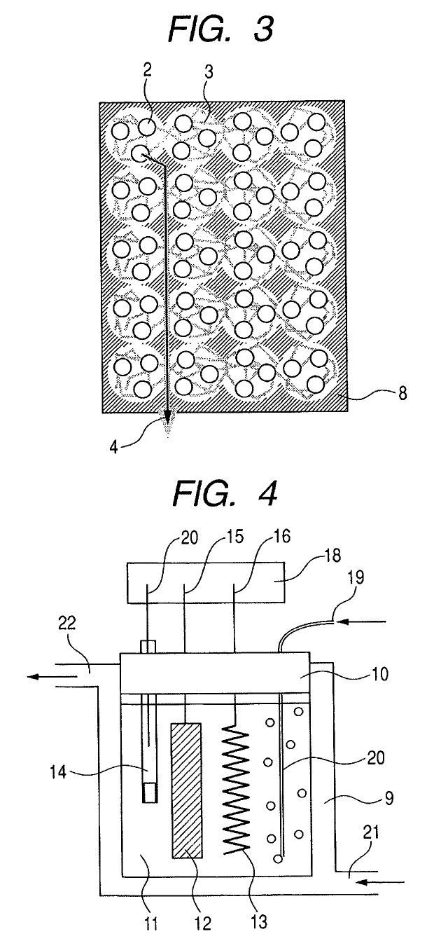

Further, the thickness of the enzyme electrode can be increased without increasing the distance between the enzyme and the conductive member and with little increase of the entire resistance of the electrode by use of a void-containing conductive member having a large effective area relative to its projected area, and high conductivity, for obtaining increased current density. FIG. 3 is a schematic drawing (a sectional view) of an enzyme electrode having a void-containing conductive member; and an enzyme for transferring electrons to or from the conductive member, and a carrier for immobilizing the enzyme in the voids. In the enzyme electrode of FIG. 3, enzyme 2 is immobilized by carrier 3 inside the voids of conductive member 8. The electric charge can be transferred, for example, as shown by arrow mark 4. The voids in FIG. 3 communicate with the outside through other voids not shown in the drawing

The enzyme electrode connected with a wiring for electron transfer provides an enzyme electrode device useful for various application fields. This device employs the above enzyme electrode as a reaction electrode for an enzyme electrode reaction: the electrode may be constituted of a single layer or multiple layers of the above-mentioned sheet-shaped (or film-shaped or layer-shaped) enzyme electrode. In the plural enzyme electrode layers, the electrode layers may be arranged in lamination such that the front face of the one electrode layer confronts the reverse face of the other electrode layer. The multilayer electrode may be constituted of the same characteristic or may be constituted of a combination of enzyme electrodes of different characteristics. For example, similarly as a fuel cell mentioned later, the anodes and the cathodes are arranged alternately. This type of device can satisfy the requirement of the electric current, voltage, and output by changing the electrode structure from a monolayer structure to a multilayer structure. The enzyme, the catalyst constituting the enzyme electrode, has a high substrate selectivity in comparison with a noble metal catalyst (e.g., platinum) employed generally in electrochemical fields. Therefore, the reaction substances on the anode and the cathode need not be separated by a partition, which can simplify the device. Further, the enzyme electrode employed in this device has continuous voids through the conductive member of the electrode. Therefore, an electrolyte solution can flow through the voids without providing an additional flow channel, whereby the device can be simplified. Further, a mechanism for promoting the penetration of the electrolyte solution provided outside the device can increase the supply of the substrate, whereby the electric current density can be increased.

A sensor, a preferred embodiment of the present invention, employs a device having a monolayer or multilayer enzyme electrode as a detector portion for detecting a substance. In a typical constitution of the sensor, an enzyme electrode is employed as the working electrode in combination with a counter electrode, and with a reference electrode if necessary, whereby an electric current is detected by the enzyme electrode (by the function of the enzyme immobilized on the enzyme electrode) to detect a substance in a solution in contact with the electrodes. The constitution of the sensor is not limited insofar as the enzyme electrode is capable of the detection. FIG. 4 shows an example of the sensor. In FIG. 4, the sensor comprises anode 12, platinum wire electrode 13, and silver-silver chloride reference electrode 14. The respective electrodes are connected by leading wires 15,16,20 to potentiostat 18. This sensor is placed in electrolyte solution 11 in water-jacketed cell 9 tightly closable with cover 10. A substrate in the electrolyte can be detected by applying a potential to the working electrodes and measuring the steady-state current. When the measurement should be conducted in an inert atmosphere, an inert gas like nitrogen is introduced from gas inlet 19 of gas tube 20. The temperature of the measurement solution can be controlled by feeding a temperature-controlling liquid from temperature controlling liquid inlet 21 to temperature controlling liquid outlet 22. This sensor has high substrate selectivity owing to the enzyme employed as the electrode reaction catalyst, and achieves a high current density owing to the enzyme electrode employing a void-containing conductive member, whereby the detection reactor can be simplified, or the detector portion can be miniaturized. This sensor is capable of detecting a substance corresponding to the substrate of the enzyme of the enzyme electrode, being useful, for example, as a glucose sensor, a fructose sensor, a galactose sensor, an amino acid sensor, an amine sensor, a cholesterol sensor, an alcohol sensor, a lactic acid sensor, an oxygen sensor, a hydrogen peroxide sensor, or the like. More specific application examples are a sensor for measuring a glucose concentration or lactic acid concentration in blood, a sensor for measuring a sugar concentration in a fruit, and a sensor for measuring an alcohol concentration in exhaled breath.

A fuel cell, another preferred embodiment of the present invention, employs a device having a monolayer or multilayer enzyme electrode as at least one of the anode and cathode thereof. In the multilayer constitution, the anodes and the cathodes may be placed in a predetermined arrangement in the lamination direction. A typical constitution of the fuel cell has a reaction vessel for holding an electrolyte solution containing a fuel material, and the anode and the cathode placed at a predetermined spacing in the reaction vessel, at least one of the anode and the cathode employing an enzyme electrode of the present invention. The fuel cell may be of a type in which an electrolyte solution is replenished or circulated, or may be of a type in which an electrolyte solution is neither replenished nor circulated. The fuel cell is not limited in the fuel, the structure, the function, and so forth, insofar as the enzyme electrode is usable. This fuel cell can give a high driving voltage by redox of a substance at a low overvoltage owing to a characteristic high activity of the employed enzyme as the catalyst for the electrode reaction. The fuel cell can give also a high electric current density by using an enzyme electrode employing a void-containing conductive member, whereby a high output and/or miniaturization of the fuel cell can be realized. FIG. 8 shows an example of the fuel cell. The fuel cell shown in FIG. 8 has an electrode unit having anodes 12 connected to anode lead wires 15 and cathodes 24 connected to cathode lead wires laminated with interposition of porous polypropylene films 23, encased in acrylic case 27. An electrolyte solution is introduced from electrolyte solution inlet 25 and is discharged from electrolyte solution outlet 26 to function as a fuel cell.

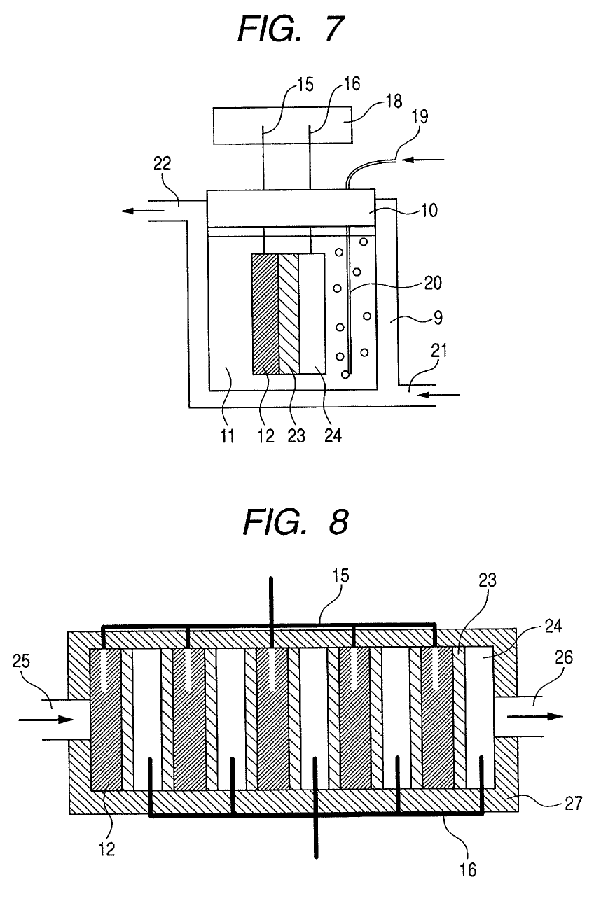

An electrochemical reactor, still another embodiment of the present invention, employs a device having a monolayer or multilayer enzyme electrode as the reaction electrode. Typically, the reactor has a pair of electrodes and optionally a reference electrode. The electrodes are placed in a reaction vessel for holding a reaction solution, and an electric current is allowed to flow between the pair of electrodes to cause an electrochemical reaction of a substance in the reaction solution to obtain an intended reaction product, a decomposition product, or the like. At least one of the pair of the electrodes is an enzyme electrode of the present invention. The kind of the reaction solution, the reaction conditions, and the constitution of the reactors are not specially limited, insofar as the enzyme electrode is usable. For example, the reactor is useful for preparation of a redox reaction product, or a decomposition product. FIG. 4 and FIG. 7 show specific examples of the constitution of the reactor. The reactor shown in FIG. 4 or 7 as the electrochemical reactor produces an intended product by application of an electric current or a voltage to cause electrochemical reaction in contrast to the aforementioned sensor or fuel cell.

The electrochemical reactor can achieve quantitativeness of the electrochemical reaction as well as high selectivity and high catalytic activity specific to the enzyme employed as the electrode reaction catalyst. Therefore, a reactor can be produced which can be operated with high selectivity, high efficiency, and high quantitativeness. This electrochemical reactor can cause selectively the reaction of a substance corresponding to the substrate of the enzyme of the enzyme electrode, being useful for oxidation of glucose, fructose, galactose, amino acids, amines, cholesterol, alcohols, lactic acid, and so forth; reduction of oxygen, hydrogen peroxide, and so forth; and the like reactions. More specific application examples include selective oxidation of cholesterol in the presence of ethanol, and reduction of oxygen at a low overvoltage.

The numerous voids in the conductive member are interconnected together in one-, two-, or three-dimensionally. The interconnection of the voids may be of two or more types. The one-dimensional void interconnection is exemplified by columnar voids; the two-dimensional void interconnection is exemplified by net-like voids; and the three-dimensional void interconnection is exemplified by sponge-like void, interstices formed in aggregation of small particles, and voids in a structural material prepared by use of the above material as a template. The voids should be large for introduction of the enzyme and flow and diffusion of the substrate substance, but should be small within the range for obtaining a sufficient ratio of the effective void surface area to the projected area of the member. The average void diameter ranges, for example, from 5 nm to 5 mm, more preferably from 10 nm to 500 μm. The conductive member should have a small thickness for flow and diffusion of the substrate through the member, but should have thickness within the range for obtaining a sufficient ratio of the effective void surface area to the projection area of the conductive member. The thickness of the void-containing conductive member ranges, for example, from 100 nm to 1 cm, more preferably from 1 μm to 5 mm. The ratio of the effective surface area to the projected area of the void-containing conductive member should be sufficiently large, for example, the ratio being 10 or more, more preferably 100 or more. The porosity of the void-containing conductive member should be sufficiently large for obtaining a high ratio of the effective void surface area to the projected area of the conductive member, and be large within the range for enabling introduction of the enzyme and the carrier and flow and diffusion of the substrate substance, but should not be excessively large for achieving the sufficient mechanical strength. The porosity ranges, for example, from 20% to 99%, more preferably from 30% to 98%. The porosity of the conductive member having an enzyme immobilized therein should be large for flow of the electrolyte solution and diffusion of the substrate substance, but should be small by filling of the enzyme. The porosity ranges for example, from 15% to 98%, more preferably from 25% to 95%.

The voids may be narrowed toward the inside from the surface of the conductive member in contact with the electrolyte solution, namely the outside surface having opening communicating with the inside voids of the electroconductive member. This type of conductive member is hereinafter referred to as a void size (e.g., pore size)-gradient conductive member having numerous voids. For holding at a high density the enzyme effective to the electrode reaction, it is effective to use conductive member having numerous voids smaller than a certain size. However, with the enzyme held at a high density, diffusion of the substrate substance to the enzyme can restrict the total electric current flow of the entire electrode, and sufficient diffusion of the substrate substance into the interior of the void-containing conductive member may not be achieved. To offset the disadvantage, use of the void size-gradient conductive member having numerous voids enables the sufficient holding density of the enzyme effective to the electrode reaction as well as sufficient diffusion of the substrate substance into the interior of the conductive member. The void size-gradient conductive member having numerous voids may be produced initially to have the void size gradient, or may be prepared by laminating conductive members having pores of different sizes. Otherwise, the member may be prepared by laminating plural members having different component compositions. The average void diameter of the void size-gradient conductive member having numerous voids ranges, for example, from 100 nm to 5 mm, more preferably from 1 μm to 1 mm in the larger void portion, and ranges from 5 nm to 500 μm in the smaller void portion. The void-size gradient region in a plate-shaped conductive member, for example, may be formed such that the size of the voids changes continuously or stepwise from one of the opposing face (front face) toward the other face (back face): in other words, voids at the back face side are smaller in size than the voids at the front face side. Otherwise, the voids may be formed to be smaller gradually from front face and the back face toward the center. The void-size gradient may be decided to meet the intended uses.

In the conductive member for the enzyme electrode of the present invention, naturally the voids may have a uniform size (or uniform porosity) in the thickness direction of the porous structure, or the voids may have a gradient distribution of the size (or porosity).

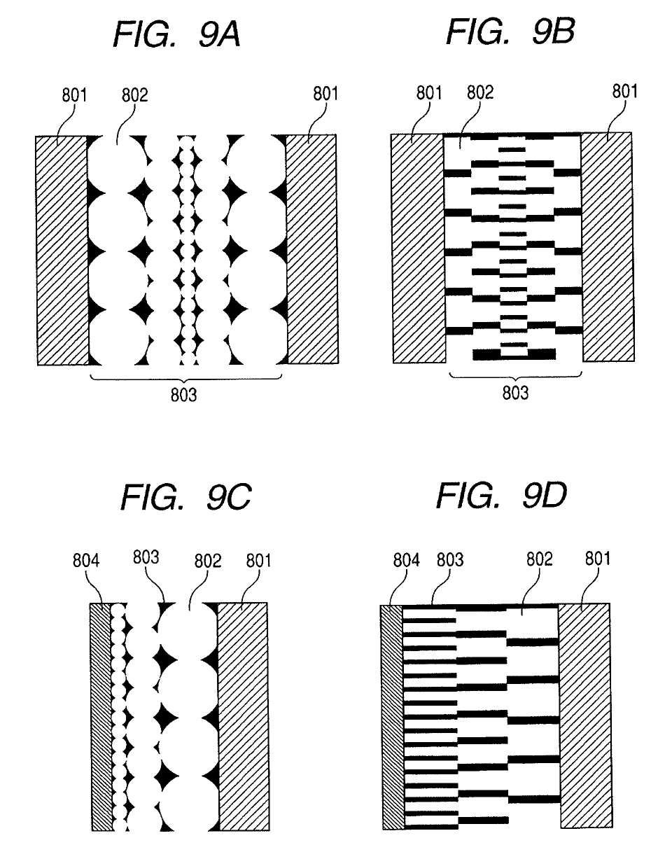

FIGS. 9A, 9B, 9C and 9D illustrates porous structures of the conductive member. In the drawings, the numerals denote the followings: 801, an electrolyte layer; 802, a pore; 803, a conductive member; 804, supporting substrate optionally employed. As shown in the drawings, the sizes of the pores in the conductive member are preferably larger at the electrolyte layer side (i.e., outer surface side of the conductive member) and smaller in the inside (i.e., interior of the conductive member). In other words, in the conductive porous member employed in the present invention, the pore sizes are preferably larger at the surface side of the conductive porous member than those at the interior thereof. The pore size ratio is preferably 2 or more, more preferably 4 or more, still more preferably 10 or more, but is not larger than 1000.

The porosity may be the same between the regions of different pore sizes. More preferably, the pore sizes and the porosities in the conductive member are both larger in the electrolyte layer side, and smaller in the interior. The pore size and porosity of the porous member can be measured by nitrogen gas adsorption measurement (BET method (Brunauer-Emmett-Teller method)), for example by AUTOSORB-1 (Quantachrome Instruments Co.). The pore sizes on the surface of the member can be estimated by measuring the pore sizes of a certain number of pores (e.g., 50 to 300 pores) in SEM photograph (scanning electron microscope photograph).

The conductive porous layer constituting the enzyme electrode has preferably a region in which the pore size is decreased from the electrolyte side of the porous layer toward the other face side. The size of the pores in the porous layer of the present invention may be changed, from one face side (electrolyte side) toward the other face side, to have a high-porosity region, and a low-porosity region; or a high-porosity region, a medium-porosity region, and a low-porosity region; or a high-porosity region, a low-porosity region, and a high-porosity region.

The carrier serves at least to immobilize the enzyme to the conductive member. The carrier includes (1) polymer compounds, (2) inorganic compounds, and (3) organic compounds, the compounds having a covalent bonding site in the molecule and being capable of bonding an enzyme to the conductive member, and/or the two enzymes. The carrier contains at least one of the above three types of compounds. To immobilize the enzyme to the electrode, the carrier has preferably an electric charge opposite to the surface charge of the enzyme under the electrode driving conditions. The carrier may be ones capable of holding the enzyme by covalent bonding, electrostatic interaction, spatial trapping, or a like action to hold the enzyme stably at a high density in comparison with retention of the enzyme by physical adsorption to the electrode or to a binder polymer for caking the electrode.

The polymer compounds useful as the carrier include electroconductive polymers such as polyacetylenes, polyarylenes, polyarylene-vinylenes, polyacenes, polyarylacetylenes, polydiacetylenes, polynaphthalenes, polypyrroles, polyanilines, polythiophenes, polythienylenes, vinylenes, polyazulenes, and polyisothianaphthenes; and other kind of polymers such as polystyrenesulfonic acids, polyvinyl sulfate, dextran sulfate, chondroitin sulfate, polyacrylic acid, polymethacrylic acid, polymaleic acid, polyfumaric acid, polyethylenimine, polyallylamine hydrochloride, polydiallyldimethylammonium chloride, polyvinylpyridine, polyvinylimidazole, polylysine, deoxyribonucleic acid, ribonucleic acid, pectin, silicone resins, cellulose, agarose, dextran, chitin, polystyrene, polyvinyl alcohol, and nylons.

The inorganic compounds useful as the carrier include metal chalcogenide compounds containing at least one element selected from the group of In, Sn, Zn, Ti, Al, Si, Zr, Nb, Mg, Ba, Mo, W, V, and Sr.

The organic compounds, being useful as the carrier, and having a covalent bonding site in the molecule and being capable of bonding an enzyme to the conductive member, and/or the two enzymes include compounds having at least one functional group selected from hydroxyl, carboxyl, amino, aldehydro, hydrazino, thiocyanato, epoxy, vinyl, halogeno, acid ester groups, phosphato, thiol, disulfido, dithiocarbamato, dithiophosphato, dithiophosphnato, thioether groups, thiosulfato, and thiourea groups. Typical examples are glutaraldehyde, polyethylene glycol diglycidyl ether, cyanuric chloride, N-hydroxysuccinimide esters, dimethyl-3,3′-dithiopropionimidate hydrochloride, 3,3′-dithio-bis(sulfosuccinimidyl propionate), cystmine, alkyl dithiols, biphenylene dithiols, and benzene dithiols.

The mediator serves to promote transfer of electrons between the enzyme and the conductive member, and may be employed optionally as necessary. The mediator may be chemically bonded to at least one of the carrier and the enzyme. The mediator is exemplified by metal complexes, quinones, heterocyclic compounds, nicotinamide derivatives, flavin derivatives, electroconductive polymers, electroconductive fine particulate materials, and carbonaceous materials. The metal complexes include those having as the central metal at least one element selected from Os, Fe, Ru, Co, Cu, Ni, V, Mo, Cr, Mn, Pt, Rh, Pd, Mg, Ca, Sr, Ba, Ti, Ir, Zn, Cd, Hg, and W. The ligands of the metal complexes are exemplified by those containing an atom of nitrogen, oxygen, phosphorus, sulfur, or carbon and capable of forming a complex through the above atom with the central metal; and those having a cyclopentadienyl ring as the skeleton. The ligand includes pyrrole, pyrazole, imidazole, 1,2,3- or 1,2,4-triazole, tetrazole, 2,2′-biimidazole, pyridine, 2,2′-bisthiophene, 2,2′-bipyridine, 2,2′:6′2″-terpyridine, ethylenediamine, porphyrin, phthalocyanine, acetylacetone, quinolinol, ammonia, cyan ion, triphenylphosphine oxide, and derivatives thereof. The quinines as the mediator include quinone, benzoquinone, anthraquinone, naphthoquinone, pyrroloquinolinequinone, tetracyanoquinodimethane, and derivatives thereof. The heterocyclic compounds as the mediator include phenazine, phenothiazine, biologen, and derivatives thereof. The nicotinamide derivatives as the mediator include nicotinamide adenine dinucleotide (NAD), and nicotinamide adenine dinucleotide phosphate. The flavin derivatives as the mediator include flavin adenine dinucleotide (FAD). The electroconductive polymers as the mediator include polyacetylenes, polyarylenes, polyarylene-vinylenes, polyacenes, polyarylacetylenes, polydiacetylenes, polynaphthalenes, polypyrroles, polyanilines, polythiophenes, polythienylenevinylenes, polyazulenes, and polyisothianaphthenes. The electroconductive fine particulate materials as the mediator contain a fine particulate metal material including metals containing at least one element of Au, Pt, Ag, Co, Pd, Rh, Ir, Ru, Os, Re, Ni, Cr, Fe, Mo, Ti, Al, Cu, V, Nb, Zr, Sn, In, Ga, Mg, and Pb; and fine particulate electroconductive polymers: the material may be an alloy or may be plated. The carbonaceous materials as the mediator include fine particulate graphite, fine particulate carbon black, fullerene compounds, carbon nanotubes, carbon nanohorns, and derivatives thereof.

The conductive member has numerous voids formed inside and communicating with the outside: preferably partitions are formed from the constituting material in integration to separate the voids, or partitions separating the voids are tightly bonded. The constituting material of the conductive member includes electroconductive materials such as metals, polymers, metal oxides, and carbonaceous materials.

The metal for constituting the conductive member should have electroconductivity, sufficient rigidity during storage and measurement operation, and sufficient electrochemical stability under the electrode working conditions. The metal includes those containing at least one element of Au, Pt, Ag, Co, Pd, Rh, Ir, Ru, Os, Re, Ni, Cr, Fe, Mo, Ti, Al, Cu, V, Nb, Zr, Sn, In, Ga, Mg, Pb, Si, and W. The metal may be an alloy, or a metal-plated matter. The void-containing metal includes foamed metals, electrodeposited metals, electrolytic metals, sintered metals, fibrous metals, and metals corresponding to two or more of the above kinds of metals. The electric conductivity of the conductive member applicable to the present invention ranges from 0.1 to 700000 S/cm, preferably from 1 to 100000 S/cm, more preferably from 100 to 100000 S/cm. (Incidentally, S denotes siemens, a reciprocal of ohm (1/Ω).) The conductive member having the porous structure for the enzyme electrode has preferably the electric conductivity within the above range.

The electroconductive polymer for constituting the conductive member should have electroconductivity, sufficient rigidity during storage and measurement operation, and sufficient electrochemical stability under the electrode working conditions. The polymer includes those containing at least one compound selected from polyacetylenes, polyarylenes, polyarylene-vinylenes, polyacenes, polyarylacetylenes, polydiacetylenes, polynaphthalenes, polypyrroles, polyanilines, polythiophenes, polythienylenevinylenes, polyazulenes, and polyisothianaphthenes. This void-containing polymer can be produced by any of the processes for manufacture of a porous resin. In one process, a template for the voids is used in molding a conductive polymer into an intended shape, and thereafter the material of the template is removed. In another process, a template for the voids is placed in a prepolymer, the prepolymer is polymerized into a conductive polymer, and thereafter the material of the template is removed. In a still another process, a layer is formed from particles for constituting a void template, a polymer is filled into the interstice of the particle layer, and thereafter the particles are removed from the layer. In a still another process, a layer is formed from particles for constituting a void template, a prepolymer is filled into the interstice of the particle layer, the prepolymer is polymerized to form a polymer layer, and thereafter the particles are removed from the layer.

The metal oxide for constituting the conductive member should have sufficient rigidity during storage and measurement operation, and sufficient electrochemical stability under the electrode working conditions. The metal oxide may be improved in electroconductivity or may be made electroconductive by an additional electroconductive material. The metal oxide includes those containing at least one element of In, Sn, Zn, Ti, Al, Si, Zr, Nb, Mg, Ba, Mo, W, V, and Sr. The additional electroconductive material includes metals, electroconductive polymers, and carbonaceous materials. The metal oxide production process includes electrodepositing, sputtering, sintering, chemical vapor deposition (CVD), electrolysis, and combination thereof.

The carbonaceous material for constituting the conductive member in the present invention should have sufficient rigidity during storage and measurement operation, and sufficient electrochemical stability under the electrode working conditions. The carbonaceous material may be improved in electroconductivity or may be made electroconductive by an additional electroconductive material. The carbonaceous material includes graphite, carbon black, carbon nanotubes, carbon nanohorns, fullerene compounds, and derivatives thereof. The conductive member can be produced from the carbonaceous material by sintering.

As the enzyme to be immobilized on the conductive member, oxidoreductases are useful. The oxidoreductase catalyzes a redox reaction. Plural different enzymes may be combinedly immobilized on one and the same enzyme electrode for achieving an intended characteristic. The enzymes include glucose oxidase, galactose oxidase, bilirubin oxidase, pyruvate oxidase, D- or L-amino acid oxidase, amine oxidase, cholesterol oxidase, choline oxidase, xanthine oxidase, sarcosine oxidase, L-lactate oxidase, ascorbate oxidase, cytochrome oxidase, alcohol dehydrogenase, glutamate dehydrogenase, cholesterol dehydrogenase, aldehyde dehydrogenase, glucose dehydrogenase, fructose dehydrogenase, sorbitol dehydrogenase, lactate dehydrogenase, maleate acid dehydrogenase, glycerol dehydrogenase, 17B-hydroxysteroid dehydrogenase, estradiol-17B dehydrogenase, amino acid dehydrogenase, glyceraldehyde-3-phosphate dehydrogenase, 3-hydroxysteroid dehydrogenase, diaphorase, cytochrome C catalase, peroxidase, glutathione reductase, NADH-cytochrome b5 reductase, NADPH-adrenodoxin reductase, cytochrome b5 reductase, adrenodoxin reductase, and nitrate reductase.

The substrate substances for the enzymes are compounds corresponding to the respective enzymes, including organic matters, oxygen, hydrogen peroxide, water, and nitrate ions. The organic matters include sugars, alcohols, carboxylic acids, quinones, nicotinamide derivatives, and flavin derivatives. The sugars include polysaccharides such as cellulose, and starch.

In the carrier immobilization in the present invention, the carrier is preferably uniformly immobilized in the voids of the conductive member. For the uniform immobilization of the carrier in the voids of the conductive member, the surface of the conductive member is preferably made hydrophilic prior to introduction of the carrier into the conductive member. The process for hydrophilicity treatment of the surface of the conductive member includes UV-ozone treatment; permeation of a water-soluble organic solvent like an alcohol into the voids of the conductive member and substitution of the solvent with water; and application of ultrasonic wave during the above hydrophilicity treatment. The carrier immobilization process may be conducted simultaneously with the enzyme immobilization process and/or mediator immobilization process. The immobilization of the carrier may be conducted, for example, by any of the processes below. In a process, a void-containing conductive member is immersed in a solution or dispersion of the carrier. In another process, a solution or dispersion of the carrier is applied, injected, or sprayed to the void-containing member. In still another process, a void-containing conductive member is immersed in a solution or dispersion of the carrier precursor, or a solution or dispersion of the carrier precursor is applied, injected, or sprayed to the void-containing member, and the carrier precursor is hydrolyzed, polymerized, or crosslinked for immobilization.

### EXAMPLES

The present invention is explained below in more detail without limiting the invention thereto.

Firstly, a method of preparation of the void-containing conductive member used in the present invention is described. The size of the particles can be measured by scanning electron microscopy. The film thickness can be measured by surface roughness tester.

### Preparation Example 1

A commercial polystyrene type latex colloid dispersion liquid (Nippon Zeon Co.; average particle size: 100 nm) is employed. The dispersion medium of the dispersion liquid is replaced by ethanol. A cleaned gold substrate is allowed to stand in the dispersion liquid. The ethanol is allowed to evaporate at 30° C. to obtain a porous film constituted of polystyrene spheres. This process is repeated several times to obtain a porous film constituted of polystyrene spheres of an intended film thickness (100 μm thick). The film is heated at 70° C. for 30 minutes, and then washed with ethanol. Using this porous film as the working electrode and a platinum electrode as the counter electrode, electro-deposition is conducted in an aqueous 0.1M nickel sulfate solution at a current density of 0.1 mA/cm² by control with a galvanostat. The time of the electro-deposition is controlled by monitoring the electrolysis current profile to obtain a film in a thickness nearly equivalent to the polystyrene film thickness. After the electro-deposition, the film is immersed in toluene for two days to remove the latex to obtain a conductive member constituted of nickel having numerous voids.

### Preparation Example 2

A platinum paste (Tanaka Kikinzoku Kogyo K.K.; platinum particle size: 1 μm) is applied on a cleaned gold substrate by screen process printing, and is sintered at 500° C. for one hour to obtain a conductive member (100 μm thick) constituted of platinum having numerous voids.

### Preparation Example 3

A gold paste (Tanaka Kikinzoku Kogyo K.K.; gold particle size: 1 μm) is applied on a cleaned gold substrate by screen process printing, and is sintered at 500° C. for one hour to obtain a conductive member (100 μm thick) constituted of gold having numerous voids.

### Preparation Example 4

Palladium particles (Tanaka Kikinzoku Kogyo K.K.; particle size: 1 μm) is dispersed in an about double weight of terpineol, and the viscosity is adjusted by addition of ethylcellulose to obtain a palladium paste. This palladium paste is applied on a cleaned gold substrate by screen process printing, and is sintered at 500° C. for one hour to obtain a conductive member (100 μm thick) constituted of palladium having numerous voids.

### Preparation Example 5

A commercial silica colloid dispersion liquid (Nissan Chemical Ind.; average particle size: 100 nm) is employed. The dispersion medium of the dispersion liquid is replaced by ethanol. A cleaned gold substrate is allowed to stand in the dispersion liquid. The ethanol is allowed to evaporate at 30° C. to obtain a porous film constituted of silica spheres. This process is repeated several times to increase the thickness of a porous film constituted of silica spheres (100 nm thick). The film is heated at 200° C. for three hours, and then washed with ethanol. In a three-electrode cell, by use of this porous film as the working electrode, a platinum electrode as the counter electrode, and an Ag/AgCl electrode as the reference electrode, electrolytic polymerization is conducted in a solution of 0.1M pyrrole and 0.1M lithium perchlorate in acetonitrile at a potential of 1.1 V (vs Ag/AgCl) by means of a potentiostat. The time of the polymerization is controlled by monitoring the electrolysis current profile to obtain a film in a thickness nearly equivalent to the silica sphere porous film thickness. After the electrolytic polymerization, the film is immersed in a 20% hydrofluoric acid solution for two days to remove the silica spheres to obtain a conductive member (100 μm thick) constituted of electroconductive polypyrrole containing numerous voids.

### Preparation Example 6

A conductive member (100 μm thick) composed of poly(3,4-ethylenedioxythiophene) having numerous voids is prepared in the same manner as in Preparation Example 5 except that 3,4-ethylenedioxythiophene is used instead of pyrrole.

### Preparation Example 7

A commercial aqueous dispersion of poly(3,4-ethylenedioxythiophene)-poly(styrenesulfonate) (Bayer) is used. The dispersion medium of this dispersion is replaced by ethanol (polymer concentration: 10 g/L). This solution is dropped onto a porous film constituted of silica spheres prepared in the same manner as in Preparation Example 5, and dried. This process is repeated to fill the polymer in the voids of the silica-sphere porous film. Then the film is annealed at 70° C. for 30 minutes. Further, the film is immersed in a 20% hydrofluoric acid solution for two days to remove the silica spheres to obtain a conductive member constituted of poly(3,4-ethylenedioxythiophene)-poly(styrenesulfonate) having numerous voids.

### Preparation Example 8

A porous film constituted of silica spheres is prepared in the same manner as in Preparation Example 5. By use of this porous film as the working electrode and a platinum wire as the counter electrode, electro-deposition is conducted in an aqueous solution of 0.5M aniline and 1M lithium perchlorate at a current density of 0.1 mA/cm² by control with a galvanostat. The time of the electro-deposition is controlled by monitoring the electrolysis current profile to obtain a film in a thickness nearly equivalent to the porous silica sphere film thickness. After the electro-deposition, the film is immersed in a 20% hydrofluoric acid solution for two days to remove the silica spheres to obtain a conductive member constituted of polyaniline containing numerous voids.

### Preparation Example 9

Needle-shaped indium tin oxide (ITO, Sumitomo Metal Mining Co.; length: 30-100 nm; aspect ratio: 10 or higher) is dispersed in terpineol, and the viscosity is adjusted by addition of ethylcellulose to obtain an ITO paste. This ITO paste is applied on a cleaned gold substrate by screen process printing, and is sintered at 250° C. for one hour to obtain a porous ITO sintered electrode (100 μm thick). Further thereon, ITO is deposited by plasma chemical vapor phase deposition (CVD) in a thickness of about 10 nm to obtain a conductive member constituted of ITO and having numerous voids.

### Preparation Example 10

Commercial fine particulate electroconductive titanium oxide (Titan Kogyo K.K.; EC-300; particle diameter: 300 nm) is dispersed in terpineol, and the viscosity is adjusted by addition of ethylcellulose to obtain a titanium oxide paste. This titanium oxide paste is applied on a cleaned gold substrate by screen process printing, and is sintered at 450° C. for one hour to obtain a sintered porous titanium oxide film (100 μm thick). By use of this porous film as the working electrode and a platinum wire as the counter electrode, electrolytic plating is conducted in a gold-plating solution (Kamimura Kogyo K.K.; 535LC) with an ultrasonic vibration at a current density of 0.1 mA/cm² by control with a galvanostat for one hour, blowing a jet of the gold-plating solution on the sintered porous film, to obtain a conductive member constituted of gold-plated porous titanium oxide having numerous voids.

### Preparation Example 11

A cleaned gold substrate is immersed in a 0.01M zinc nitrate solution in water/ethanol (9:1). On this base plate, needle-shaped zinc crystal is allowed to grow by application of a potential of −1.2 V (vs Ag/AgCl) by employing a platinum wire as the counter electrode and an Ag/AgCl electrode as the reference electrode at 85° C. for 1.5 hours. After washing the base plate, the crystalline matter is treated for coating with carbon as below. The base plate is placed in a tubular furnace. The temperature is elevated by 5° C. per minute to the predetermined temperature. During the heat treatment, hydrogen/helium (2%/98%) is constantly fed at a flow rate of 33 sccm. During the thermal decomposition of hydrocarbon, ethylene/helium (1%/99%) is fed at 66 sccm as a hydrocarbon gas. During the thermal decomposition of the hydrocarbon, the total gas feed rate is 100 sccm at the gas ratio of ethylene:hydrogen:helium=1:1:100. In the heat treatment, the temperature is elevated in an atmosphere of hydrogen/helium (2%/98%) up to 1000° C. in 200 minutes, the temperature is kept for 10 minutes, and then ethylene/helium (1%/99%) is fed for 10 minutes. The system is kept at 1000° C. for 1 hour, and cooled in 200 minutes. Thereby a conductive member is prepared which has numerous voids constituted of carbon-coated needle-shaped crystalline zinc oxide.

### Preparation Example 12

An electropolished aluminum sheet (100 μm thick) is anodized in 0.3M sulfuric acid at 25 V for one hour to obtain porous alumina at pore intervals of 60 nm. This porous alumina sheet is electroplated with a platinum counter electrode in a gold electroplating solution (Kamimura Kogyo K.K.; 535LC) in a jet flow of said gold-plating solution with an ultrasonic vibration at a current density of 0.1 mA/cm² by control with a galvanostat for one hour. Thereby a conductive member is prepared which is constituted of porous alumina having many gold-plated pores.

### Preparation Example 13

Natural particulate graphite (particle size: 11 μm) is mixed with polyvinylidene fluoride in an amount of 10 wt % of the particulate graphite. N-methyl-2-pyrrolidone is added thereto to solve the polyvinylidene fluoride. The blended graphite paste is molded into a film of 11.3 mm diameter and 0.5 mm thick. The film is dried at 60° C., heated to 240° C., and further vacuum-dried at 200° C. Thereby a conductive member is obtained which is constituted of many graphite particles bonded together and has numerous voids in the structure.

### Preparation Example 14

A conductive member is prepared in the same manner as in Preparation Example 13 except that carbon black (Lion Corp.; Carbon ECP600JD) is used instead of the particulate graphite. Thereby a conductive member is obtained which has numerous voids in the carbon black particle structure.

### Preparation Example 15

A conductive member is prepared in the same manner as in Preparation Example 14 except that monolayer carbon nanotubes (Carbon Nanotech Research Institute) is used in an amount of 20 wt % of the carbon black. Thereby a conductive member is obtained which has numerous voids in the carbon nanotube structure.

Next, processes for preparation of the mediator are described below.

### Preparation Example 16

The process for synthesis of the complex polymer shown by Chemical Formula (1) is described below.

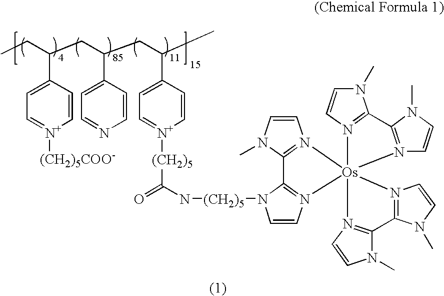

To 100 g of an aqueous 40% glyoxal solution, was added dropwise 370 mL of an aqueous concentrated ammonia solution on an ice bath. The mixture is stirred at 45° C. for 24 hours, and is air-cooled. The formed precipitate is collected by filtration, and vacuum-dried at 50° C. for 24 hours to obtain 2,2′-biimidazole. This compound is identified by silica-gel thin-layer chromatography (methanol/chloroform (10%/90%)). To a solution of 4.6 g of 2,2′-biimidazole in 100 mL of N,N′-dimethylformamide (DMF), is added 2.7 g of sodium hydride in a nitrogen atmosphere on an ice bath. The mixture is stirred at room temperature for one hour. Thereto, a solution of 12.8 g of methyl p-toluenesulfonate in 5 mL of DMF is added dropwise in 20 minutes, and the mixture is stirred at room temperature for 4 hours. The solvent is evaporated under vacuum at 50° C. The evaporation residue is washed with 50 mL of hexane, and vacuum-dried at 160° C. to obtain N,N′-dimethyl-2,2′-biimidazole in a colorless transparent crystalline state. The obtained product is identified by ¹H-NMR.

To a solution of 10 g 2,2′-biimidazole in 100 mL of DMF, is added 3.3 g of sodium hydride on an ice bath in a nitrogen atmosphere. The mixture was stirred on an ice bath for one hour. Thereto, 4.6 mL of methyl iodide is added dropwise, and the mixture was stirred on an ice bath for 30 minutes and at room temperature for 12 hours. The reaction solution is poured into 300 mL of ethyl acetate. The mixture is filtered, and the solvent is evaporated from the filtrate under a reduced pressure and vacuum. The evaporation residue is dissolved in boiling ethyl acetate, and the solution is filtered. The filtered ethyl acetate solution is boiled again. Thereto 300 mL of hexane is added for saturation. The solution is kept in a refrigerator for 12 hours for crystal growth. The crystalline matter is collected by suction filtration, and recrystallized from ethyl acetate/hexane to obtain N-methyl-2,2′-biimidazole. The identification is conducted by ¹H-NMR.

A 1 g portion of N-methyl-2,2′-biimidazole is dissolved in 80 mL of DMF. Thereto, 0.32 g of sodium hydride is added in a nitrogen atmosphere. The mixture is stirred on an ice bath for one hour. Thereto 2.5 g of N-(6-bromohexyl)phthalimide and 1.0 g of sodium iodide are added gradually. The mixture is stirred in a nitrogen atmosphere at 80° C. for 24 hours. The mixture is cooled to room temperature, and 150 mL of water is added thereto. The mixture is extracted twice with ethyl acetate. The ethyl acetate solution is washed with an aqueous sodium chloride solution and dried over sodium sulfate, and is evaporated under a reduced pressure. The residue is purified by a neutral alumina column (ethyl acetate/hexane 10 to 40%) to obtain N-methyl-N′-(6-phthalimidohexyl)-2,2′-biimidazole. This product is identified by ¹H-NMR.

A 2.5 g portion of N-methyl-N′-(6-phthalimidohexyl)-2,2′-biimidazole is dissolved in 25 mL of ethanol, and thereto 0.39 g of hydrogenated hydrazine is added. The mixture is refluxed for 2 hours, cooled to room temperature, and filtered. The solution is transferred to a silica gel column with ethanol. The product is recovered by a 10% ammonia solution in acetonitrile, and the solution is evaporated under a reduced pressure to obtain N-(6-aminohexyl)-N′-methyl-2,2′-biimidazole. This product is identified by ¹H-NMR.

In 40 mL of ethylene glycol, 1.1 g of N-methyl-2,2′-biimidazole and 1.4 g of ammonium hexachloroosmate are dissolved. The solution is stirred in a nitrogen atmosphere at 140° C. for 24 hours. Thereto, is added a solution of 0.8 g of N-(6-aminohexyl)-N′-methyl-2,2′-biimidazole in 5 mL of ethylene glycol. The solution is stirred further for 24 hours, cooled to room temperature, and filtered. The filtrate is diluted with 200 mL of water, and stirred with 40 mL of an anion exchange resin (DOWEX® 1×4) in the air for 24 hours. The solution is poured gradually into a solution of 10.2 g of ammonium hexafluorophosphate in 150 mL of water. The precipitate is collected by filtration by suction, and dissolved in acetonitrile and reprecipitated by an aqueous ammonium hexafluorophosphate solution. The obtained matter is washed with water, and vacuum-dried at 45° C. for 24 hours to obtain osmium(III)(N,N′-dimethyl-2,2′-biimidazole)₂(N-(6-aminohexyl)-N′-methyl-2,2′-biimidazole) hexafluorophosphate salt. This product is identified by elemental analysis.

To 150 mL of DMF, are added 20 g of polyvinylpyridine (average molecular weight: 150,000) and 5.6 g of 6-bromohexane. The mixture is stirred at 90° C. with a stirrer for 24 hours, and cooled to room temperature. The cooled mixture is poured gradually into 1.2 L of ethyl acetate with violent agitation. Then the solvent is removed by decantation, and the remaining solid matter is dissolved in methanol. The solution is filtered, and evaporated to a solvent volume of about 200 mL. The formed product is reprecipitated with 1 L of diethyl ether. The product is vacuum-dried at 50° C. for 24 hours, pulverized, and further dried for 48 hours to obtain poly(4-(N-(5-carboxypentyl)pyridinium)-co-4-vinylpyridine).

In 10 mL of DMF, 0.52 g of the poly(4-(N-(5-carboxypentyl)pyridinium)-co-4-vinylpyridine) is dispersed, and thereto 0.18 g of O-(N-succinimidyl)-N,N,N′,N′-tetramethyluronium tetrafluoroborate (TSTU) is added. The mixture is stirred for 15 minutes. Thereto 0.1 mL of N,N-diisopropylethylamine is added, and the mixture is stirred for 8 hours. Thereto, 0.89 g of poly(4-(N-(5-carboxypentyl)pyridinium)-co-4-vinylpyridine) is added and the mixture is stirred for 5 minutes. Further thereto, 0.1 mL of N,N-diisopropylethylamine is added and the mixture is stirred at room temperature for 24 hours. The resulting mixture is added to 200 mL of ethyl acetate. The formed precipitate is collected by filtration, and is added to 30 mL of acetonitrile. Thereto 40 mL of DOWEX® 1×4, and 100 mL of water are added, and the mixture is stirred for 36 hours to dissolve the polymer. The solution is filtered by suction, and is concentrated to a volume of 50 mL. The concentrated matter is extruded through a (mol wt 10000)-cutoff filter (Millipore) at a nitrogen pressure of 275 kPa. Further, the extruded matter is passed with water as the solvent through a DOWEX® 1×4 column, and dialyzed in water. Thereby the polymer-(chloride salt) of Chemical Formula (1) is obtained.

### Preparation Example 17

The process for synthesis of the complex polymer shown by Chemical Formula (2) is described below.

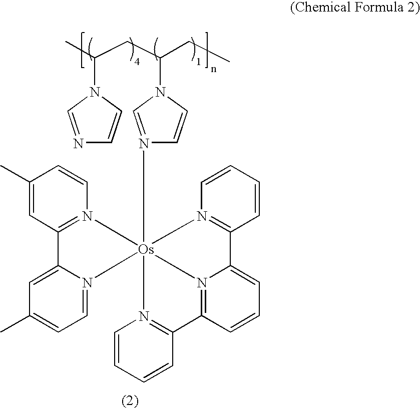

To 6 mL of 1-vinylimidazole, is added 0.5 g of azobisisobutylonitrile. The mixture is allowed to react in an argon atmosphere at 70° C. for 2 hours. The reaction solution is air-cooled. The formed precipitate is dissolved in methanol. The solution is added dropwise into acetone with violent agitation. The precipitate is collected by filtration to obtain poly-1-vinylimidazole. Separately, 0.76 g of 2,2′:6′2″-terpyridine and 1.42 g of ammonium hexachloroosmate are added to 5 mL of ethylene glycol, and the mixture is refluxed in an argon atmosphere for one hour. To this solution, 0.60 g of 4,4′-dimethyl-2,2′-bipyridine is added. The mixture is refluxed for 24 hours. The reaction solution is air-cooled. Impurity is removed by filtration. The filtrate is evaporated to remove the solvent to obtain osmium(2,2′:6′2″-terpyridine)(4,4′-dimethyl-2,2′-bipyridine) chloride salt.

A 200 mL portion of ethanol is added to 0.38 g of osmium(2,2′:6′2″-terpyridine)(4,4′-dimethyl-2,2′-bipyridine) chloride salt and 0.2 g of polyvinylimidazole. The mixture is refluxed in a nitrogen atmosphere for three days. The reaction mixture is filtered, and then the filtrate is added dropwise into 1 L of diethyl ether with violent agitation. The formed precipitate is recovered and dried to obtain the osmium complex represented by Chemical Formula (2). The compound is identified by elemental analysis.

### Preparation Example 18

The process for synthesis of the complex polymer shown by Chemical Formula (3) is described below.

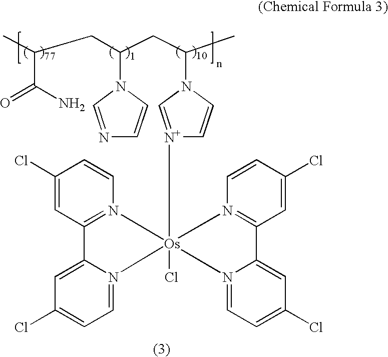

To 7.5 mL of concentrated sulfuric acid, is added 1.9 g of 2,2′-bipyridyl-N,N′-dioxide. To the mixture, 1.6 g of fuming nitric acid is added gradually dropwise on a salted ice bath. The mixture is stirred for 5 minutes, and is poured onto crushed ice. The deposited solid is collected by filtration to obtain 4,4′-dinitro-2,2′-bipyridyl-N,N′-dioxide. A 0.5 g portion of this 4,4′-dinitro-2,2′-bipyridyl-N,N′-dioxide is added to 2.0 g of acetyl chloride, and the mixture is refluxed for one hour. The reaction solution is cooled, and an excess of acetyl chloride is distilled off. The reaction product is recrystallized from chloroform to obtain 4,4′-dichloro-2,2′-bipyridine. The product is identified by ¹H-NMR.

In 150 mL of water, are dissolved 24 g of acetylamide and 7 mL of 1-vinylimidazole. To the solution, is added an aqueous solution of 0.69 mL of N,N,N′,N′-tetramethylethylenediamine in 50 mL of water, and is further added thereto an aqueous solution of 0.6 g of ammonium persulfate in 150 mL of water. The mixture is allowed to react in an argon atmosphere at 40° C. for 30 minutes. Then the reaction solution is air-cooled, and the formed solid matter is allowed to precipitate in 2 L of methanol. The precipitate is dissolved again in 300 mL of water, and reprecipitated in 2 L of methanol. The precipitate is isolated, and is kept in methanol at 4° C. for 12 hours. Thereafter, the solvent is evaporated under a reduced pressure to obtain a copolymer of polyacrylamide-polyvinylimidazole (7/1).

A 5 mL portion of ethylene glycol is added to 1.5 g of 4,4′-dichloro-2,2′-bipyridine and 1.4 g of ammonium hexachloroosmate, and the mixture is refluxed in an argon atmosphere for one hour. The reaction solution is air-cooled. Impurity is removed by filtration. The filtrate is evaporated to remove the solvent to obtain osmium(4,4′-dichloro-2,2′-bipyridine)₂ dichloride.

A 200 mL portion of ethanol is added to 1.0 g of osmium(4,4′-dichloro-2,2′-bipyridine)₂ dichloride salt and 0.90 g of polyacrylamide-polyvinylimidazole (7/1) copolymer. The mixture is refluxed in a nitrogen atmosphere for three days. The reaction mixture is filtered, and then the filtrate is added dropwise into 1 L of diethyl ether with violent agitation. The formed precipitate is recovered and dried to obtain the osmium complex represented by Chemical Formula (3). The compound is identified by elemental analysis.

### Preparation Example 19

The process for synthesis of the ferrocene derivative shown by Chemical Formula (4), and the glucose oxidase modifying the ferrocene derivative is described below.

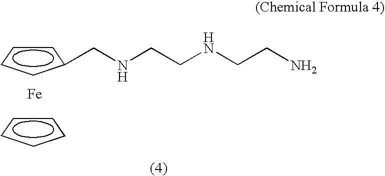

A 4.1 g portion of diethylenetriamine is dissolved in 200 mL of DMF. Thereto, is added a solution of 2.1 g ferrocene carbaldehyde in 100 mL of DMF. The mixture is stirred at 100° C. for one hour. Thereto is added 1 g of sodium boron hydride saturated in water. The mixture is stirred at room temperature for one hour. The solvent is evaporated off under a reduced pressure. The evaporation residue is treated by a silica column with a solvent of dichloromethane/methanol (10/1) to remove the dimer to obtain the ferrocene derivative compound represented by Chemical Formula (4). The compound is identified by ¹H-NMR. Separately, in a sample tube, 0.052 g of glucose oxidase (Aspergillus niger) is added to 1.3 mL of an aqueous 0.1M sodium hydrogencarbonate solution, and further thereto 0.7 mL of a 7 mg/mL sodium periodate solution. The mixture is stirred in the dark for one hour. The solution is added to 2 mL of a 0.2M citrate buffer solution. Further thereto, 0.01 g of the ferrocene derivative compound represented by Chemical Formula (4) is added. The mixture is stirred for 15 hours, and centrifuged. The supernatant liquid is filtered through a 0.2 μm-filter (Millipore), and is treated with a gel filtration column (Sephadex® G25) to eliminate unreacted ferrocene derivative to obtain a glucose oxidase combined with a ferrocene derivative.

### Preparation Example 20

The complex polymer shown by Chemical Formula (5) below (M=Ru) is prepared by the process described below.

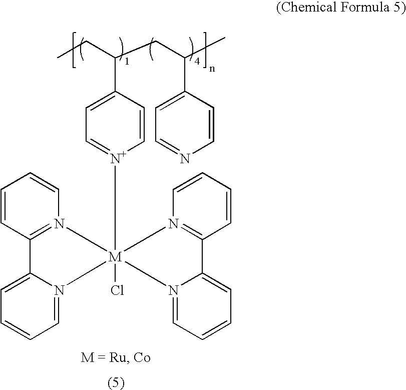

A 20 mL portion of ethylene glycol is added to 0.21 g of ruthenium trichloride and 0.31 g of 2,2-bipyridine. The mixture is refluxed in an argon atmosphere for 24 hours. Thereafter the reaction solution is air-cooled. Impurity is eliminated by filtration, and the filtrate is evaporated by a reduced pressure to obtain ruthenium(2,2′-bipyridine)2 dichloride salt.

A 0.1 g portion of the ruthenium(2,2′-bipyridine)₂ dichloride salt is added to a solution of 0.11 g of polyvinylpyridine (average mol wt: 150,000) in 30 mL of DMF. The mixture is stirred at 90° C. for 24 hours, and thereafter is cooled to room temperature. The cooled mixture is poured gradually into 1.2 L of ethyl acetate with violent agitation. Then the solvent is removed by decantation, and the solid matter is dissolved in methanol. The solution is filtered, and evaporated to a solution volume of about 200 mL. The formed product is reprecipitated in 1 L of diethyl ether. The product is vacuum-dried at 50° C. for 24 hours, pulverized, and further dried for 48 hours to obtain the ruthenium complex polymer represented by Chemical Formula (5). The compound is identified by elemental analysis.

### Preparation Example 21

The complex polymer shown by Chemical Formula (5) (M=Co) is prepared as below.

The cobalt complex shown by Chemical Formula (5) is prepared in the same manner as in Preparation Example 20 except that the ruthenium trichloride (0.21 g) is replaced by 0.13 g of cobalt dichloride, and the ruthenium(2,2′-bipyridine)₂ dichloride salt (0.10 g) is replaced by 0.088 g of cobalt(2,2′-bipyridine)₂ dichloride salt.

### Preparation Example 22

N⁶-(2-aminoethyl)FAD is prepared through the process shown below. To an aqueous 10% FAD solution, is added an equimolar amount of ethylenimine. The pH is adjusted to 6-6.5. The mixture is allowed to react at 50° C. for 6 hours. The reaction solution is cooled, and is added into ethanol on an ice bath to cause precipitation. The precipitate is collected and is purified by anion exchange chromatography and reversed-phase high-speed chromatography to obtain purified N⁶-(2-aminoethyl)FAD.

### Preparation Example 23

The phenothiazine-modified glucose oxidase shown by Chemical Formula (6) blow is prepared through the process described below.

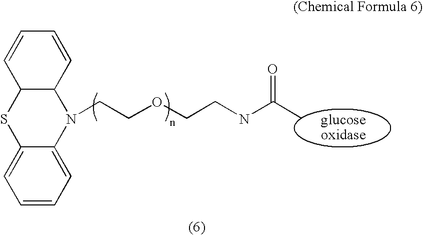

To 50 mL of an aqueous 0.01M potassium hydroxide solution, are added 0.40 g of phenothiazine, and 3.0 g of polyethylene glycol (mol wt: 3000). Thereto 0.040 g of ethylene oxide is added with stirring on an ice bath. After stirring at ordinary temperature for 6 hours, the mixture is ultra-filtered to eliminate remaining unreacted phenothiazine. The filtrate is evaporated by vacuum to obtain polyethylene glycol-modified phenothiazine. A 3.2 g portion of this polyethylene glycol-modified phenothiazine is dissolved in 50 mL of tetrahydrofuran (THF). Thereto 0.11 g of methanesulfonyl chloride, and 0.10 g of triethylamine are added. The mixture is stirred at room temperature for 2 hours. The solvent is evaporated to obtain methanesulfonylated polyethylene glycol-modified phenothiazine. This modified phenothiazine is dissolved in 100 mL of an aqueous 5% ammonia solution. The solution is stirred at room temperature for 2 days to obtain aminated polyethylene glycol-modified phenothiazine. Separately, glucose oxidase (Aspergillus niger) is treated with 10 mM of N-hydroxysuccinimide and 10 mM of 1-ethyl-3-(3-(dimethylamino)propyl)carbodiimide in a phosphate buffer solution for activation of the carboxyl group on the surface thereof. Thereto the above aminated polyethylene glycol-modified phenothiazine is added and the mixture is stirred at 25° C. for 24 hours. Therefrom the excess aminated polyethylene glycol-modified phenothiazine is eliminated by ultrafiltration to obtain the phenothiazine-modified glucose oxidase.

Enzyme preparation methods are described further.

### Preparation Example 24

An FAD-free apoglucose oxidase is prepared through the process below. Glucose oxidase (Aspergillus niger) is dissolved in 3 mL of a 0.25M sodium phosphate buffer solution (pH 6) containing 30% glycerol. This solution is cooled to 0° C., and the pH thereof is adjusted to 1.7 by addition of a 0.025M sodium phosphate buffer solution-sulfuric acid solution containing 30% glycerol (pH 1.1). This solution is allowed to pass through a Sephadex® G-25 column with a 0.1M sodium phosphate solution (pH: 1.7) containing 30% glycerol, and the intended fraction is recovered by monitoring with light of a wavelength of 280 nm. Dextran-coated charcoal is added to the recovered solution. The solution, after adjustment of pH to 7 by addition of a 1M sodium hydroxide solution, is stirred at 4° C. for one hour. The resulting solution is centrifuged, passed through a 0.45 μm filter, and dialyzed by use of a 0.1M sodium phosphate buffer solution to obtain the apoglucose oxidase.

### Preparation Example 25

A cytochrome oxidase is prepared as shown below. One kilogram of minced and washed bovine heart muscle is agitated with 4 L of a 0.02M phosphate buffer solution (pH: 7.4) for 6 minutes. The mixture is centrifuged at 2500G for 20 minutes. The supernatant is recovered. The precipitate is stirred again with 2 L of a 0.02M phosphate buffer solution (pH: 7.4) for 3 minutes, and the stirred mixture is centrifuged at 2500G for 20 minutes. The supernatant is recovered and is combined with the above-recovered supernatant. The pH of the combined supernatant is adjusted to 5.6. This liquid matter is centrifuged at 2500G for 20 minutes. The precipitate is dispersed again in 1 L of pure water, and centrifuged at 2500G for 20 minutes. The precipitate is dispersed again in 450 mL of a 0.02M phosphate buffer solution (pH: 7.4). Thereto 125 mL of a 10% NaCl solution, and 90 g of ammonium sulfate are added. The mixture is left standing at room temperature for two hours. A 41 g portion of ammonium sulfate is added thereto, and the mixture is centrifuged at 7000G for 20 minutes. To the recovered supernatant (500 mL), 50 g of ammonium sulfate is added, and the mixture is centrifuged at 7000G for 20 minutes. The precipitate is recovered, and is dissolved in 200 mL of a 0.1M phosphate buffer solution (pH: 7.4) containing 2% NaCl. A 66 mL portion of a saturated ammonium sulfate solution is added thereto. The mixture is left standing at 0° C. for 12 hours. Thereafter the mixture is centrifuged at 7000G for 20 minutes. To the recovered supernatant (200 mL), 31 mL of an aqueous saturated ammonium sulfate solution is added. The mixture is centrifuged at 7000G for 20 minutes. The precipitate is recovered and is dissolved in 100 mL of a 0.1M phosphate buffer solution (pH: 7.4) containing 2% NaCl. The solution is centrifuged at 7000G for 20 minutes to recover the precipitate. The precipitate is treated four times through steps: dissolution in 100 mL of a phosphate buffer solution; addition of 31 mL of an aqueous saturated ammonium sulfate solution; centrifuge; and precipitate recovery. Thereafter the recovered precipitate is dissolved in 30 mL of a 0.1M phosphate buffer solution (pH: 7.4) containing 1% Tween 80 to obtain a cytochrome oxidase solution.

### Preparation Example 26

A commercial polystyrene type latex colloid dispersion liquid (Nippon Zeon Co.; average particle size: 100 nm) is employed. The dispersion medium of the dispersion liquid is replaced by ethanol. A cleaned gold substrate is allowed to stand in the dispersion liquid. The ethanol is allowed to evaporate at 30° C. to obtain a porous film constituted of polystyrene spheres. This process is repeated several times to obtain a porous film constituted of polystyrene spheres of an intended film thickness (150 μm thick). The film is heated at 70° C. for 30 minutes, and then washed with ethanol. Using this porous film as the working electrode and a platinum electrode as the counter electrode, electro-deposition is conducted in an aqueous 0.1M nickel sulfate solution at a current density of 0.1 mA/cm² by control with a galvanostat. The time of the electro-deposition is controlled by monitoring the electrolysis current profile to obtain a film in a thickness nearly equivalent to the polystyrene film thickness. After the electro-deposition, the film is immersed in toluene for two days to remove the polystyrene spheres to obtain a conductive member constituted of nickel having numerous voids.

Methods for preparing a void size-gradient conductive member having numerous voids are described in Preparation Examples 27, 28, 29, 31, 33, 34, and 36. The diameters of particles can be measured by scanning electron microscopy, the sizes of the voids can be measured by gas adsorption measurement, and the film thicknesses can be measured by a surface roughness tester.

### Preparation Example 27

Two grades of commercial polystyrene type latex colloid dispersion liquids (Nippon Zeon Co.; average particle sizes: 100 nm and 200 nm) are employed. The dispersion medium of the respective dispersion liquids is replaced by ethanol. Firstly, a cleaned gold substrate is allowed to stand in the dispersion liquid of the average particle size of 100 nm. The ethanol is allowed to evaporate at 30° C. to obtain a porous film constituted of polystyrene spheres. This process is repeated several times to obtain a porous film constituted of 100-nm polystyrene spheres in an intended film thickness (50 μm thick). Secondly, on the porous film of 100-nm polystyrene spheres, a porous film constituted of polystyrene spheres of the average particle size of 200 nm is formed in the same manner as the 100-nm polystyrene sphere film (about 100 μm thick, total thickness: about 150 μm). The film is heated at 70° C. for 30 minutes, and then washed with ethanol. Thereafter, by using this porous film, a void size-gradient conductive member having numerous voids is prepared in the same manner as in Preparation Example 26.

### Preparation Example 28

Three grades of commercial polystyrene type latex colloid dispersion liquids (Nippon Zeon Co.; average particle sizes: 100 nm, 200 nm, and 300 nm) are employed. The dispersion medium of the respective dispersion liquids is replaced by ethanol. Firstly, a cleaned gold substrate is allowed to stand in the dispersion liquid of the average particle size of 100 nm. The ethanol is allowed to evaporate at 30° C. to obtain a porous film constituted of polystyrene spheres. This process is repeated several times to obtain a porous film constituted of 100-nm polystyrene spheres in an intended film thickness (about 50 μm thick). Secondly, on the porous film of 100-nm styrene spheres, a porous film constituted of polystyrene spheres of the average particle size of 200 nm is formed in the same manner as the 100-nm styrene sphere film (about 50 μm thick, total film thickness: about 100 μm). Thirdly, on the porous films of 100-nm and 200-nm styrene spheres, a porous film constituted of polystyrene spheres of the average particle size of 300 nm is formed in the same manner as the 100-nm styrene sphere film (about 50 μm thick, total thickness: about 150 μm). The film is heated at 70° C. for 30 minutes, and then washed with ethanol. Thereafter, by using this porous film, a void size-gradient conductive member having numerous voids is prepared in the same manner as in Preparation Example 26.

### Preparation Example 29

Two grades of commercial silica colloid dispersion liquids (Nissan Chemical Ind.; average particle sizes: 100 nm, and 300 nm) are employed. The dispersion medium of the respective dispersion liquids is replaced by ethanol. Firstly, a cleaned gold substrate is allowed to stand in the dispersion liquid of the average particle size of 100 nm. The ethanol is allowed to evaporate at 30° C. to obtain a porous film constituted of silica spheres. This process is repeated several times to increase the thickness of a porous film constituted of silica spheres (about 50 nm thick). Secondly, on the porous film of 100-nm silica sphere film formed above, a porous film constituted of silica spheres of average particle size of 300 nm is formed in the same manner as the formation of the 100-nm porous film (about 50 μm thick, total thickness: about 100 μm). The film is heated at 200° C. for three hours, and then washed with ethanol. In a three-electrode cell, with this porous film as the working electrode, a platinum electrode as the counter electrode, and an Ag/AgCl electrode as the reference electrode, electrolytic polymerization is conducted in a solution of 0.1M 3,4,-ethylenedioxythiophene and 0.1M lithium perchlorate in acetonitrile at a potential of 1.1 V (vs Ag/AgCl) by control with a potentiostat. The time of the polymerization is controlled by monitoring the electrolysis current profile to obtain a film in a thickness nearly equivalent to the silica sphere porous film thickness. After the electrolytic polymerization, the film is immersed in a 20% hydrofluoric acid solution for two days to remove the silica spheres to obtain a void size-gradient conductive member (100 μm thick) constituted of poly(3,4-ethylenedioxythiophene), an electroconductive polymer, having numerous voids.

### Preparation Example 30

Commercial fine particulate electroconductive titanium oxide (Titan Kogyo K.K.; particle diameter: about 250 nm) is dispersed in terpineol. The viscosity of the dispersion is adjusted by addition of ethylcellulose to obtain a titanium oxide paste. This titanium oxide paste is applied on a cleaned gold substrate by screen process printing, and is sintered at 450° C. for one hour to obtain a sintered porous titanium oxide film (100 μm thick). Using this porous film as the working electrode and a platinum wire as the counter electrode, electrolytic plating is conducted in a gold plating solution (Kamimura Kogyo K.K.; 535LC) in a jet flow of said gold-plating solution with an ultrasonic vibration at a current density of 0.1 mA/cm² by control with a galvanostat for one hour to obtain a conductive member constituted of gold-plated porous titanium oxide having numerous voids.

### Preparation Example 31

Two grades of commercial fine particulate electroconductive titanium oxide (Titan Kogyo K.K.; particle sizes: about 250 nm, and 400 nm) are respectively dispersed in terpineol, and the viscosities are respectively adjusted by addition of ethylcellulose to obtain titanium oxide pastes. The titanium oxide paste of the particle size of 250 nm is firstly applied on a cleaned gold substrate by screen process printing (in a sintered thickness of about 50 μm) and calcined at 150° C. for 5 minutes. Thereon, the titanium oxide paste of the particle size of about 400 nm is applied, and the paste is sintered at 450° C. for one hour to obtain a sintered porous titanium oxide film (total thickness: 100 μm). By use of this porous film, a void size-gradient conductive member constituted of gold-plated porous titanium oxide having numerous voids is prepared in the same manner as in Preparation Example 29.

### Preparation Example 32

Three sheets of a foamed nickel alloy (Mitsubishi Materials Corp.; MA600; thickness: 0.5 mm, pore size: 50 μm) are superposed and bonded by spot welding to obtain a conductive member having numerous voids constituted of the nickel alloy.

### Preparation Example 33

Two types of foamed nickel alloy sheets (Mitsubishi Materials Corp.; MA600; thickness: 0.5 mm, pore sizes: 50 μm, and 150 μm) are employed. One sheet of the pore size of 50 μm, and two sheets of the pore size of 150 μm are superposed in this order (three sheets in total), and bonded by spot welding to obtain a void size-gradient conductive member constituted of the nickel alloy having numerous voids.

### Preparation Example 34

Three types of foamed nickel alloy sheets (Mitsubishi Materials Corp.; MA600; thickness: 0.5 mm, pore sizes: 50 μm, 150 μm, and 300 μm) are employed. The sheet of the pore size of 50 μm, the sheet of the pore size of 150 μm, and the sheet of the pore size of 300 μm are superposed in this order (three sheets in total), and bonded by spot welding to obtain a void size-gradient conductive member constituted of the nickel alloy having numerous voids.

### Preparation Example 35

Two sheets of carbon fiber (Toray Ind.; Toreca Cloth; thickness: 0.2 mm; fiber density: 40 fibers/25 cm) are superposed, and are cut in 1 cm square. The cut sheets are united by applying carbon paste (SPI Co.) on four side peripheries to obtain a conductive member constituted of carbon fiber and having numerous voids.

### Preparation Example 36

Two types of sheets of carbon fiber (Toray Ind.; Toreca Cloth; thickness: 0.2 mm; fiber density: 40 fibers/25 cm and 22.5 fibers/25 cm) are superposed, and are cut in 1 cm square. The cut sheets are united by applying carbon paste (SPI Co.) on four side peripheries to obtain a void size-gradient conductive member constituted of carbon fiber having numerous voids.

The process for producing the enzyme electrode of the present invention is described below.

### Example 1

A sheet of gold-plated foamed stainless steel (Mitsubishi Materials Corp.; SUS316L (constituting elements: Fe, Cr, Ni, Mo, Si, O, Mn, C, P, S, and Au); thickness: 0.5 mm; gold plating thickness 0.5 μm; pore size: 50 μm) is cut in 1 cm square; washed and dried; and subjected to UV-ozone treatment for hydrophilicity. An electrolytic solution is prepared by mixing 1 mL of an aqueous solution containing 1.0 mg/mL of glucose oxidase (Aspergillus niger) and 1 wt % Triton X-100® and 9 mL of an aqueous solution of 0.1M pyrrole and 0.1M lithium perchlorate. Electrolytic polymerization is conducted with the electrolytic solution with the above foamed metal as the working electrode, a platinum wire as the counter electrode, and an Ag/AgCl electrode as the reference electrode in a nitrogen atmosphere by applying 100 pulses of 1.1 V (vs Ag/AgCl) for one second and 0.35 V for 30 seconds. The working electrode after the electrolytic polymerization is washed with water to obtain a glucose-oxidase enzyme electrode containing polypyrrole serving simultaneously as the carrier and the mediator (carrier-and-mediator).

### Example 2

An alcohol-dehydrogenase enzyme electrode employing polypyrrole as the carrier-and-mediator is prepared in the same manner as in Example 1 except that 245 U/mL of quinohemoprotein-alcohol dehydrogenase (Gluconobacter sp-33) is used instead of 1.0 mg/mL of glucose oxidase (Aspergillus niger).

### Example 3

A glucose-oxidase enzyme electrode employing poly(3,4-ethylenedioxythiophene) as the carrier-and-mediator is prepared in the same manner as in Example 1 except that 3,4-ethylenedioxythiophene is used instead of pyrrole.

### Example 4

An alcohol-dehydrogenase enzyme electrode employing poly(3,4-ethylenedioxythiophene) as the carrier-and-mediator is prepared in the same manner as in Example 2 except that 3,4-ethylenedioxythiophene is used instead of pyrrole.

### Example 5

A glucose-oxidase enzyme electrode employing polyaniline as the carrier-and-mediator is prepared in the same manner as in Example 1 except that aniline is used instead of pyrrole.

### Example 6

An alcohol-dehydrogenase enzyme electrode employing polyaniline as the carrier-and-mediator is prepared in the same manner as in Example 2 except that aniline is used instead of pyrrole.

### Example 7

In 5 mL of water in a sample tube, the osmium polymer prepared in Preparation Example 17 is dissolved at a concentration of 10 mg/mL. Thereto, 1 mL of a 0.2M citrate buffer solution, and 1 mL of an aqueous solution of 30 mg/mL laccase (Coriolus hirsutus) are added, and the mixture is stirred. Thereto, 2 mL of an aqueous 10 mg/mL polyethylene glycol diglycidyl ether solution is added and the mixture is stirred. Separately, a sheet of gold-plated foamed stainless steel (Mitsubishi Materials Corp., SUS316L (constituting elements: Fe, Cr, Ni, Mo, Si, O, Mn, C, P, S, and Au), thickness: 0.5 mm, gold-plating thickness: 0.5 μm, pore size: 50 μm) is cut in 1 cm square, cleaned, and subjected to UV-ozone treatment. This cut sheet is immersed in the above prepared enzyme-osmium polymer solution, taken out, and dried in a desiccator for two days to obtain an enzyme electrode.

### Example 8

In 5 mL of water in a sample tube, the osmium polymer prepared in Preparation Example 18 is dissolved at a concentration of 10 mg/mL. Thereto, are added 1 mL of a phosphate buffer solution, 1 mL of an aqueous 46 mg/mL bilirubin oxidase solution, and 1 mL of an aqueous 7 mg/mL polyethylene glycol diglycidyl ether solution. Separately, a sheet of gold-plated foamed stainless steel (Mitsubishi Materials Corp., SUS316L (constituting elements: Fe, Cr, Ni, Mo, Si, O, Mn, C, P, S, and Au), thickness: 0.5 mm, gold-plating thickness: 0.5 μm, pore size: 50 μm) is cut in 1 cm square, cleaned, and subjected to UV-ozone treatment. This cut sheet is immersed in the above prepared enzyme-osmium polymer solution, taken out, and dried in a desiccator for two days to obtain an enzyme electrode.

### Example 9

In a sample tube, is prepared 1 mL of an aqueous 40 mg/mL solution of ferrocene-modified glucose oxidase shown in Preparation Example 19 in 0.1M sodium hydrogencarbonate. Thereto, 0.5 mL of an aqueous 7 mg/mL sodium periodate solution is added, and the mixture is stirred in the dark for one hour. Thereto, are added 6 mL of an aqueous 4 mg/mL polyvinylimidazole solution and 0.4 mL of an aqueous 2.5 mg/mL polyethylene glycol diglycidyl ether solution. Separately, a sheet of gold-plated foamed stainless steel (Mitsubishi Materials Corp., SUS316L (constituting elements: Fe, Cr, Ni, Mo, Si, O, Mn, C, P, S, and Au), thickness: 0.5 mm, gold-plating thickness: 0.5 μm, pore size: 50 μm) is cut in 1 cm square, cleaned, and subjected to UV-ozone treatment. This cut sheet is immersed in the above prepared modified enzyme solution, taken out, and dried in a desiccator for two days to obtain an enzyme electrode.

### Example 10

In a sample tube, is prepared 1 mL of an aqueous solution containing 40 mg/mL glucose oxidase (Aspergillus niger) and 0.1M sodium hydrogen carbonate. Thereto, 0.5 mL of an aqueous 7 mg/mL sodium periodate solution is added, and the mixture is stirred in the dark for one hour. Thereto, are added 6 mL of an aqueous 10 mg/mL solution of the ruthenium complex polymer prepared in Preparation Example 20 and 0.4 mL of an aqueous 2.5 mg/mL polyethylene glycol diglycidyl ether solution. Separately, a sheet of gold-plated foamed stainless steel (Mitsubishi Materials Corp., SUS316L (constituting elements: Fe, Cr, Ni, Mo, Si, O, Mn, C, P, S, and Au), thickness: 0.5 mm, gold-plating thickness: 0.5 μm, pore size: 50 μm) is cut in 1 cm square, cleaned, and subjected to UV-ozone treatment. This cut sheet is immersed in the above prepared modified enzyme solution, taken out, and dried in a desiccator for two days to obtain an enzyme electrode.

### Example 11

An enzyme electrode is prepared in the same manner as in Example 10 except that the cobalt complex polymer shown in Preparation Example 21 is used instead of the ruthenium complex polymer of Preparation Example 20.

### Example 12

Into 5 mL of a phosphate buffer solution, are added 34 units of glucose dehydrogenase (Thermoplasma acidophilum), 27 units of diaphorase (Spinacia oleracea), 0.22 mg of vitamin K3, 0.15 mg of nicotinamide adenine dinucleotide (NADH), and 0.13 mg of polyvinylpyridine (average mol wt: 150,000). Thereto 0.4 mL of an aqueous 2.5 mg/mL polyethylene glycol diglycidyl ether solution, and the mixture is stirred. Separately, a sheet of gold-plated foamed stainless steel (Mitsubishi Materials Corp., SUS316L (constituting elements: Fe, Cr, Ni, Mo, Si, O, Mn, C, P, S, and Au), thickness: 0.5 mm, gold-plating thickness: 0.5 μm, pore size: 50 μm) is cut in 1 cm square, cleaned, and subjected to UV-ozone treatment. This cut sheet is immersed in the above prepared modified enzyme solution, taken out, and dried in a desiccator for two days to obtain an enzyme electrode.

### Example 13

An enzyme electrode is prepared in the same manner as in Example 12 except that 0.27 mg of anthraquinone is used instead of 0.22 mg of vitamin K3.

### Example 14

An enzyme electrode is prepared in the same manner as in Example 9 except that the phenothiazine-modified glucose oxidase shown in Preparation Example 23 is used instead of the ferrocene-modified glucose oxidase of Preparation Example 19.

### Example 15

In a sample tube, is prepared 1 mL of an aqueous solution containing 40 mg/mL glucose oxidase (Aspergillus niger) and 0.1M sodium hydrogencarbonate. Thereto, 0.5 mL of an aqueous 7 mg/mL sodium periodate solution is added, and the mixture is stirred in the dark for one hour. Thereto, are added 6 mL of an aqueous 10 mg/mL solution of the osmium complex polymer prepared in Preparation Example 16 and 0.4 mL of an aqueous 2.5 mg/mL polyethylene glycol diglycidyl ether solution. Separately, a sheet of gold-plated foamed stainless steel (Mitsubishi Materials Corp., SUS316L (constituting elements: Fe, Cr, Ni, Mo, Si, O, Mn, C, P, S, and Au), thickness: 0.5 mm, gold-plating thickness: 0.5 μm, pore size: 50 μm) is cut in 1 cm square, cleaned, and subjected to UV-ozone treatment. This cut sheet is immersed in the above prepared modified enzyme solution, then taken out, and dried in a desiccator for two days to obtain an enzyme electrode.

### Example 16

To 1.8 mL of a 0.1M phosphate buffer solution, are added 0.25 mL of a 1M N-(3-(trimethoxysilyl)propyl)ethylenediamine solution and 0.25 mL of a 0.01M chlorauric acid solution. The mixture is irradiated with an ultrasonic wave for 10 minutes. Hydrochloric acid is added to the mixture to adjust the pH to 7, and 0.013 mL of a 0.1M sodium boron hydride solution is added thereto. The resulting sol is stirred for 24 hours to prepare a silica sol containing fine particulate gold. Separately, 10 mg of glucose oxidase is dissolved in 6 mL of a 0.05M phosphate buffer solution (pH: 7.0). Therein 1.6 g of polyvinylpyridine is added and mixed uniformly. The resulting mixture solution is added to the above obtained silica sol containing fine particulate gold uniformly by stirring. Separately, a sheet of gold-plated foamed stainless steel (Mitsubishi Materials Corp., SUS316L (constituting elements: Fe, Cr, Ni, Mo, Si, O, Mn, C, P, S, and Au), thickness: 0.5 mm, gold-plating thickness: 0.5 μm, pore size: 50 μm) is cut in 1 cm square, cleaned, and subjected to UV-ozone treatment. This cut sheet is immersed in the above prepared mixture solution, then taken out, and dried in a desiccator for two days to obtain an enzyme electrode.

### Example 17

An enzyme electrode is prepared in the same manner as in Example 16 except that palladium chloride is used instead of the chloroauric acid.

### Example 18

In a nitrogen atmosphere, 0.25 mL of titanium(IV) isopropoxide is dissolved in a small amount of isopropanol. Thereto, 1.8 mL of a 0.1M phosphate buffer solution and 0.25 mL of a 0.01M chloroauric acid solution are added. The resulting mixture is irradiated with ultrasonic wave for one hour. The pH of the mixture is adjusted to 7 by addition of 0.1M hydrochloric acid. Thereto 0.013 mL of a 0.1M sodium boron hydride is added, and the mixture is stirred for 24 hours to obtain titania sol containing fine particulate gold. Separately, 10 mg of glucose oxidase is dissolved in 6 mL of a 0.05M phosphate buffer solution (pH: 7.0) and 1.6 g of polyvinylpyridine is added thereto and stirred uniformly. This mixture is added to the above prepared titania sol containing fine particulate gold. The resulting mixture is stirred uniformly. Separately, a sheet of gold-plated foamed stainless steel (Mitsubishi Materials Corp., SUS316L (constituting elements: Fe, Cr, Ni, Mo, Si, O, Mn, C, P, S, and Au), thickness: 0.5 mm, gold-plating thickness: 0.5 μm, pore size: 50 μm) is cut in 1 cm square, cleaned, and subjected to UV-ozone treatment. This cut sheet is immersed in the above prepared mixture solution, then taken out, and dried in a desiccator for two days to obtain an enzyme electrode.

### Example 19

An enzyme electrode is prepared in the same manner as in Example 18 except that palladium chloride is used instead of the chloroauric acid.

### Example 20

In 8 mL of a 0.1M phosphate buffer solution, is dissolved 20 mg of polylysine hydrochloride (average mol wt: 70,000). Thereto are added 40 mg of bilirubin oxidase and 27 mg of potassium octacyanotungstate. The mixture is stirred at 0° C. for one hour. Separately, a sheet of gold-plated foamed stainless steel (Mitsubishi Materials Corp., SUS316L (constituting elements: Fe, Cr, Ni, Mo, Si, O, Mn, C, P, S, and Au), thickness: 0.5 mm, gold-plating thickness: 0.5 μm, pore size: 50 μm) is cut in 1 cm square, cleaned, and subjected to UV-ozone treatment. This cut sheet is immersed in the above prepared solution, then taken out, and dried in a desiccator for two days to obtain an enzyme electrode.

### Example 21

Into 5 mL of a phosphate buffer solution, are added 34 units of glucose dehydrogenase (Thermoplasma acidophilum), 27 units of diaphorase (Spinacia oleracea), 0.22 mg of vitamin K3, and 0.15 mg of NADH; and further 0.5 mL of 1% bovin serum albumin, and 0.4 mL of a 2.5 mg/mL glutalaldehyde solution. The mixture is stirred. Separately, a sheet of gold-plated foamed stainless steel (Mitsubishi Materials Corp., SUS316L (constituting elements: Fe, Cr, Ni, Mo, Si, O, Mn, C, P, S, and Au), thickness: 0.5 mm, gold-plating thickness: 0.5 μm, pore size: 50 μm) is cut in 1 cm square, cleaned, and subjected to UV-ozone treatment. This cut sheet is immersed in an aqueous 0.02M aminoethanethiol solution for 2 hours, then taken out and washed with water. Thereafter the aminoethanethiol-treated sheet is immersed in the above prepared enzyme solution, then taken out, and dried in a desiccator for two days to obtain an enzyme electrode.

### Example 22

A sheet of gold-plated foamed stainless steel (Mitsubishi Materials Corp., SUS316L (constituting elements: Fe, Cr, Ni, Mo, Si, O, Mn, C, P, S, and Au), thickness: 0.5 mm, gold-plating thickness: 0.5 μm, pore size: 50 μm) is cut in 1 cm square, cleaned, and subjected to UV-ozone treatment. This cut sheet is immersed in an aqueous 0.02M cystamine solution for 2 hours, then taken out, and washed with water to prepare a cystamine-modified electrode. This cystamine-modified electrode is immersed in a 0.01M N-2-hydroxyethylpiperazine-N′-2-ethanesulfonic acid (HEPES) buffer solution containing 3 mM pyrroloquinolineqinone (PQQ) and 10 mM of 1-ethyl-3-(3-dimethylaminopropyl)carbodiimide for one hour and washed with water to modify the electrode with PQQ. Further, this PQQ-modified electrode is immersed in a 0.01M HEPES buffer solution (pH: 7.3) containing 1 mM N⁶-(2-aminoethyl)FAD described in Preparation Example 22 and 10 mM 1-ethyl-3-(3-dimethylaminopropyl)carbodiimide for 2 hours and washed with water to modify the electrode with FAD. Further, this modified electrode is immersed in a 0.1M phosphate buffer solution (pH: 7.0) containing 4 mg/mL of the apoglucose oxidase described in Preparation Example 24 at 25° C. for 4 hours, and at 4° C. for 12 hours, then taken out, and further immersed in a phosphate buffer solution (pH: 7.0) to prepare an enzyme electrode.

### Example 23

A 0.06 mM portion of fine particulate gold (Nanoprobes) modified by sulfo-N-hydroxysuccinimide, and 0.68 mM of N⁶-(2-aminoethyl)FAD described in Preparation Example 22 dissolved in 0.01M HEPES buffer solution (pH: 7.9) are stirred at room temperature for one hour and 4° C. for 12 hours to allow the fine particulate gold and the N⁶-(2-aminoethyl)FAD to react. The unreacted N⁶-(2-aminoethyl)FAD is eliminated by Spin Column (Sigma) to prepare fine particulate FAD-modified gold. Further, 3 mg/mL of apoglucose oxidase described in Preparation Example 24, and 4.8 μM of the above FAD-modified fine particulate gold are stirred in a 0.1M phosphate buffer solution containing 30% glycerol, 0.1% bovin serum albumin, and 0.1% sodium azide at room temperature for 4 hours and at 4° C. for 12 hours. Then resulting glucose oxidase-modified fine particulate gold is separated by centrifugation. Separately, a sheet of gold-plated foamed stainless steel (Mitsubishi Materials Corp., SUS316L (constituting elements: Fe, Cr, Ni, Mo, Si, O, Mn, C, P, S, and Au), thickness: 0.5 mm, gold-plating thickness: 0.5 μm, pore size: 50 μm) is cut in 1 cm square, cleaned, and subjected to UV-ozone treatment. This cut sheet is immersed in an aqueous 0.02M cystamine solution for 2 hours, then taken out, and washed with water to prepare a cystamine-modified electrode. Thereafter the cystamine-modified electrode is immersed in a 1 μM solution of glucose oxidase-modified fine particulate gold in a phosphate buffer solution at 4° C. for 12 hours to prepare an enzyme electrode.

### Example 24

A sheet of gold-plated foamed stainless steel (Mitsubishi Materials Corp., SUS316L (constituting elements: Fe, Cr, Ni, Mo, Si, O, Mn, C, P, S, and Au), thickness: 0.5 mm, gold-plating thickness: 0.5 μm, pore size: 50 μm) is cut in 1 cm square, cleaned, and subjected to UV-ozone treatment. This cut sheet is immersed in a 1 mM cystamine solution in ethanol for 2 hours, taken out, and washed with water to prepare a cystamine-modified base plate. This base plate is immersed in a solution of 1 mM 1,2-dehydro-1,2-methanofullerene[60]-61-carboxylic acid (Material Technologies Research Limited) and 5 mM 1-ethyl-3-(3-dimethylaminopropyl)carbodiimide in ethanol:dimethylsulfoxide (DMSO) (1:1) at room temperature for 4 hours, and washed with ethanol:DMSO mixed solvent to prepare a fullerene-modified base plate. Separately 0.8 mL of a 2.5 mg/mL glutaraldehyde solution is added to 10 mL of a 30 mg/mL glucose oxidase (Aspergillus niger) in a phosphate buffer solution and stirred. In this solution, the above fullerene-modified base plate is immersed at room temperature for one hour and at 4° C. for 12 hours, then taken out, and washed with a phosphate buffer solution, and dried in a desiccator for 2 days to prepare an enzyme electrode.

### Example 25

A sheet of gold-plated foamed stainless steel (Mitsubishi Materials Corp., SUS316L (constituting elements: Fe, Cr, Ni, Mo, Si, O, Mn, C, P, S, and Au), thickness: 0.5 mm, gold-plating thickness: 0.5 μm, pore size: 50 μm) is cut in 1 cm square, cleaned, and subjected to UV-ozone treatment. This cut sheet is immersed in an aqueous 0.02M cystamine solution for 2 hours, then taken out, and washed with water. This sheet is immersed in a solution of 0.3 mM microperoxidase 11 (MP11) and 10 mM 1-ethyl-3-(3-dimethylaminopropyl)carbodiimide in 0.01M HEPES buffer solution for three hours, then taken out, and immersed in a 0.01M HEPES buffer solution (pH: 7.3) for one hour to prepare an enzyme electrode.

### Example 26

A sheet of gold-plated foamed stainless steel (Mitsubishi Materials Corp., SUS316L (constituting elements: Fe, Cr, Ni, Mo, Si, O, Mn, C, P, S, and Au), thickness: 0.5 mm, gold-plating thickness: 0.5 μm, pore size: 50 μm) is cut in 1 cm square, cleaned, and subjected to UV-ozone treatment. This cut sheet is immersed in an aqueous 0.02M cystamine solution for 2 hours, then taken out, and washed with water to prepare a cystamine-modified electrode. This cystamine-modified electrode is immersed in a 0.01M HEPES buffer solution containing 3 mM N-succinimidyl-3-maleimidopropionate and 10 mM 1-ethyl-3-(3-dimethylaminopropyl)carbodiimide for one hour, and is washed with a 0.01M HEPES buffer solution for modification. This electrode is immersed in a 0.1M phosphate buffer solution (pH: 7.0) containing 4 mg/mL cytochrome C at 25° C. for 4 hours and at 4° C. for 12 hours, then taken out, and immersed in a phosphate buffer solution (pH: 7.0) for one hour to modify the maleimide by the thiol group of the enzyme. Further, this electrode is immersed in a 0.1M phosphate buffer solution (pH: 7.0) containing 4 mg/mL cytochrome oxidase described in Preparation Example 25 at 25° C. for 4 hours and at 4° C. for 12 hours, then taken out, and immersed in a phosphate buffer solution (pH: 7.0) for one hour to couple the cytochrome C with the cytochrome oxidase. Then the electrode is immersed in a 10 mM glutaraldehyde solution in 0.1M phosphate buffer solution (pH: 7.0) at 25° C. for 10 minutes and 4° C. for one hour to obtain an immobilized-enzyme electrode.

### Example 27

An enzyme electrode is prepared in the same manner as in Example 4 except that a foamed nickel alloy (Mitsubishi Materials Corp., constituting elements: Ni, Cr, Ti, Nb, Al, Mn, Si, and C; thickness: 0.5 mm; gold-plating thickness: 0.5 μm, pore size: 50 μm) is used instead of the gold-plated foamed stainless steel.

### Example 28

An enzyme electrode is prepared in the same manner as in Example 8 except that a foamed nickel alloy (Mitsubishi Materials Corp., constituting elements: Ni, Cr, Ti, Nb, Al, Mn, Si, and C; thickness: 0.5 mm; gold-plating thickness: 0.5 μm, pore size: 50 μm) is used instead of the gold-plated foamed stainless steel.

### Example 29

An enzyme electrode is prepared in the same manner as in Example 15 except that a foamed nickel alloy (Mitsubishi Materials Corp., constituting elements: Ni, Cr, Ti, Nb, Al, Mn, Si, and C; thickness: 0.5 mm; gold-plating thickness: 0.5 μm, pore size: 50 μm) is used instead of the gold-plated foamed stainless steel.

### Example 30

An enzyme electrode is prepared in the same manner as in Example 18 except that a foamed nickel alloy (Mitsubishi Materials Corp., constituting elements: Ni, Cr, Ti, Nb, Al, Mn, Si, and C; thickness: 0.5 mm; gold-plating thickness: 0.5 μm; pore size: 50 μm) is used instead of the gold-plated foamed stainless steel.

### Example 31

An enzyme electrode is prepared in the same manner as in Example 4 except that the conductive member constituted of void-containing nickel described in Preparation Example 1 is used instead of the gold-plated foamed stainless steel.

### Example 32

An enzyme electrode is prepared in the same manner as in Example 8 except that the conductive member constituted of void-containing nickel described in Preparation Example 1 is used instead of the gold-plated foamed stainless steel.

### Example 33

An enzyme electrode is prepared in the same manner as in Example 15 except that the conductive member constituted of void-containing nickel described in Preparation Example 1 is used instead of the gold-plated foamed stainless steel.

### Example 34

An enzyme electrode is prepared in the same manner as in Example 18 except that the conductive member constituted of void-containing nickel described in Preparation Example 1 is used instead of the gold-plated foamed stainless steel.

### Example 35

An enzyme electrode is prepared in the same manner as in Example 4 except that a stainless steel net (Nilaco; constituting elements: Fe, Cr, Ni, Mo, Si, O, Mn, C, P, and S; 400 mesh) is used instead of the gold-plated foamed stainless steel.

### Example 36

An enzyme electrode is prepared in the same manner as in Example 8 except that a stainless steel net (Nilaco; constituting elements: Fe, Cr, Ni, Mo, Si, O, Mn, C, P, and S; 400 mesh) is used instead of the gold-plated foamed stainless steel.

### Example 37

An enzyme electrode is prepared in the same manner as in Example 15 except that a stainless steel net (Nilaco; constituting elements: Fe, Cr, Ni, Mo, Si, O, Mn, C, P, and S; 400 mesh) is used instead of the gold-plated foamed stainless steel.

### Example 38

An enzyme electrode is prepared in the same manner as in Example 18 except that a nickel alloy net (Nilaco; constituting elements: Fe, Cr, Ni, Mo, Si, O, Mn, C, P, and S; 400 mesh) is used instead of the gold-plated foamed stainless steel.

### Example 39

An enzyme electrode is prepared in the same manner as in Example 4 except that the conductive member constituted of void-containing platinum described in Preparation Example 2 is used instead of the gold-plated foamed stainless steel.

### Example 40

An enzyme electrode is prepared in the same manner as in Example 8 except that the conductive member constituted of void-containing platinum described in Preparation Example 2 is used instead of the gold-plated foamed stainless steel.

### Example 41

An enzyme electrode is prepared in the same manner as in Example 15 except that the conductive member constituted of void-containing platinum described in Preparation Example 2 is used instead of the gold-plated foamed stainless steel.

### Example 42

An enzyme electrode is prepared in the same manner as in Example 18 except that the conductive member constituted of void-containing platinum described in Preparation Example 2 is used instead of the gold-plated foamed stainless steel.

### Example 43

An enzyme electrode is prepared in the same manner as in Example 4 except that the conductive member constituted of void-containing gold described in Preparation Example 3 is used instead of the gold-plated foamed stainless steel.

### Example 44

An enzyme electrode is prepared in the same manner as in Example 8 except that the conductive member constituted of void-containing gold described in Preparation Example 3 is used instead of the gold-plated foamed stainless steel.

### Example 45

An enzyme electrode is prepared in the same manner as in Example 15 except that the conductive member constituted of void-containing gold described in Preparation Example 3 is used instead of the gold-plated foamed stainless steel.

### Example 46

An enzyme electrode is prepared in the same manner as in Example 18 except that the conductive member constituted of void-containing gold described in Preparation Example 3 is used instead of the gold-plated foamed stainless steel.

### Example 47

An enzyme electrode is prepared in the same manner as in Example 24 except that the conductive member constituted of void-containing gold described in Preparation Example 3 is used instead of the gold-plated foamed stainless steel.

### Example 48

An enzyme electrode is prepared in the same manner as in Example 4 except that the conductive member constituted of void-containing palladium described in Preparation Example 4 is used instead of the gold-plated foamed stainless steel.

### Example 49

An enzyme electrode is prepared in the same manner as in Example 8 except that the conductive member constituted of void-containing palladium described in Preparation Example 4 is used instead of the gold-plated foamed stainless steel.

### Example 50

An enzyme electrode is prepared in the same manner as in Example 15 except that the conductive member constituted of void-containing palladium described in Preparation Example 4 is used instead of the gold-plated foamed stainless steel.

### Example 51

An enzyme electrode is prepared in the same manner as in Example 18 except that the conductive member constituted of void-containing palladium described in Preparation Example 4 is used instead of the gold-plated foamed stainless steel.

### Example 52

An enzyme electrode is prepared in the same manner as in Example 4 except that the conductive member constituted of a void-containing polypyrrole electrode described in Preparation Example 5 is used instead of the gold-plated foamed stainless steel.

### Example 53

An enzyme electrode is prepared in the same manner as in Example 8 except that the conductive member constituted of a void-containing polypyrrole electrode described in Preparation Example 5 is used instead of the gold-plated foamed stainless steel.

### Example 54

An enzyme electrode is prepared in the same manner as in Example 15 except that the conductive member constituted of a void-containing polypyrrole electrode described in Preparation Example 5 is used instead of the gold-plated foamed stainless steel.

### Example 55

An enzyme electrode is prepared in the same manner as in Example 18 except that the conductive member constituted of a void-containing polypyrrole electrode described in Preparation Example 5 is used instead of the gold-plated foamed stainless steel.

### Example 56

An enzyme electrode is prepared in the same manner as in Example 1 except that the conductive member constituted of void-containing poly(3,4-ethylenedioxythiophene) described in Preparation Example 6 is used instead of the gold-plated foamed stainless steel.

### Example 57

An enzyme electrode is prepared in the same manner as in Example 2 except that the conductive member constituted of void-containing poly(3,4-ethylenedioxythiophene) described in Preparation Example 6 is used instead of the gold-plated foamed stainless steel.

### Example 58

An enzyme electrode is prepared in the same manner as in Example 3 except that the conductive member constituted of void-containing poly(3,4-ethylenedioxythiophene) described in Preparation Example 6 is used instead of the gold-plated foamed stainless steel.

### Example 59

An enzyme electrode is prepared in the same manner as in Example 4 except that the conductive member constituted of void-containing poly(3,4-ethylenedioxythiophene) described in Preparation Example 6 is used instead of the gold-plated foamed stainless steel.

### Example 60

An enzyme electrode is prepared in the same manner as in Example 5 except that the conductive member constituted of void-containing poly(3,4-ethylenedioxythiophene) described in Preparation Example 6 is used instead of the gold-plated foamed stainless steel.

### Example 61

An enzyme electrode is prepared in the same manner as in Example 6 except that the conductive member constituted of void-containing poly(3,4-ethylenedioxythiophene) described in Preparation Example 6 is used instead of the gold-plated foamed stainless steel.

### Example 62

An enzyme electrode is prepared in the same manner as in Example 7 except that the conductive member constituted of void-containing poly(3,4-ethylenedioxythiophene) described in Preparation Example 6 is used instead of the gold-plated foamed stainless steel.

### Example 63

An enzyme electrode is prepared in the same manner as in Example 8 except that the conductive member constituted of void-containing poly(3,4-ethylenedioxythiophene) described in Preparation Example 6 is used instead of the gold-plated foamed stainless steel.

### Example 64

An enzyme electrode is prepared in the same manner as in Example 9 except that the conductive member constituted of void-containing poly(3,4-ethylenedioxythiophene) described in Preparation Example 6 is used instead of the gold-plated foamed stainless steel.

### Example 65

An enzyme electrode is prepared in the same manner as in Example 10 except that the conductive member constituted of void-containing poly(3,4-ethylenedioxythiophene) described in Preparation Example 6 is used instead of the gold-plated foamed stainless steel.

### Example 66

An enzyme electrode is prepared in the same manner as in Example 11 except that the conductive member constituted of void-containing poly(3,4-ethylenedioxythiophene) described in Preparation Example 6 is used instead of the gold-plated foamed stainless steel.

### Example 67

An enzyme electrode is prepared in the same manner as in Example 12 except that the conductive member constituted of void-containing poly(3,4-ethylenedioxythiophene) described in Preparation Example 6 is used instead of the gold-plated foamed stainless steel.

### Example 68

An enzyme electrode is prepared in the same manner as in Example 13 except that the conductive member constituted of void-containing poly(3,4-ethylenedioxythiophene) described in Preparation Example 6 is used instead of the gold-plated foamed stainless steel.

### Example 69

An enzyme electrode is prepared in the same manner as in Example 14 except that the conductive member constituted of void-containing poly(3,4-ethylenedioxythiophene) described in Preparation Example 6 is used instead of the gold-plated foamed stainless steel.

### Example 70

An enzyme electrode is prepared in the same manner as in Example 15 except that the conductive member constituted of void-containing poly(3,4-ethylenedioxythiophene) described in Preparation Example 6 is used instead of the gold-plated foamed stainless steel.

### Example 71

An enzyme electrode is prepared in the same manner as in Example 16 except that the conductive member constituted of void-containing poly(3,4-ethylenedioxythiophene) described in Preparation Example 6 is used instead of the gold-plated foamed stainless steel.

### Example 72

An enzyme electrode is prepared in the same manner as in Example 17 except that the conductive member constituted of void-containing poly(3,4-ethylenedioxythiophene) described in Preparation Example 6 is used instead of the gold-plated foamed stainless steel.

### Example 73

An enzyme electrode is prepared in the same manner as in Example 18 except that the conductive member constituted of void-containing poly(3,4-ethylenedioxythiophene) described in Preparation Example 6 is used instead of the gold-plated foamed stainless steel.

### Example 74

An enzyme electrode is prepared in the same manner as in Example 19 except that the conductive member constituted of void-containing poly(3,4-ethylenedioxythiophene) described in Preparation Example 6 is used instead of the gold-plated foamed stainless steel.

### Example 75

An enzyme electrode is prepared in the same manner as in Example 20 except that the conductive member constituted of void-containing poly(3,4-ethylenedioxythiophene) described in Preparation Example 6 is used instead of the gold-plated foamed stainless steel.

### Example 76

An enzyme electrode is prepared in the same manner as in Example 4 except that the conductive member constituted of void-containing poly(3,4-ethylenedioxythiophene)-poly(styrenesulfonate) described in Preparation Example 7 is used instead of the gold-plated foamed stainless steel.

### Example 77

An enzyme electrode is prepared in the same manner as in Example 8 except that the conductive member constituted of void-containing poly(3,4-ethylenedioxythiophene)-poly(styrenesulfonate) described in Preparation Example 7 is used instead of the gold-plated foamed stainless steel.

### Example 78

An enzyme electrode is prepared in the same manner as in Example 15 except that the conductive member constituted of void-containing poly(3,4-ethylenedioxythiophene)-poly(styrenesulfonate) described in Preparation Example 7 is used instead of the gold-plated foamed stainless steel.

### Example 79

An enzyme electrode is prepared in the same manner as in Example 18 except that the conductive member constituted of void-containing poly(3,4-ethylenedioxythiophene)-poly(styrenesulfonate) described in Preparation Example 7 is used instead of the gold-plated foamed stainless steel.

### Example 80

An enzyme electrode is prepared in the same manner as in Example 4 except that the conductive member constituted of void-containing polyaniline described in Preparation Example 8 is used instead of the gold-plated foamed stainless steel.

### Example 81

An enzyme electrode is prepared in the same manner as in Example 8 except that the conductive member constituted of void-containing polyaniline described in Preparation Example 8 is used instead of the gold-plated foamed stainless steel.

### Example 82

An enzyme electrode is prepared in the same manner as in Example 15 except that the conductive member constituted of void-containing polyaniline described in Preparation Example 8 is used instead of the gold-plated foamed stainless steel.

### Example 83

An enzyme electrode is prepared in the same manner as in Example 18 except that the conductive member constituted of void-containing polyaniline described in Preparation Example 8 is used instead of the gold-plated foamed stainless steel.

### Example 84

An enzyme electrode is prepared in the same manner as in Example 4 except that the conductive member constituted of void-containing ITO described in Preparation Example 9 is used instead of the gold-plated foamed stainless steel.

### Example 85

An enzyme electrode is prepared in the same manner as in Example 8 except that the conductive member constituted of void-containing ITO described in Preparation Example 9 is used instead of the gold-plated foamed stainless steel.

### Example 86

An enzyme electrode is prepared in the same manner as in Example 15 except that the conductive member constituted of void-containing ITO described in Preparation Example 9 is used instead of the gold-plated foamed stainless steel.

### Example 87

An enzyme electrode is prepared in the same manner as in Example 18 except that the conductive member constituted of void-containing ITO described in Preparation Example 9 is used instead of the gold-plated foamed stainless steel.

### Example 88

An enzyme electrode is prepared in the same manner as in Example 4 except that the void-containing conductive member constituted of gold-plated porous titanium oxide described in Preparation Example 10 is used instead of the gold-plated foamed stainless steel.

### Example 89

An enzyme electrode is prepared in the same manner as in Example 8 except that the void-containing conductive member constituted of gold-plated porous titanium oxide described in Preparation Example 10 is used instead of the gold-plated foamed stainless steel.

### Example 90

An enzyme electrode is prepared in the same manner as in Example 15 except that the void-containing conductive member constituted of gold-plated porous titanium oxide described in Preparation Example 10 is used instead of the gold-plated foamed stainless steel.

### Example 91

An enzyme electrode is prepared in the same manner as in Example 18 except that the void-containing conductive member constituted of gold-plated porous titanium oxide described in Preparation Example 10 is used instead of the gold-plated foamed stainless steel.

### Example 92

An enzyme electrode is prepared in the same manner as in Example 24 except that the void-containing conductive member constituted of gold-plated porous titanium oxide described in Preparation Example 10 is used instead of the gold-plated foamed stainless steel.

### Example 93

An enzyme electrode is prepared in the same manner as in Example 1 except that the void-containing conductive member constituted of carbon-coated needle-crystalline zinc oxide described in Preparation Example 11 is used instead of the gold-plated foamed stainless steel.

### Example 94

An enzyme electrode is prepared in the same manner as in Example 2 except that the void-containing conductive member constituted of carbon-coated needle-crystalline zinc oxide described in Preparation Example 11 is used instead of the gold-plated foamed stainless steel.

### Example 95

An enzyme electrode is prepared in the same manner as in Example 3 except that the void-containing conductive member constituted of carbon-coated needle-crystalline zinc oxide described in Preparation Example 11 is used instead of the gold-plated foamed stainless steel.

### Example 96

An enzyme electrode is prepared in the same manner as in Example 4 except that the void-containing conductive member constituted of carbon-coated needle-crystalline zinc oxide described in Preparation Example 11 is used instead of the gold-plated foamed stainless steel.

### Example 97

An enzyme electrode is prepared in the same manner as in Example 5 except that the void-containing conductive member constituted of carbon-coated needle-crystalline zinc oxide described in Preparation Example 11 is used instead of the gold-plated foamed stainless steel.

### Example 98

An enzyme electrode is prepared in the same manner as in Example 6 except that the void-containing conductive member constituted of carbon-coated needle-crystalline zinc oxide described in Preparation Example 11 is used instead of the gold-plated foamed stainless steel.

### Example 99

An enzyme electrode is prepared in the same manner as in Example 7 except that the void-containing conductive member constituted of carbon-coated needle-crystalline zinc oxide described in Preparation Example 11 is used instead of the gold-plated foamed stainless steel.

### Example 100

An enzyme electrode is prepared in the same manner as in Example 8 except that the void-containing conductive member constituted of carbon-coated needle-crystalline zinc oxide described in Preparation Example 11 is used instead of the gold-plated foamed stainless steel.

### Example 101

An enzyme electrode is prepared in the same manner as in Example 9 except that the void-containing conductive member constituted of carbon-coated needle-crystalline zinc oxide described in Preparation Example 11 is used instead of the gold-plated foamed stainless steel.

### Example 102

An enzyme electrode is prepared in the same manner as in Example 10 except that the void-containing conductive member constituted of carbon-coated needle-crystalline zinc oxide described in Preparation Example 11 is used instead of the gold-plated foamed stainless steel.

### Example 103

An enzyme electrode is prepared in the same manner as in Example 11 except that the void-containing conductive member constituted of carbon-coated needle-crystalline zinc oxide described in Preparation Example 11 is used instead of the gold-plated foamed stainless steel.

### Example 104

An enzyme electrode is prepared in the same manner as in Example 12 except that the void-containing conductive member constituted of carbon-coated needle-crystalline zinc oxide described in Preparation Example 11 is used instead of the gold-plated foamed stainless steel.

### Example 105

An enzyme electrode is prepared in the same manner as in Example 13 except that the void-containing conductive member constituted of carbon-coated needle-crystalline zinc oxide described in Preparation Example 11 is used instead of the gold-plated foamed stainless steel.

### Example 106

An enzyme electrode is prepared in the same manner as in Example 14 except that the void-containing conductive member constituted of carbon-coated needle-crystalline zinc oxide described in Preparation Example 11 is used instead of the gold-plated foamed stainless steel.

### Example 107

An enzyme electrode is prepared in the same manner as in Example 15 except that the void-containing conductive member constituted of carbon-coated needle-crystalline zinc oxide described in Preparation Example 11 is used instead of the gold-plated foamed stainless steel.

### Example 108

An enzyme electrode is prepared in the same manner as in Example 16 except that the void-containing conductive member constituted of carbon-coated needle-crystalline zinc oxide described in Preparation Example 11 is used instead of the gold-plated foamed stainless steel.

### Example 109

An enzyme electrode is prepared in the same manner as in Example 17 except that the void-containing conductive member constituted of carbon-coated needle-crystalline zinc oxide described in Preparation Example 11 is used instead of the gold-plated foamed stainless steel.

### Example 110

An enzyme electrode is prepared in the same manner as in Example 18 except that the void-containing conductive member constituted of carbon-coated needle-crystalline zinc oxide described in Preparation Example 11 is used instead of the gold-plated foamed stainless steel.

### Example 111

An enzyme electrode is prepared in the same manner as in Example 19 except that the void-containing conductive member constituted of carbon-coated needle-crystalline zinc oxide described in Preparation Example 11 is used instead of the gold-plated foamed stainless steel.

### Example 112

An enzyme electrode is prepared in the same manner as in Example 20 except that the void-containing conductive member constituted of carbon-coated needle-crystalline zinc oxide described in Preparation Example 11 is used instead of the gold-plated foamed stainless steel.

### Example 113

An enzyme electrode is prepared in the same manner as in Example 4 except that the void-containing conductive member constituted of alumina having nanoholes described in Preparation Example 12 is used instead of the gold-plated foamed stainless steel.

### Example 114

An enzyme electrode is prepared in the same manner as in Example 8 except that the void-containing conductive member constituted of alumina having nanoholes described in Preparation Example 12 is used instead of the gold-plated foamed stainless steel.

### Example 115

An enzyme electrode is prepared in the same manner as in Example 15 except that the void-containing conductive member constituted of alumina having nanoholes described in Preparation Example 12 is used instead of the gold-plated foamed stainless steel.

### Example 116

An enzyme electrode is prepared in the same manner as in Example 18 except that the void-containing conductive member constituted of alumina having nanoholes described in Preparation Example 12 is used instead of the gold-plated foamed stainless steel.

### Example 117

An enzyme electrode is prepared in the same manner as in Example 24 except that the void-containing conductive member constituted of alumina having nanoholes described in Preparation Example 12 is used instead of the gold-plated foamed stainless steel.

### Example 118

An enzyme electrode is prepared in the same manner as in Example 4 except that the void-containing conductive member constituted of graphite particles having numerous voids described in Preparation Example 13 is used instead of the gold-plated foamed stainless steel.

### Example 119

An enzyme electrode is prepared in the same manner as in Example 8 except that the void-containing conductive member constituted of graphite particles having numerous voids described in Preparation Example 13 is used instead of the gold-plated foamed stainless steel.

### Example 120

An enzyme electrode is prepared in the same manner as in Example 15 except that the void-containing conductive member constituted of graphite particles having numerous voids described in Preparation Example 13 is used instead of the gold-plated foamed stainless steel.

### Example 121

An enzyme electrode is prepared in the same manner as in Example 18 except that the void-containing conductive member constituted of graphite particles having numerous voids described in Preparation Example 13 is used instead of the gold-plated foamed stainless steel.

### Example 122

An enzyme electrode is prepared in the same manner as in Example 4 except that the void-containing conductive member constituted of carbon black particles having numerous voids described in Preparation Example 14 is used instead of the gold-plated foamed stainless steel.

### Example 123

An enzyme electrode is prepared in the same manner as in Example 8 except that the void-containing conductive member constituted of carbon black particles having numerous voids described in Preparation Example 14 is used instead of the gold-plated foamed stainless steel.

### Example 124

An enzyme electrode is prepared in the same manner as in Example 15 except that the void-containing conductive member constituted of carbon black particles having numerous voids described in Preparation Example 14 is used instead of the gold-plated foamed stainless steel.

### Example 125

An enzyme electrode is prepared in the same manner as in Example 18 except that the void-containing conductive member constituted of carbon black particles having numerous voids described in Preparation Example 14 is used instead of the gold-plated foamed stainless steel.

### Example 126

An enzyme electrode is prepared in the same manner as in Example 1 except that the void-containing conductive member constituted of carbon nanotubes described in Preparation Example 15 is used instead of the gold-plated foamed stainless steel.

### Example 127

An enzyme electrode is prepared in the same manner as in Example 2 except that the void-containing conductive member constituted of carbon nanotubes described in Preparation Example 15 is used instead of the gold-plated foamed stainless steel.

### Example 128

An enzyme electrode is prepared in the same manner as in Example 3 except that the void-containing conductive member constituted of carbon nanotubes described in Preparation Example 15 is used instead of the gold-plated foamed stainless steel.

### Example 129

An enzyme electrode is prepared in the same manner as in Example 4 except that the void-containing conductive member constituted of carbon nanotubes described in Preparation Example 15 is used instead of the gold-plated foamed stainless steel.

### Example 130

An enzyme electrode is prepared in the same manner as in Example 5 except that the void-containing conductive member constituted of carbon nanotubes described in Preparation Example 15 is used instead of the gold-plated foamed stainless steel.

### Example 131

An enzyme electrode is prepared in the same manner as in Example 6 except that the void-containing conductive member constituted of carbon nanotubes described in Preparation Example 15 is used instead of the gold-plated foamed stainless steel.

### Example 132

An enzyme electrode is prepared in the same manner as in Example 7 except that the void-containing conductive member constituted of carbon nanotubes described in Preparation Example 15 is used instead of the gold-plated foamed stainless steel.

### Example 133

An enzyme electrode is prepared in the same manner as in Example 8 except that the void-containing conductive member constituted of carbon nanotubes described in Preparation Example 15 is used instead of the gold-plated foamed stainless steel.

### Example 134

An enzyme electrode is prepared in the same manner as in Example 9 except that the void-containing conductive member constituted of carbon nanotubes described in Preparation Example 15 is used instead of the gold-plated foamed stainless steel.

### Example 135

An enzyme electrode is prepared in the same manner as in Example 10 except that the void-containing conductive member constituted of carbon nanotubes described in Preparation Example 15 is used instead of the gold-plated foamed stainless steel.

### Example 136

An enzyme electrode is prepared in the same manner as in Example 11 except that the void-containing conductive member constituted of carbon nanotubes described in Preparation Example 15 is used instead of the gold-plated foamed stainless steel.

### Example 137

An enzyme electrode is prepared in the same manner as in Example 12 except that the void-containing conductive member constituted of carbon nanotubes described in Preparation Example 15 is used instead of the gold-plated foamed stainless steel.

### Example 138

An enzyme electrode is prepared in the same manner as in Example 13 except that the void-containing conductive member constituted of carbon nanotubes described in Preparation Example 15 is used instead of the gold-plated foamed stainless steel.

### Example 139

An enzyme electrode is prepared in the same manner as in Example 14 except that the void-containing conductive member constituted of carbon nanotubes described in Preparation Example 15 is used instead of the gold-plated foamed stainless steel.

### Example 140

An enzyme electrode is prepared in the same manner as in Example 15 except that the void-containing conductive member constituted of carbon nanotubes described in Preparation Example 15 is used instead of the gold-plated foamed stainless steel.

### Example 141

An enzyme electrode is prepared in the same manner as in Example 16 except that the void-containing conductive member constituted of carbon nanotubes described in Preparation Example 15 is used instead of the gold-plated foamed stainless steel.

### Example 142

An enzyme electrode is prepared in the same manner as in Example 17 except that the void-containing conductive member constituted of carbon nanotubes described in Preparation Example 15 is used instead of the gold-plated foamed stainless steel.

### Example 143

An enzyme electrode is prepared in the same manner as in Example 18 except that the void-containing conductive member constituted of carbon nanotubes described in Preparation Example 15 is used instead of the gold-plated foamed stainless steel.

### Example 144

An enzyme electrode is prepared in the same manner as in Example 19 except that the void-containing conductive member constituted of carbon nanotubes described in Preparation Example 15 is used instead of the gold-plated foamed stainless steel.

### Example 145

An enzyme electrode is prepared in the same manner as in Example 20 except that the void-containing conductive member constituted of carbon nanotubes described in Preparation Example 15 is used instead of the gold-plated foamed stainless steel.

### Example 146

An enzyme electrode is prepared in the same manner as in Example 4 except that the void-containing conductive member constituted of nickel having numerous voids described in Preparation Example 26 is used instead of the gold-plated foamed stainless steel.

### Example 147

An enzyme electrode is prepared in the same manner as in Example 8 except that the void-containing conductive member constituted of nickel having numerous voids described in Preparation Example 26 is used instead of the gold-plated foamed stainless steel.

### Example 148

An enzyme electrode is prepared in the same manner as in Example 15 except that the void-containing conductive member constituted of nickel having numerous voids described in Preparation Example 26 is used instead of the gold-plated foamed stainless steel.

### Example 149

An enzyme electrode is prepared in the same manner as in Example 18 except that the void-containing conductive member constituted of nickel having numerous voids described in Preparation Example 26 is used instead of the gold-plated foamed stainless steel.

### Example 150

An enzyme electrode is prepared in the same manner as in Example 4 except that the void size-gradient conductive member constituted of nickel having numerous voids described in Preparation Example 27 is used instead of the gold-plated foamed stainless steel.

### Example 151

An enzyme electrode is prepared in the same manner as in Example 8 except that the void size-gradient conductive member constituted of nickel having numerous voids described in Preparation Example 27 is used instead of the gold-plated foamed stainless steel.

### Example 152

An enzyme electrode is prepared in the same manner as in Example 15 except that the void size-gradient conductive member constituted of nickel having numerous voids described in Preparation Example 27 is used instead of the gold-plated foamed stainless steel.

### Example 153

An enzyme electrode is prepared in the same manner as in Example 18 except that the void size-gradient conductive member constituted of nickel having numerous voids described in Preparation Example 27 is used instead of the gold-plated foamed stainless steel.

### Example 154

An enzyme electrode is prepared in the same manner as in Example 4 except that the void size-gradient conductive member constituted of nickel having numerous voids described in Preparation Example 28 is used instead of the gold-plated foamed stainless steel.

### Example 155

An enzyme electrode is prepared in the same manner as in Example 8 except that the void size-gradient conductive member constituted of nickel having numerous voids described in Preparation Example 28 is used instead of the gold-plated foamed stainless steel.

### Example 156

An enzyme electrode is prepared in the same manner as in Example 15 except that the void size-gradient conductive member constituted of nickel having numerous voids described in Preparation Example 28 is used instead of the gold-plated foamed stainless steel.

### Example 157

An enzyme electrode is prepared in the same manner as in Example 18 except that the void size-gradient conductive member constituted of nickel having numerous voids described in Preparation Example 28 is used instead of the gold-plated foamed stainless steel.

### Example 158

An enzyme electrode is prepared in the same manner as in Example 4 except that the conductive member constituted of void-containing poly(3,4-ethylenedioxythiophene) described in Preparation Example 6 is used instead of the gold-plated foamed stainless steel.

### Example 159

An enzyme electrode is prepared in the same manner as in Example 8 except that the conductive member constituted of void-containing poly(3,4-ethylenedioxythiophene) described in Preparation Example 6 is used instead of the gold-plated foamed stainless steel.

### Example 160

An enzyme electrode is prepared in the same manner as in Example 15 except that the conductive member constituted of void-containing poly(3,4-ethylenedioxythiophene) described in Preparation Example 6 is used instead of the gold-plated foamed stainless steel.

### Example 161

An enzyme electrode is prepared in the same manner as in Example 18 except that the conductive member constituted of void-containing poly(3,4-ethylenedioxythiophene) described in Preparation Example 6 is used instead of the gold-plated foamed stainless steel.

### Example 162

An enzyme electrode is prepared in the same manner as in Example 4 except that the void size-gradient conductive member constituted of poly(3,4-ethylenedioxythiophene) having numerous voids described in Preparation Example 29 is used instead of the gold-plated foamed stainless steel.

### Example 163

An enzyme electrode is prepared in the same manner as in Example 8 except that the void size-gradient conductive member constituted of poly(3,4-ethylenedioxythiophene) having numerous voids described in Preparation Example 29 is used instead of the gold-plated foamed stainless steel.

### Example 164

An enzyme electrode is prepared in the same manner as in Example 15 except that the void size-gradient conductive member constituted of poly(3,4-ethylenedioxythiophene) having numerous voids described in Preparation Example 29 is used instead of the gold-plated foamed stainless steel.

### Example 165

An enzyme electrode is prepared in the same manner as in Example 18 except that the void size-gradient conductive member constituted of poly(3,4-ethylenedioxythiophene) having numerous voids described in Preparation Example 29 is used instead of the gold-plated foamed stainless steel.

### Example 166

An enzyme electrode is prepared in the same manner as in Example 4 except that the conductive member constituted of gold-plated porous titanium oxide having numerous voids described in Preparation Example 30 is used instead of the gold-plated foamed stainless steel.

### Example 167

An enzyme electrode is prepared in the same manner as in Example 8 except that the conductive member constituted of gold-plated porous titanium oxide having numerous voids described in Preparation Example 30 is used instead of the gold-plated foamed stainless steel.

### Example 168

An enzyme electrode is prepared in the same manner as in Example 15 except that the conductive member constituted of gold-plated porous titanium oxide having numerous voids described in Preparation Example 30 is used instead of the gold-plated foamed stainless steel.

### Example 169

An enzyme electrode is prepared in the same manner as in Example 18 except that the conductive member constituted of gold-plated porous titanium oxide having numerous voids described in Preparation Example 30 is used instead of the gold-plated foamed stainless steel.

### Example 170

An enzyme electrode is prepared in the same manner as in Example 24 except that the conductive member constituted of gold-plated porous titanium oxide having numerous voids described in Preparation Example 30 is used instead of the gold-plated foamed stainless steel.

### Example 171

An enzyme electrode is prepared in the same manner as in Example 4 except that the void size-gradient conductive member constituted of gold-plated porous titanium oxide having numerous voids described in Preparation Example 31 is used instead of the gold-plated foamed stainless steel.

### Example 172

An enzyme electrode is prepared in the same manner as in Example 8 except that the void size-gradient conductive member constituted of gold-plated porous titanium oxide having numerous voids described in Preparation Example 31 is used instead of the gold-plated foamed stainless steel.

### Example 173

An enzyme electrode is prepared in the same manner as in Example 15 except that the void size-gradient conductive member constituted of gold-plated porous titanium oxide having numerous voids described in Preparation Example 31 is used instead of the gold-plated foamed stainless steel.

### Example 174

An enzyme electrode is prepared in the same manner as in Example 18 except that the void size-gradient conductive member constituted of gold-plated porous titanium oxide having numerous voids described in Preparation Example 31 is used instead of the gold-plated foamed stainless steel.

### Example 175

An enzyme electrode is prepared in the same manner as in Example 24 except that the void size-gradient conductive member constituted of gold-plated porous titanium oxide having numerous voids described in Preparation Example 31 is used instead of the gold-plated foamed stainless steel.

### Example 176

An enzyme electrode is prepared in the same manner as in Example 4 except that the conductive member constituted of nickel alloy having numerous voids described in Preparation Example 32 is used instead of the gold-plated foamed stainless steel.

### Example 177

An enzyme electrode is prepared in the same manner as in Example 8 except that the conductive member constituted of nickel alloy having numerous voids described in Preparation Example 32 is used instead of the gold-plated foamed stainless steel.

### Example 178

An enzyme electrode is prepared in the same manner as in Example 15 except that the conductive member constituted of nickel alloy having numerous voids described in Preparation Example 32 is used instead of the gold-plated foamed stainless steel.

### Example 179

An enzyme electrode is prepared in the same manner as in Example 18 except that the conductive member constituted of nickel alloy having numerous voids described in Preparation Example 32 is used instead of the gold-plated foamed stainless steel.

### Example 180

An enzyme electrode is prepared in the same manner as in Example 4 except that the void size-gradient conductive member constituted of nickel alloy having numerous voids described in Preparation Example 33 is used instead of the gold-plated foamed stainless steel.

### Example 181

An enzyme electrode is prepared in the same manner as in Example 8 except that the void size-gradient conductive member constituted of nickel alloy having numerous voids described in Preparation Example 33 is used instead of the gold-plated foamed stainless steel.

### Example 182

An enzyme electrode is prepared in the same manner as in Example 15 except that the void size-gradient conductive member constituted of nickel alloy having numerous voids described in Preparation Example 33 is used instead of the gold-plated foamed stainless steel.

### Example 183

An enzyme electrode is prepared in the same manner as in Example 18 except that the void size-gradient conductive member constituted of nickel alloy having numerous voids described in Preparation Example 33 is used instead of the gold-plated foamed stainless steel.

### Example 184

An enzyme electrode is prepared in the same manner as in Example 4 except that the void size-gradient conductive member constituted of nickel alloy having numerous voids described in Preparation Example 34 is used instead of the gold-plated foamed stainless steel.

### Example 185

An enzyme electrode is prepared in the same manner as in Example 8 except that the void size-gradient conductive member constituted of nickel alloy having numerous voids described in Preparation Example 34 is used instead of the gold-plated foamed stainless steel.

### Example 186

An enzyme electrode is prepared in the same manner as in Example 15 except that the void size-gradient conductive member constituted of nickel alloy having numerous voids described in Preparation Example 34 is used instead of the gold-plated foamed stainless steel.

### Example 187

An enzyme electrode is prepared in the same manner as in Example 18 except that the void size-gradient conductive member constituted of nickel alloy having numerous voids described in Preparation Example 34 is used instead of the gold-plated foamed stainless steel.

### Example 188

An enzyme electrode is prepared in the same manner as in Example 4 except that the conductive member constituted of carbon fiber and having numerous voids described in Preparation Example 35 is used instead of the gold-plated foamed stainless steel.

### Example 189

An enzyme electrode is prepared in the same manner as in Example 8 except that the conductive member constituted of carbon fiber and having numerous voids described in Preparation Example 35 is used instead of the gold-plated foamed stainless steel.

### Example 190

An enzyme electrode is prepared in the same manner as in Example 15 except that the conductive member constituted of carbon fiber and having numerous voids described in Preparation Example 35 is used instead of the gold-plated foamed stainless steel.

### Example 191

An enzyme electrode is prepared in the same manner as in Example 18 except that the conductive member constituted of carbon fiber and having numerous voids described in Preparation Example 35 is used instead of the gold-plated foamed stainless steel.

### Example 192

An enzyme electrode is prepared in the same manner as in Example 4 except that the void size-gradient conductive member constituted of carbon fiber and having numerous voids described in Preparation Example 36 is used instead of the gold-plated foamed stainless steel.

### Example 193

An enzyme electrode is prepared in the same manner as in Example 8 except that the void size-gradient conductive member constituted of carbon fiber and having numerous voids described in Preparation Example 36 is used instead of the gold-plated foamed stainless steel.

### Example 194

An enzyme electrode is prepared in the same manner as in Example 15 except that the void size-gradient conductive member constituted of carbon fiber and having numerous voids described in Preparation Example 36 is used instead of the gold-plated foamed stainless steel.

### Example 195

An enzyme electrode is prepared in the same manner as in Example 18 except that the void size-gradient conductive member constituted of carbon fiber and having numerous voids described in Preparation Example 36 is used instead of the gold-plated foamed stainless steel.

### Comparative Examples 1 to 26

Enzyme electrodes are prepared respectively in the same manner as in Examples 1 to 26 except that a gold sheet (1 cm square, 0.3 mm thick, Nilaco) is used as the conductive member instead of the gold-plated foamed stainless steel.

### Example 196

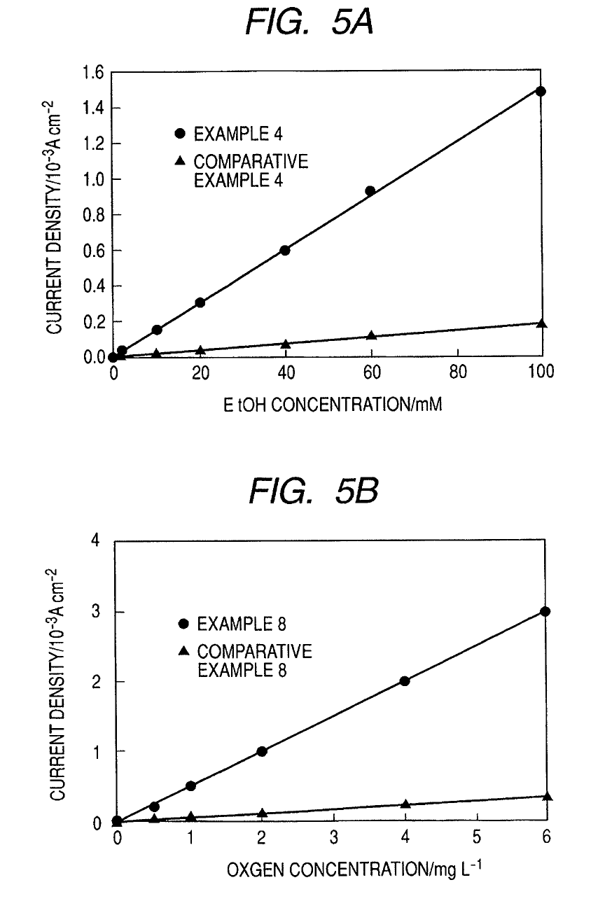

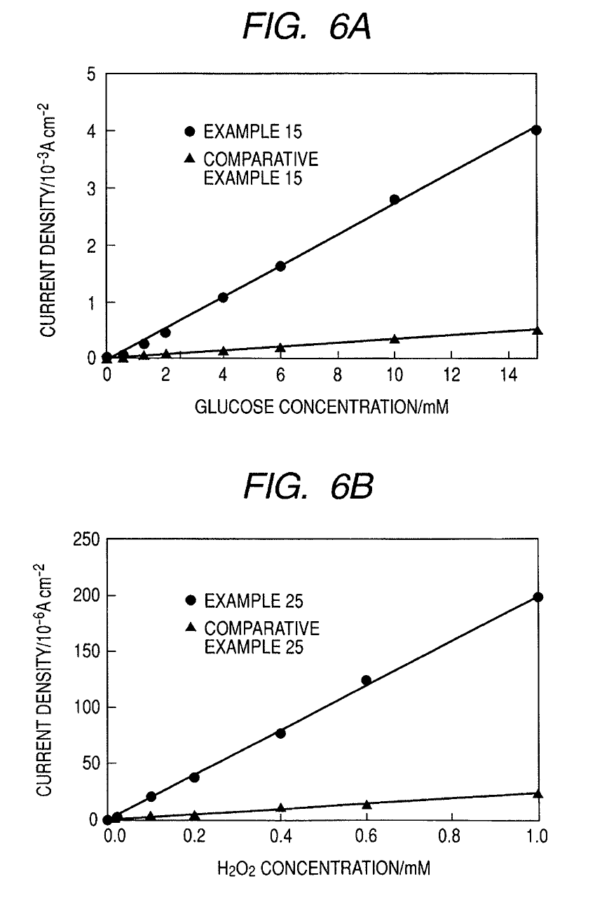

Sensors are prepared with the enzyme electrodes described in Examples 1 to 195 and Comparative Examples 1 to 26. FIG. 4 shows schematically the three-electrode cell for the measurement. In the cell, the enzyme electrode is employed as the working electrode, an Ag/AgCl electrode is employed as the reference electrode, and a platinum wire is employed as the counter electrode. Into the water-jacketed cell having a cover, air is introduced through a gas tube and a gas inlet. The measurement temperature is kept at 37° C. by a constant-temperature water cycling. In the measurement, with the electrodes connected to a potentiostat (Toho Giken K.K., Model 2000), the steady-state current is recorded for the applied potential shown in Table 1. In the electrolytic solution, the electrolyte shown in Table 1 is used corresponding to the substrate for the enzyme of the respective enzyme electrode for the measurement. For measurement with the sensors designated as S12, S13, S21, S25, S67, S68, S104, S105, S137, S138, S157, S158, S166, and S170 in Table 2, a platinum wire modified by polydimethylsiloxane is used respectively as the counter electrode. For measurement with the sensors designated as S1 to 30, S35 to 38, S118 to 145, and S176 to 195 in Table 2, the enzyme electrodes are prepared as a monolayer electrode as well as a five-layered electrode. All of the sensors employing the enzyme electrode show linear increase of the electric current density with increase of the substrate concentration as exemplified in FIGS. 5A, 5B, 6A and 6B, functioning obviously as a sensor. Table 2 shows the electric current densities measured by the sensors.

TABLE 1

| | | | | Applied |
|---|---|---|---|---|
| | | | Substrate | voltage V |
| | Electrolyte | | concn | vs |
| Enzyme | solution | Substrate | mM | Ag/AgCl |
| Glucose | 1M NaCl | Glucose | 15 | 0.5 |
| oxidase | 20 mM | | | |
| | phosphate | | | |
| | buffer soln | | | |
| | pH 7.2 | | | |
| Pyruvate | 15M NaCl | Oxygen | Saturated | 0.2 |
| oxidase | 20 mM | | | |
| | phosphate | | | |
| | buffer soln | | | |
| | pH 7.4 | | | |
| Laccase | 2M citrate | Oxygen | Saturated | 0.2 |
| | buffer soln | | | |
| | pH 5.0 | | | |
| Glucose | 33 mM | Glucose | 15 | 0.5 |
| dehydrogenase/ | phosphate | | | |
| Diaphorase | buffer soln | | | |
| | pH 7.0 | | | |
| MP-11 | 1M phosphate | Hydrogen | 1 | 0 |
| | buffer soln | peroxide | | |
| | pH 7.0 | | | |
| Alcohol | 50 mM KCl | Ethanol | 100 | 0.5 |
| dehydrogenase | 50 mM Na | | | |
| | acetate | | | |
| | buffer soln | | | |
| | pH 6.0 | | | |
| Cytochrome | 0.1M | Oxygen | Saturated | 0.2 |
| oxidase | tris(hydroxymethyl)- | | | |
| | aminomethane | | | |
| | buffer soln | | | |
| | pH 7.0 | | | |

TABLE 2

| | | | Current | | | |
|---|---|---|---|---|---|---|
| | | | density | | Current density | |
| | | | (monolayer) | | (5-layer) | |
| | | | Substrate | Substrate | Substrate | Substrate |
| | Enzyme | Reference | Not added | Added | Not added | Added |
| Symbol | electrode | Sensor | μA/cm² | μA/cm² | μA/cm² | μA/cm² |
| S1 | Example 1 | S196 | 18 | 1000 | 9 | 3900 |
| S2 | Example 2 | S197 | 8 | 790 | 14 | 3100 |
| S3 | Example 3 | S198 | 16 | 1800 | 22 | 6600 |
| S4 | Example 4 | S199 | 12 | 1500 | 12 | 5500 |
| S5 | Example 5 | S200 | 9 | 580 | 11 | 2200 |
| S6 | Example 6 | S201 | 5 | 470 | 5 | 1800 |
| S7 | Example 7 | S202 | 42 | 3600 | 55 | 14000 |
| S8 | Example 8 | S203 | 13 | 2800 | 54 | 11000 |
| S9 | Example 9 | S204 | 4 | 1500 | 5 | 5700 |
| S10 | Example | S205 | 2 | 1100 | 17 | 4300 |
| | 10 | | | | | |
| S11 | Example | S206 | 18 | 1100 | 5 | 4100 |
| | 11 | | | | | |
| S12 | Example | S207 | 14 | 750 | 13 | 2800 |
| | 12 | | | | | |
| S13 | Example | S208 | 3 | 190 | 1 | 680 |
| | 13 | | | | | |
| S14 | Example | S209 | 9 | 590 | 4 | 2300 |
| | 14 | | | | | |
| S15 | Example | S210 | 48 | 3800 | 11 | 14000 |
| | 15 | | | | | |
| S16 | Example | S211 | 11 | 790 | 15 | 3000 |
| | 16 | | | | | |
| S17 | Example | S212 | 2 | 370 | 4 | 1500 |
| | 17 | | | | | |
| S18 | Example | S213 | 13 | 660 | 4 | 2500 |
| | 18 | | | | | |
| S19 | Example | S214 | 0 | 310 | 5 | 1100 |
| | 19 | | | | | |
| S20 | Example | S215 | 5 | 1200 | 11 | 4300 |
| | 20 | | | | | |
| S21 | Example | S216 | 1 | 720 | 13 | 2600 |
| | 21 | | | | | |
| S22 | Example | S217 | 42 | 2200 | 15 | 8500 |
| | 22 | | | | | |
| S23 | Example | S218 | 21 | 2100 | 39 | 7700 |
| | 23 | | | | | |
| S24 | Example | S219 | 6 | 310 | 4 | 1200 |
| | 24 | | | | | |
| S25 | Example | S220 | 2 | 190 | 1 | 740 |
| | 25 | | | | | |
| S26 | Example | S221 | 11 | 1400 | 12 | 5400 |
| | 26 | | | | | |
| S27 | Example | S199 | 21 | 1400 | 22 | 5400 |
| | 27 | | | | | |
| S28 | Example | S203 | 7 | 2700 | 53 | 10000 |
| | 28 | | | | | |
| S29 | Example | S210 | 30 | 3700 | 37 | 14000 |
| | 29 | | | | | |
| S30 | Example | S213 | 3 | 610 | 4 | 2400 |
| | 30 | | | | | |
| S31 | Example | S199 | 25 | 1900 | — | — |
| | 31 | | | | | |
| S32 | Example | S203 | 47 | 3500 | — | — |
| | 32 | | | | | |
| S33 | Example | S210 | 94 | 4900 | — | — |
| | 33 | | | | | |
| S34 | Example | S213 | 3 | 840 | — | |
| | 34 | | | | | |
| S35 | Example | S199 | 1 | 390 | 0.3 | 1400 |
| | 35 | | | | | |
| S36 | Example | S203 | 8 | 680 | 1 | 2600 |
| | 36 | | | | | |
| S37 | Example | S210 | 9 | 990 | 9 | 3900 |
| | 37 | | | | | |
| S38 | Example | S213 | 2 | 180 | 2 | 680 |
| | 38 | | | | | |
| S39 | Example | S199 | 10 | 290 | — | — |
| | 39 | | | | | |
| S40 | Example | S203 | 25 | 540 | — | — |
| | 40 | | | | | |
| S41 | Example | S210 | 38 | 680 | — | — |
| | 41 | | | | | |
| S42 | Example | S213 | 8 | 130 | — | — |
| | 42 | | | | | |
| S43 | Example | S199 | 4 | 380 | — | — |
| | 43 | | | | | |
| S44 | Example | S203 | 10 | 690 | — | — |
| | 44 | | | | | |
| S45 | Example | S210 | 12 | 950 | — | — |
| | 45 | | | | | |
| S46 | Example | S213 | 2 | 180 | — | — |
| | 46 | | | | | |
| S47 | Example | S219 | 1 | 77 | — | — |
| | 47 | | | | | |
| S48 | Example | S199 | 8 | 230 | — | — |
| | 48 | | | | | |
| S49 | Example | S203 | 12 | 420 | — | — |
| | 49 | | | | | |
| S50 | Example | S210 | 20 | 560 | — | — |
| | 50 | | | | | |
| S51 | Example | S213 | 2 | 98 | — | — |
| | 51 | | | | | |
| S52 | Example | S199 | 1 | 370 | — | — |
| | 52 | | | | | |
| S53 | Example | S203 | 12 | 720 | — | — |
| | 53 | | | | | |
| S54 | Example | S210 | 18 | 940 | — | — |
| | 54 | | | | | |
| S55 | Example | S213 | 0 | 170 | — | — |
| | 55 | | | | | |
| S56 | Example | S196 | 3 | 580 | — | — |
| | 56 | | | | | |
| S57 | Example | S197 | 9 | 490 | — | — |
| | 57 | | | | | |
| S58 | Example | S198 | 1 | 1000 | — | — |
| | 58 | | | | | |
| S59 | Example | S199 | 0 | 930 | — | — |
| | 59 | | | | | |
| S60 | Example | S200 | 2 | 370 | — | — |
| | 60 | | | | | |
| S61 | Example | S201 | 1 | 280 | — | — |
| | 61 | | | | | |
| S62 | Example | S202 | 24 | 2400 | — | — |
| | 62 | | | | | |
| S63 | Example | S203 | 35 | 1800 | — | — |
| | 63 | | | | | |
| S64 | Example | S204 | 4 | 930 | — | — |
| | 64 | | | | | |
| S65 | Example | S205 | 6 | 680 | — | — |
| | 65 | | | | | |
| S66 | Example | S206 | 14 | 730 | — | — |
| | 66 | | | | | |
| S67 | Example | S207 | 0 | 500 | — | — |
| | 67 | | | | | |
| S68 | Example | S208 | 0 | 110 | — | — |
| | 68 | | | | | |
| S69 | Example | S209 | 5 | 350 | — | — |
| | 69 | | | | | |
| S70 | Example | S210 | 21 | 2400 | — | — |
| | 70 | | | | | |
| S71 | Example | S211 | 9 | 480 | — | — |
| | 71 | | | | | |
| S72 | Example | S212 | 0 | 230 | — | — |
| | 72 | | | | | |
| S73 | Example | S213 | 8 | 420 | — | — |
| | 73 | | | | | |
| S74 | Example | S214 | 1 | 190 | — | — |
| | 74 | | | | | |
| S75 | Example | S215 | 7 | 680 | — | — |
| | 75 | | | | | |
| S76 | Example | S199 | 2 | 200 | — | — |
| | 76 | | | | | |
| S77 | Example | S203 | 6 | 390 | — | — |
| | 77 | | | | | |
| S78 | Example | S210 | 7 | 510 | — | — |
| | 78 | | | | | |
| S79 | Example | S213 | 2 | 95 | — | — |
| | 79 | | | | | |
| S80 | Example | S199 | 0 | 260 | — | — |
| | 80 | | | | | |
| S81 | Example | S203 | 0 | 450 | — | — |
| | 81 | | | | | |
| S82 | Example | S210 | 8 | 630 | — | — |
| | 82 | | | | | |
| S83 | Example | S213 | 1 | 120 | — | — |
| | 83 | | | | | |
| S84 | Example | S199 | 8 | 560 | — | — |
| | 84 | | | | | |
| S85 | Example | S203 | 19 | 1100 | — | — |
| | 85 | | | | | |
| S86 | Example | S210 | 22 | 1400 | — | — |
| | 86 | | | | | |
| S87 | Example | S213 | 3 | 250 | — | — |
| | 87 | | | | | |
| S88 | Example | S199 | 0 | 280 | — | — |
| | 88 | | | | | |
| S89 | Example | S203 | 0 | 520 | — | — |
| | 89 | | | | | |
| S90 | Example | S210 | 11 | 720 | — | — |
| | 90 | | | | | |
| S91 | Example | S213 | 0 | 130 | — | — |
| | 91 | | | | | |
| S92 | Example | S219 | 1 | 57 | — | — |
| | 92 | | | | | |
| S93 | Example | S196 | 4 | 430 | — | — |
| | 93 | | | | | |
| S94 | Example | S197 | 6 | 320 | — | — |
| | 94 | | | | | |
| S95 | Example | S198 | 0 | 720 | — | — |
| | 95 | | | | | |
| S96 | Example | S199 | 10 | 670 | — | — |
| | 96 | | | | | |
| S97 | Example | S200 | 5 | 260 | — | — |
| | 97 | | | | | |
| S98 | Example | S201 | 1 | 190 | — | — |
| | 98 | | | | | |
| S99 | Example | S202 | 11 | 1700 | — | — |
| | 99 | | | | | |
| S100 | Example | S203 | 20 | 1200 | — | — |
| | 100 | | | | | |
| S101 | Example | S204 | 1 | 640 | — | — |
| | 101 | | | | | |
| S102 | Example | S205 | 10 | 510 | — | — |
| | 102 | | | | | |
| S103 | Example | S206 | 10 | 490 | — | — |
| | 103 | | | | | |
| S104 | Example | S207 | 4 | 330 | — | — |
| | 104 | | | | | |
| S105 | Example | S208 | 1 | 79 | — | — |
| | 105 | | | | | |
| S106 | Example | S209 | 2 | 250 | — | — |
| | 106 | | | | | |
| S107 | Example | S210 | 11 | 1600 | — | — |
| | 107 | | | | | |
| S108 | Example | S211 | 6 | 350 | — | — |
| | 108 | | | | | |
| S109 | Example | S212 | 1 | 170 | — | — |
| | 109 | | | | | |
| S110 | Example | S213 | 2 | 310 | — | — |
| | 110 | | | | | |
| S111 | Example | S214 | 2 | 130 | — | — |
| | 111 | | | | | |
| S112 | Example | S215 | 1 | 490 | — | — |
| | 112 | | | | | |
| S113 | Example | S199 | 1 | 330 | — | — |
| | 113 | | | | | |
| S114 | Example | S203 | 10 | 660 | — | — |
| | 114 | | | | | |
| S115 | Example | S210 | 5 | 890 | — | — |
| | 115 | | | | | |
| S116 | Example | S213 | 1 | 160 | — | — |
| | 116 | | | | | |
| S117 | Example | S219 | 1 | 66 | — | — |
| | 117 | | | | | |
| S118 | Example | S199 | 3 | 220 | 2 | 880 |
| | 118 | | | | | |
| S119 | Example | S203 | 0 | 440 | 5 | 1600 |
| | 119 | | | | | |
| S120 | Example | S210 | 1 | 570 | 5 | 2200 |
| | 120 | | | | | |
| S121 | Example | S213 | 1 | 110 | 1 | 380 |
| | 121 | | | | | |
| S122 | Example | S199 | 1 | 260 | 2 | 950 |
| | 122 | | | | | |
| S123 | Example | S203 | 4 | 520 | 6 | 2100 |
| | 123 | | | | | |
| S124 | Example | S210 | 12 | 660 | 4 | 2500 |
| | 124 | | | | | |
| S125 | Example | S213 | 0 | 120 | 1 | 450 |
| | 125 | | | | | |
| S126 | Example | S196 | 4 | 310 | 4 | 1200 |
| | 126 | | | | | |
| S127 | Example | S197 | 2 | 240 | 3 | 890 |
| | 127 | | | | | |
| S128 | Example | S198 | 10 | 520 | 9 | 2000 |
| | 128 | | | | | |
| S129 | Example | S199 | 1 | 460 | 0.3 | 1800 |
| | 129 | | | | | |
| S130 | Example | S200 | 1 | 170 | 2 | 640 |
| | 130 | | | | | |
| S131 | Example | S201 | 2 | 140 | 1 | 510 |
| | 131 | | | | | |
| S132 | Example | S202 | 15 | 1200 | 16 | 4500 |
| | 132 | | | | | |
| S133 | Example | S203 | 5 | 870 | 2 | 3200 |
| | 133 | | | | | |
| S134 | Example | S204 | 2 | 490 | 9 | 1900 |
| | 132 | | | | | |
| S135 | Example | S205 | 3 | 340 | 3 | 1300 |
| | 135 | | | | | |
| S136 | Example | S206 | 1 | 370 | 5 | 1300 |
| | 136 | | | | | |
| S137 | Example | S207 | 3 | 230 | 4 | 820 |
| | 137 | | | | | |
| S138 | Example | S208 | 0 | 60 | 1 | 240 |
| | 138 | | | | | |
| S139 | Example | S209 | 3 | 180 | 2 | 700 |
| | 139 | | | | | |
| S140 | Example | S210 | 7 | 1200 | 11 | 4400 |
| | 140 | | | | | |
| S141 | Example | S211 | 0 | 240 | 5 | 960 |
| | 141 | | | | | |
| S142 | Example | S212 | 0 | 120 | 1 | 440 |
| | 142 | | | | | |
| S143 | Example | S213 | 1 | 210 | 1 | 830 |
| | 143 | | | | | |
| S144 | Example | S214 | 0 | 93 | 1 | 370 |
| | 144 | | | | | |
| S145 | Example | S215 | 4 | 360 | 6 | 1400 |
| | 145 | | | | | |
| S146 | Example | S199 | 9 | 2000 | — | — |
| | 146 | | | | | |
| S147 | Example | S203 | 38 | 4000 | — | — |
| | 147 | | | | | |
| S148 | Example | S210 | 88 | 5300 | — | — |
| | 148 | | | | | |
| S149 | Example | S213 | 2 | 910 | — | — |
| | 149 | | | | | |
| S150 | Example | S146 | 14 | 2300 | — | — |
| | 150 | | | | | |
| S151 | Example | S147 | 64 | 4200 | — | — |
| | 151 | | | | | |
| S152 | Example | S148 | 53 | 5900 | — | — |
| | 152 | | | | | |
| S153 | Example | S149 | 5 | 990 | — | — |
| | 153 | | | | | |
| S154 | Example | S146 | 14 | 2400 | — | — |
| | 154 | | | | | |
| S155 | Example | S147 | 6 | 4800 | — | — |
| | 155 | | | | | |
| S156 | Example | S148 | 42 | 6000 | — | — |
| | 156 | | | | | |
| S157 | Example | S149 | 12 | 1200 | — | — |
| | 157 | | | | | |
| S158 | Example | S199 | 10 | 990 | — | — |
| | 158 | | | | | |
| S159 | Example | S203 | 11 | 1800 | — | — |
| | 159 | | | | | |
| S160 | Example | S210 | 27 | 2300 | — | — |
| | 160 | | | | | |
| S161 | Example | S213 | 6 | 420 | — | — |
| | 161 | | | | | |
| S162 | Example | S158 | 12 | 1100 | — | — |
| | 162 | | | | | |
| S163 | Example | S159 | 25 | 2000 | — | — |
| | 163 | | | | | |
| S164 | Example | S160 | 44 | 2800 | — | — |
| | 164 | | | | | |
| S165 | Example | S161 | 5 | 530 | — | — |
| | 165 | | | | | |
| S166 | Example | S199 | 2 | 270 | — | — |
| | 166 | | | | | |
| S167 | Example | S203 | 5 | 530 | — | — |
| | 167 | | | | | |
| S168 | Example | S210 | 12 | 680 | — | — |
| | 168 | | | | | |
| S169 | Example | S213 | 2 | 120 | — | — |
| | 169 | | | | | |
| S170 | Example | S219 | 1 | 57 | — | — |
| | 170 | | | | | |
| S171 | Example | S166 | 3 | 330 | — | — |
| | 171 | | | | | |
| S172 | Example | S167 | 10 | 650 | — | — |
| | 172 | | | | | |
| S173 | Example | S168 | 16 | 850 | — | — |
| | 173 | | | | | |
| S174 | Example | S169 | 2 | 150 | — | — |
| | 174 | | | | | |
| S175 | Example | S170 | 0 | 67 | — | — |
| | 175 | | | | | |
| S176 | Example | S199 | 32 | 1700 | 6 | 6300 |
| | 176 | | | | | |
| S177 | Example | S203 | 5 | 3100 | 23 | 11000 |
| | 177 | | | | | |
| S178 | Example | S210 | 13 | 3900 | 50 | 15000 |
| | 178 | | | | | |
| S179 | Example | S213 | 3 | 740 | 5 | 2800 |
| | 179 | | | | | |
| S180 | Example | S176 | 18 | 1800 | 30 | 7100 |
| | 180 | | | | | |
| S181 | Example | S177 | 33 | 3300 | 57 | 13000 |
| | 181 | | | | | |
| S182 | Example | S178 | 57 | 4500 | 87 | 17000 |
| | 182 | | | | | |
| S183 | Example | S179 | 17 | 850 | 10 | 3400 |
| | 183 | | | | | |
| S184 | Example | S176 | 5 | 2200 | 33 | 7900 |
| | 184 | | | | | |
| S185 | Example | S177 | 35 | 4300 | 36 | 15000 |
| | 185 | | | | | |
| S186 | Example | S178 | 46 | 5200 | 46 | 19000 |
| | 186 | | | | | |
| S187 | Example | S179 | 8 | 1000 | 3 | 4100 |
| | 187 | | | | | |
| S188 | Example | S199 | 11 | 1200 | 22 | 4600 |
| | 188 | | | | | |
| S189 | Example | S203 | 12 | 2400 | 38 | 9300 |
| | 189 | | | | | |
| S190 | Example | S210 | 54 | 3000 | 23 | 12000 |
| | 190 | | | | | |
| S191 | Example | S213 | 9 | 530 | 6 | 2000 |
| | 191 | | | | | |
| S192 | Example | S188 | 22 | 1500 | 29 | 5800 |
| | 192 | | | | | |
| S193 | Example | S189 | 12 | 2800 | 41 | 11000 |
| | 193 | | | | | |
| S194 | Example | S190 | 29 | 3800 | 13 | 15000 |
| | 194 | | | | | |
| S195 | Example | S191 | 10 | 700 | 5 | 2800 |
| | 195 | | | | | |
| S196 | Comp. Ex. 1 | | 0 | 120 | | |
| S197 | Comp. Ex. 2 | | 1 | 97 | | |
| S198 | Comp. Ex. 3 | | 1 | 220 | | |
| S199 | Comp. Ex. 4 | | 1 | 180 | | |
| S200 | Comp. Ex. 5 | | 0 | 71 | | |
| S201 | Comp. Ex. 6 | | 1 | 55 | | |
| S202 | Comp. Ex. 7 | | 5 | 480 | | |
| S203 | Comp. Ex. 8 | | 1 | 360 | | |
| S204 | Comp. Ex. 9 | | 0 | 180 | | |
| S205 | Comp. Ex. | | 2 | 150 | | |
| | 10 | | | | | |
| S206 | Comp. Ex. | | 1 | 140 | | |
| | 11 | | | | | |
| S207 | Comp. Ex. | | 1 | 91 | | |
| | 12 | | | | | |
| S208 | Comp. Ex. | | 0 | 24 | | |
| | 13 | | | | | |
| S209 | Comp. Ex. | | 1 | 72 | | |
| | 14 | | | | | |
| S210 | Comp. Ex. | | 3 | 490 | | |
| | 15 | | | | | |
| S211 | Comp. Ex. | | 0 | 96 | | |
| | 16 | | | | | |
| S212 | Comp. Ex. | | 0 | 48 | | |
| | 17 | | | | | |
| S213 | Comp. Ex. | | 2 | 90 | | |
| | 18 | | | | | |
| S214 | Comp. Ex. | | 0 | 36 | | |
| | 19 | | | | | |
| S215 | Comp. Ex. | | 1 | 140 | | |
| | 20 | | | | | |
| S216 | Comp. Ex. | | 1 | 85 | | |
| | 21 | | | | | |
| S217 | Comp. Ex. | | 0 | 280 | | |
| | 22 | | | | | |
| S218 | Comp. Ex. | | 2 | 270 | | |
| | 23 | | | | | |
| S219 | Comp. Ex. | | 0 | 39 | | |
| | 24 | | | | | |
| S220 | Comp. Ex. | | 0 | 25 | | |
| | 25 | | | | | |
| S221 | Comp. Ex. | | 1 | 170 | | |
| | 26 | | | | | |

Comp. Ex.: Comparative Example

Any of the sensors employing the enzyme electrode having a void-containing conductive member in Examples 1 to 149, Examples 158 to 161, Examples 166 to 170, Examples 176 to 179, and Examples 188 to 191 gives a higher current density than that shown by the sensors employing a flat gold electrode, and a corresponding carrier, mediator, enzyme, and substrate. In particular, the sensor having five-layered electrode gives much higher current density, nearly 30-fold at the highest. This shows possibility of increasing the sensitivity of the sensor by use of the void-containing conductive member. Further, the sensors employing the enzyme electrode having a void size-gradient conductive member having numerous voids in Examples 150 to 157, Examples 162 to 165, Examples 171 to 175, Examples 180 to 187, and Examples 192 to 195 give higher current densities than that given by enzyme electrodes of comparative non-void size-gradient conductive members. This shows possibility of further increasing the sensitivity of the sensor by use of a void size-gradient conductive member having numerous voids.

### Example 197

Fuel cells are produced by use of the enzyme electrodes of Examples with combinations of enzyme electrodes as shown in Table 4, combinations of electrolytic solutions shown in Table 3, and the kinds and concentrations of the substrates for the enzymes shown in Table 1. FIG. 7 illustrates schematically the two-electrode cell as the measurement reactor. In this reactor, the anode and the cathode with interposition of a porous polypropylene film (20 μm thick) are placed in an electrolytic solution in a water-jacketed capped cell. To the electrolytic solution for the enzyme electrode utilizing oxygen as the substrate, air is fed through a gas tube and a gas inlet. The measurement temperature is kept at 37° C. by constant-temperature water cycling. In the measurement, with the electrodes connected to a potentiostat (Toho Giken K.K., Model 2000), the voltage-current characteristics are measured by changing the voltage from −1.2 V to 0.1 V. In the fuel cells employing the enzyme electrode utilizing the enzyme shown in Table 3 as one or both of the electrodes, the electrolytic solution shown in Table 3 is used. In the fuel cells employing none of the enzymes shown in Table 3 for the anode or cathode, the electrolytic solution is a 0.1M NaCl solution in a 20 mM phosphate buffer solution saturated with oxygen. For an enzyme electrode containing glucose dehydrogenase/diaphorase or for use of MP-11, an electrochemical measurement is conducted with an electrochemical measurement cell having a diaphragm (Hokuto Denko K.K.) by separating the anode chamber and the cathode chamber. In the measurements with the fuel cells denoted as FC1-25, FC29-31, FC98-121, and FC145-159, the enzyme electrode is employed as a monolayer as well as a stack of five layers. Table 4 shows the measurement results.

TABLE 3

| | | | Substrate | Applied |
|---|---|---|---|---|
| | Electrolyte | | concn | voltage V vs |
| Enzyme | solution | Substrate | mM | Ag/AgCl |
| Laccase | 0.2M citrate | Oxygen | Saturated | 0.2 |
| | buffer soln | | | |
| MP-11 | 0.1M | Hydrogen | 1 | 0 |
| | phosphate | peroxide | | |
| | buffer soln | | | |
| Alcohol | 50 mM KCl | Ethanol | 100 | 0.5 |
| dehydrogenase | 50 mM Na | | | |
| | acetate | | | |
| | buffer soln | | | |
| Cyto- | 0.1M tris | Oxygen | Saturated | 0.2 |
| chrome | (hydroxy- | | | |
| C/Cyto- | methyl)- | | | |
| crome | aminomethane | | | |
| oxidase | buffer soln | | | |

TABLE 4

| | | | | Short- | | Short- | |
|---|---|---|---|---|---|---|---|
| | | | | circuit | | circuit | |
| | | | | current | Maximum | current | Maximum |
| | | | | density | power | density | power |
| | | | | (Mono- | (Mono- | (5- | (5- |
| | | | Reference fuel | layer) | layer) | Layer) | Layer) |
| Symbol | Anode | Cathode | cell | μA/cm² | μW/cm² | μA/cm² | μW/cm² |
| FC1 | Ex 1 | Ex 8 | FC160 | 780 | 70 | 2700 | 220 |
| FC2 | Ex 2 | Ex 8 | FC161 | 590 | 32 | 2100 | 99 |
| FC3 | Ex 3 | Ex 8 | FC162 | 1300 | 200 | 4600 | 680 |
| FC4 | Ex 4 | Ex 8 | FC163 | 1300 | 140 | 4400 | 480 |
| FC5 | Ex 5 | Ex 8 | FC164 | 460 | 17 | 1600 | 53 |
| FC6 | Ex 6 | Ex 8 | FC165 | 360 | 6 | 1200 | 19 |
| FC7 | Ex 9 | Ex 8 | FC166 | 1200 | 130 | 4300 | 410 |
| FC8 | Ex | Ex 8 | FC167 | 960 | 110 | 3300 | 340 |
| | 10 | | | | | | |
| FC9 | Ex | Ex 8 | FC168 | 900 | 100 | 3200 | 340 |
| | 11 | | | | | | |
| FC10 | Ex | Ex 8 | FC169 | 610 | 190 | 2100 | 600 |
| | 12 | | | | | | |
| FC11 | Ex | Ex 8 | FC170 | 150 | 51 | 520 | 160 |
| | 13 | | | | | | |
| FC12 | Ex | Ex 8 | FC171 | 460 | 0.03 | 1600 | 0.08 |
| | 14 | | | | | | |
| FC13 | Ex | Ex 7 | FC172 | 3100 | 1400 | 11000 | 4500 |
| | 15 | | | | | | |
| FC14 | Ex | Ex | FC173 | 3000 | 660 | 10000 | 2100 |
| | 15 | 20 | | | | | |
| FC15 | Ex | Ex 8 | FC174 | 610 | 18 | 2100 | 56 |
| | 16 | | | | | | |
| FC16 | Ex | Ex 8 | FC175 | 320 | 5 | 1100 | 17 |
| | 17 | | | | | | |
| FC17 | Ex | Ex 8 | FC176 | 550 | 17 | 1900 | 54 |
| | 18 | | | | | | |
| FC18 | Ex | Ex 8 | FC177 | 230 | 4 | 810 | 12 |
| | 19 | | | | | | |
| FC19 | Ex | Ex 8 | FC178 | 570 | 56 | 2000 | 170 |
| | 21 | | | | | | |
| FC20 | Ex | Ex | FC179 | 1800 | 120 | 6400 | 370 |
| | 22 | 25 | | | | | |
| FC21 | Ex | Ex | FC180 | 1700 | 0.09 | 6000 | 0.31 |
| | 23 | 26 | | | | | |
| FC22 | Ex | Ex 8 | FC181 | 230 | 6 | 810 | 20 |
| | 24 | | | | | | |
| FC23 | Ex | Ex | FC163 | 1100 | 130 | 3800 | 410 |
| | 27 | 28 | | | | | |
| FC24 | Ex | Ex | FC172 | 2900 | 870 | 10000 | 2800 |
| | 29 | 28 | | | | | |
| FC25 | Ex | Ex | FC176 | 500 | 14 | 1800 | 43 |
| | 30 | 28 | | | | | |
| FC26 | Ex | Ex | FC163 | 1600 | 170 | — | — |
| | 31 | 32 | | | | | |
| FC27 | Ex | Ex | FC172 | 4000 | 1200 | — | — |
| | 33 | 32 | | | | | |
| FC28 | Ex | Ex | FC176 | 690 | 20 | — | — |
| | 34 | 32 | | | | | |
| FC29 | Ex | Ex | FC163 | 290 | 36 | 1000 | 120 |
| | 35 | 36 | | | | | |
| FC30 | Ex | Ex | FC172 | 790 | 240 | 2800 | 750 |
| | 37 | 36 | | | | | |
| FC31 | Ex | Ex | FC176 | 130 | 4 | 470 | 13 |
| | 38 | 36 | | | | | |
| FC32 | Ex | Ex | FC163 | 230 | 26 | — | — |
| | 39 | 40 | | | | | |
| FC33 | Ex | Ex | FC172 | 570 | 170 | — | — |
| | 41 | 40 | | | | | |
| FC34 | Ex | Ex | FC176 | 110 | 3 | — | — |
| | 42 | 40 | | | | | |
| FC35 | Ex | Ex | FC163 | 310 | 32 | — | — |
| | 43 | 44 | | | | | |
| FC36 | Ex | Ex | FC172 | 770 | 220 | — | — |
| | 45 | 44 | | | | | |
| FC37 | Ex | Ex | FC176 | 130 | 3 | — | — |
| | 46 | 44 | | | | | |
| FC38 | Ex | Ex | FC181 | 61 | 2 | — | — |
| | 47 | 44 | | | | | |
| FC39 | Ex | Ex | FC163 | 180 | 18 | — | — |
| | 48 | 47 | | | | | |
| FC40 | Ex | Ex | FC172 | 460 | 130 | — | — |
| | 50 | 47 | | | | | |
| FC41 | Ex | Ex | FC176 | 80 | 2 | — | — |
| | 51 | 47 | | | | | |
| FC42 | Ex | Ex | FC163 | 300 | 10 | — | — |
| | 52 | 53 | | | | | |
| FC43 | Ex | Ex | FC172 | 760 | 65 | — | — |
| | 54 | 53 | | | | | |
| FC44 | Ex | Ex | FC176 | 140 | 1 | — | — |
| | 55 | 53 | | | | | |
| FC45 | Ex | Ex | FC160 | 490 | 21 | — | — |
| | 56 | 63 | | | | | |
| FC46 | Ex | Ex | FC161 | 380 | 11 | — | — |
| | 57 | 63 | | | | | |
| FC47 | Ex | Ex | FC162 | 860 | 63 | — | — |
| | 58 | 63 | | | | | |
| FC48 | Ex | Ex | FC163 | 790 | 45 | — | — |
| | 59 | 63 | | | | | |
| FC49 | Ex | Ex | FC164 | 270 | 6 | — | — |
| | 60 | 63 | | | | | |
| FC50 | Ex | Ex | FC165 | 220 | 2 | — | — |
| | 61 | 63 | | | | | |
| FC51 | Ex | Ex | FC166 | 740 | 37 | — | — |
| | 64 | 63 | | | | | |
| FC52 | Ex | Ex | FC167 | 580 | 37 | — | — |
| | 65 | 63 | | | | | |
| FC53 | Ex | Ex | FC168 | 550 | 30 | — | — |
| | 66 | 63 | | | | | |
| FC54 | Ex | Ex | FC169 | 360 | 60 | — | — |
| | 67 | 63 | | | | | |
| FC55 | Ex | Ex | FC170 | 95 | 15 | — | — |
| | 68 | 63 | | | | | |
| FC56 | Ex | Ex | FC171 | 290 | 0.009 | — | — |
| | 69 | 63 | | | | | |
| FC57 | Ex | Ex | FC172 | 1800 | 410 | — | — |
| | 70 | 62 | | | | | |
| FC58 | Ex | Ex | FC173 | 1900 | 220 | — | — |
| | 70 | 75 | | | | | |
| FC59 | Ex | Ex | FC174 | 390 | 6 | — | — |
| | 71 | 63 | | | | | |
| FC60 | Ex | Ex | FC175 | 190 | 2 | — | — |
| | 72 | 63 | | | | | |
| FC61 | Ex | Ex | FC176 | 330 | 5 | — | — |
| | 73 | 63 | | | | | |
| FC62 | Ex | Ex | FC177 | 140 | 1 | — | — |
| | 74 | 63 | | | | | |
| FC63 | Ex | Ex | FC163 | 170 | 4 | — | — |
| | 76 | 77 | | | | | |
| FC64 | Ex | Ex | FC172 | 420 | 23 | — | — |
| | 78 | 77 | | | | | |
| FC65 | Ex | Ex | FC176 | 76 | 0 | — | — |
| | 79 | 77 | | | | | |
| FC66 | Ex | Ex | FC163 | 200 | 3 | — | — |
| | 80 | 81 | | | | | |
| FC67 | Ex | Ex | FC172 | 510 | 17 | — | — |
| | 82 | 81 | | | | | |
| FC68 | Ex | Ex | FC176 | 88 | 0.3 | — | — |
| | 83 | 81 | | | | | |
| FC69 | Ex | Ex | FC163 | 440 | 27 | — | — |
| | 84 | 85 | | | | | |
| FC70 | Ex | Ex | FC172 | 1100 | 190 | — | — |
| | 86 | 85 | | | | | |
| FC71 | Ex | Ex | FC176 | 210 | 4 | — | — |
| | 87 | 85 | | | | | |
| FC72 | Ex | Ex | FC163 | 220 | 10 | — | — |
| | 88 | 89 | | | | | |
| FC73 | Ex | Ex | FC172 | 570 | 71 | — | — |
| | 90 | 89 | | | | | |
| FC74 | Ex | Ex | FC176 | 110 | 1 | — | — |
| | 91 | 89 | | | | | |
| FC75 | Ex | Ex | FC181 | 47 | 1 | — | — |
| | 92 | 89 | | | | | |
| FC76 | Ex | Ex | FC160 | 340 | 10 | — | — |
| | 93 | 100 | | | | | |
| FC77 | Ex | Ex | FC161 | 270 | 5 | — | — |
| | 94 | 100 | | | | | |
| FC78 | Ex | Ex | FC162 | 620 | 29 | — | — |
| | 95 | 100 | | | | | |
| FC79 | Ex | Ex | FC163 | 540 | 21 | — | — |
| | 96 | 100 | | | | | |
| FC80 | Ex | Ex | FC164 | 190 | 3 | — | — |
| | 97 | 100 | | | | | |
| FC81 | Ex | Ex | FC165 | 160 | 1 | — | — |
| | 98 | 100 | | | | | |
| FC82 | Ex | Ex | FC166 | 510 | 19 | — | — |
| | 101 | 100 | | | | | |
| FC83 | Ex | Ex | FC167 | 400 | 16 | — | — |
| | 102 | 100 | | | | | |
| FC84 | Ex | Ex | FC168 | 380 | 14 | — | — |
| | 103 | 100 | | | | | |
| FC85 | Ex | Ex | FC169 | 270 | 30 | — | — |
| | 104 | 100 | | | | | |
| FC86 | Ex | Ex | FC170 | 66 | 8 | — | — |
| | 105 | 100 | | | | | |
| FC87 | Ex | Ex | FC171 | 190 | 0.004 | — | — |
| | 106 | 100 | | | | | |
| FC88 | Ex | Ex | FC172 | 1300 | 180 | — | — |
| | 107 | 99 | | | | | |
| FC89 | Ex | Ex | FC173 | 1300 | 100 | — | — |
| | 107 | 112 | | | | | |
| FC90 | Ex | Ex | FC174 | 260 | 3 | — | — |
| | 108 | 100 | | | | | |
| FC91 | Ex | Ex | FC175 | 130 | 1 | — | — |
| | 109 | 100 | | | | | |
| FC92 | Ex | Ex | FC176 | 240 | 2 | — | — |
| | 110 | 100 | | | | | |
| FC93 | Ex | Ex | FC177 | 100 | 1 | — | — |
| | 111 | 100 | | | | | |
| FC94 | Ex | Ex | FC163 | 260 | 12 | — | — |
| | 113 | 114 | | | | | |
| FC95 | Ex | Ex | FC172 | 720 | 88 | — | — |
| | 115 | 114 | | | | | |
| FC96 | Ex | Ex | FC176 | 120 | 1 | — | — |
| | 116 | 114 | | | | | |
| FC97 | Ex | Ex | FC181 | 53 | 1 | — | — |
| | 117 | 114 | | | | | |
| FC98 | Ex | Ex | FC163 | 180 | 4 | 620 | 13 |
| | 118 | 119 | | | | | |
| FC99 | Ex | Ex | FC172 | 480 | 30 | 1700 | 92 |
| | 120 | 119 | | | | | |
| FC100 | Ex | Ex | FC176 | 82 | 0.5 | 290 | 2 |
| | 121 | 119 | | | | | |
| FC101 | Ex | Ex | FC163 | 210 | 6 | 730 | 18 |
| | 122 | 123 | | | | | |
| FC102 | Ex | Ex | FC172 | 550 | 42 | 1900 | 140 |
| | 124 | 123 | | | | | |
| FC103 | Ex | Ex | FC176 | 92 | 1 | 320 | 2 |
| | 125 | 123 | | | | | |
| FC104 | Ex | Ex | FC160 | 250 | 6 | 860 | 17 |
| | 126 | 133 | | | | | |
| FC105 | Ex | Ex | FC161 | 180 | 3 | 630 | 8 |
| | 127 | 133 | | | | | |
| FC106 | Ex | Ex | FC162 | 410 | 14 | 1400 | 40 |
| | 128 | 133 | | | | | |
| FC107 | Ex | Ex | FC163 | 370 | 10 | 1300 | 34 |
| | 129 | 133 | | | | | |
| FC108 | Ex | Ex | FC164 | 150 | 1 | 510 | 4 |
| | 130 | 133 | | | | | |
| FC109 | Ex | Ex | FC165 | 110 | 1 | 400 | 2 |
| | 131 | 133 | | | | | |
| FC110 | Ex | Ex | FC166 | 380 | 10 | 1300 | 31 |
| | 134 | 133 | | | | | |
| FC111 | Ex | Ex | FC167 | 280 | 8 | 970 | 26 |
| | 135 | 133 | | | | | |
| FC112 | Ex | Ex | FC168 | 300 | 8 | 1000 | 24 |
| | 136 | 133 | | | | | |
| FC113 | Ex | Ex | FC169 | 200 | 16 | 690 | 47 |
| | 137 | 133 | | | | | |
| FC114 | Ex | Ex | FC170 | 45 | 4 | 160 | 12 |
| | 138 | 133 | | | | | |
| FC115 | Ex | Ex | FC171 | 150 | 0.002 | 510 | 0.01 |
| | 139 | 133 | | | | | |
| FC116 | Ex | Ex | FC172 | 910 | 100 | 3200 | 330 |
| | 140 | 132 | | | | | |
| FC117 | Ex | Ex | FC173 | 970 | 53 | 3400 | 160 |
| | 140 | 145 | | | | | |
| FC118 | Ex | Ex | FC174 | 190 | 1 | 660 | 4 |
| | 141 | 133 | | | | | |
| FC119 | Ex | Ex | FC175 | 93 | 0.4 | 330 | 1 |
| | 142 | 133 | | | | | |
| FC120 | Ex | Ex | FC176 | 180 | 1 | 630 | 4 |
| | 143 | 133 | | | | | |
| FC121 | Ex | Ex | FC177 | 79 | 0.3 | 280 | 1 |
| | 144 | 133 | | | | | |
| FC122 | Ex | Ex | FC163 | 1700 | 200 | — | — |
| | 146 | 147 | | | | | |
| FC123 | Ex | Ex | FC172 | 4200 | 1300 | — | — |
| | 148 | 147 | | | | | |
| FC124 | Ex | Ex | FC176 | 790 | 24 | — | — |
| | 149 | 147 | | | | | |
| FC125 | Ex | Ex | FC163 | 1900 | 210 | — | — |
| | 150 | 151 | | | | | |
| FC126 | Ex | Ex | FC172 | 4300 | 1500 | — | — |
| | 152 | 151 | | | | | |
| FC127 | Ex | Ex | FC176 | 780 | 24 | — | — |
| | 153 | 151 | | | | | |
| FC128 | Ex | Ex | FC163 | 2000 | 220 | — | — |
| | 154 | 155 | | | | | |
| FC129 | Ex | Ex | FC172 | 4800 | 1500 | — | — |
| | 156 | 155 | | | | | |
| FC130 | Ex | Ex | FC176 | 850 | 26 | — | — |
| | 157 | 155 | | | | | |
| FC131 | Ex | Ex | FC163 | 740 | 42 | — | — |
| | 158 | 159 | | | | | |
| FC132 | Ex | Ex | FC172 | 1900 | 320 | — | — |
| | 160 | 159 | | | | | |
| FC133 | Ex | Ex | FC176 | 330 | 5 | — | — |
| | 161 | 159 | | | | | |
| FC134 | Ex | Ex | FC163 | 930 | 52 | — | — |
| | 162 | 163 | | | | | |
| FC135 | Ex | Ex | FC172 | 2300 | 370 | — | — |
| | 164 | 163 | | | | | |
| FC136 | Ex | Ex | FC176 | 400 | 6 | — | — |
| | 165 | 163 | | | | | |
| FC137 | Ex | Ex | FC163 | 220 | 10 | — | — |
| | 166 | 167 | | | | | |
| FC138 | Ex | Ex | FC172 | 590 | 73 | — | — |
| | 168 | 167 | | | | | |
| FC139 | Ex | Ex | FC176 | 100 | 1 | — | — |
| | 169 | 167 | | | | | |
| FC140 | Ex | Ex | FC181 | 44 | 0.5 | — | — |
| | 170 | 167 | | | | | |
| FC141 | Ex | Ex | FC163 | 280 | 13 | — | — |
| | 171 | 172 | | | | | |
| FC142 | Ex | Ex | FC172 | 720 | 93 | — | — |
| | 173 | 172 | | | | | |
| FC143 | Ex | Ex | FC176 | 120 | 1 | — | — |
| | 174 | 172 | | | | | |
| FC144 | Ex | Ex | FC181 | 54 | 1 | — | — |
| | 175 | 172 | | | | | |
| FC145 | Ex | Ex | FC163 | 1200 | 150 | 4300 | 440 |
| | 176 | 177 | | | | | |
| FC146 | Ex | Ex | FC172 | 3300 | 1000 | 11000 | 3200 |
| | 178 | 177 | | | | | |
| FC147 | Ex | Ex | FC176 | 560 | 16 | 2000 | 53 |
| | 179 | 177 | | | | | |
| FC148 | Ex | Ex | FC163 | 1400 | 170 | 5000 | 530 |
| | 180 | 181 | | | | | |
| FC149 | Ex | Ex | FC172 | 3700 | 1200 | 13000 | 4100 |
| | 182 | 181 | | | | | |
| FC150 | Ex | Ex | FC176 | 660 | 21 | 2300 | 67 |
| | 183 | 181 | | | | | |
| FC151 | Ex | Ex | FC163 | 1700 | 200 | 5900 | 620 |
| | 184 | 185 | | | | | |
| FC152 | Ex | Ex | FC172 | 4500 | 1400 | 16000 | 4500 |
| | 186 | 185 | | | | | |
| FC153 | Ex | Ex | FC176 | 780 | 23 | 2700 | 75 |
| | 187 | 185 | | | | | |
| FC154 | Ex | Ex | FC163 | 1000 | 79 | 3600 | 250 |
| | 188 | 189 | | | | | |
| FC155 | Ex | Ex | FC172 | 2400 | 530 | 8400 | 1700 |
| | 190 | 189 | | | | | |
| FC156 | Ex | Ex | FC176 | 450 | 9 | 1600 | 27 |
| | 191 | 189 | | | | | |
| FC157 | Ex | Ex | FC163 | 1200 | 93 | 4300 | 290 |
| | 192 | 193 | | | | | |
| FC158 | Ex | Ex | FC172 | 3000 | 610 | 11000 | 2000 |
| | 194 | 193 | | | | | |
| FC159 | Ex | Ex | FC176 | 530 | 11 | 1900 | 32 |
| | 195 | 193 | | | | | |
| FC160 | Comp. | Comp. | | 97 | 10 | | |
| | Ex 1 | Ex 8 | | | | | |
| FC161 | Comp. | Comp. | | 78 | 5 | | |
| | Ex 2 | Ex 8 | | | | | |
| FC162 | Comp. | Comp. | | 180 | 28 | | |
| | Ex 3 | Ex 8 | | | | | |
| FC163 | Comp. | Comp. | | 160 | 21 | | |
| | Ex 4 | Ex 8 | | | | | |
| FC164 | Comp. | Comp. | | 59 | 3 | | |
| | Ex 5 | Ex 8 | | | | | |
| FC165 | Comp. | Comp. | | 44 | 1 | | |
| | Ex 6 | Ex 8 | | | | | |
| FC166 | Comp. | Comp. | | 160 | 18 | | |
| | Ex 9 | Ex 8 | | | | | |
| FC167 | Comp. | Comp. | | 110 | 14 | | |
| | Ex 10 | Ex 8 | | | | | |
| FC168 | Comp. | Comp. | | 110 | 13 | | |
| | Ex 11 | Ex 8 | | | | | |
| FC169 | Comp. | Comp. | | 77 | 28 | | |
| | Ex 12 | Ex 8 | | | | | |
| FC170 | Comp. | Comp. | | 20 | 8 | | |
| | Ex 13 | Ex 8 | | | | | |
| FC171 | Comp. | Comp. | | 55 | 0.003 | | |
| | Ex 14 | Ex 8 | | | | | |
| FC172 | Comp. | Comp. | | 360 | 180 | | |
| | Ex 15 | Ex 7 | | | | | |
| FC173 | Comp. | Comp. | | 370 | 93 | | |
| | Ex 15 | Ex 20 | | | | | |
| FC174 | Comp. | Comp. | | 74 | 2 | | |
| | Ex 16 | Ex 8 | | | | | |
| FC175 | Comp. | Comp. | | 37 | 1 | | |
| | Ex 17 | Ex 8 | | | | | |
| FC176 | Comp. | Comp. | | 71 | 2 | | |
| | Ex 18 | Ex 8 | | | | | |
| FC177 | Comp. | Comp. | | 30 | 1 | | |
| | Ex 19 | Ex 8 | | | | | |
| FC178 | Comp. | Comp. | | 65 | 7 | | |
| | Ex 21 | Ex 8 | | | | | |
| FC179 | Comp. | Comp. | | 240 | 20 | | |
| | Ex 22 | Ex 25 | | | | | |
| FC180 | Comp. | Comp. | | 220 | 0.02 | | |
| | Ex 23 | Ex 26 | | | | | |
| FC181 | Comp. | Comp. | | 29 | 1 | | |

Ex: Example
Comp. Ex: Comparative Example

Any of the fuel cells employing the enzyme electrode having a void-containing conductive member designated in Table 4 as FC1 to 124, FC131 to 133, FC137 to 140, FC145 to 147, and FC154 to 156 gives higher current density than that shown by the fuel cells employing a flat gold electrode, and a corresponding carrier, mediator, enzyme, and substrate. Most of the fuel cells give a higher maximum power than corresponding fuel cells employing flat gold electrodes. In particular, the sensor having five-layered electrode gives much higher current density, nearly 30-fold at the highest, and the maximum power of nearly 25-fold at the highest. This shows possibility of increasing the output of the fuel cell by use of the void-containing conductive member. Further, the fuel cells employing the enzyme electrode having a void size-gradient conductive member having numerous voids designated as FC125 to 130, FC134 to 136, FC141 to 144, FC148 to 153, and FC157 to 159 give a higher current density and a higher maximum power than that given by enzyme electrodes of comparative non-void size-gradient conductive members. The fuel cells employing the five-layered electrode having a void size-gradient conductive member give a higher current density and a higher maximum power than that given by comparative fuels cells employing non-void size-gradient conductive members. This shows possibility of further increasing the output of the fuel cell by use of a void size-gradient conductive member having numerous voids.

### Example 198

Flow cell type of fuel cells are constructed with the fuel cells designated as FC1 to 9, FC12 to 18, FC21 to 25, FC29 to 31, FC98 to 112, FC115 to 121, and FC145 to 159 in Table 4. In the flow cells as shown in FIG. 8, five anode-cathode sets are arranged alternately with interposition of porous polypropylene films (thickness: 20 μm, porosity: 80%) in an acrylic resin case. Gold wires of 0.1 mm diameter are connected to the electrodes through the case for electric contact, and fixed to the case with a silicone resin to the case. The measurement is conducted by allowing the electrolytic solution to pass through tubes attached to the acrylic case at a flow rate of 0.25 mL/sec by a precision pump at 37° C. The compositions of the electrolyte solutions are the same as in Example 197. Table 5 shows the measurement results.

TABLE 5

| | | | | Short- | |
|---|---|---|---|---|---|
| | | | | circuit | |
| | | | | current | Maximum |
| | | | Reference | density | power |
| | | | non-flow | (Flow | (Flow |
| | | | type fuel | type) | type) |
| Symbol | Anode | Cathode | cell | μA/cm² | μW/cm² |
| FCF1 | Ex 1 | Ex 8 | FC1 | 7400 | 460 |
| FCF2 | Ex 2 | Ex 8 | FC2 | 6600 | 270 |
| FCF3 | Ex 3 | Ex 8 | FC3 | 13000 | 1300 |
| FCF4 | Ex 4 | Ex 8 | FC4 | 10000 | 870 |
| FCF5 | Ex 5 | Ex 8 | FC5 | 3500 | 140 |
| FCF6 | Ex 6 | Ex 8 | FC6 | 2900 | 38 |
| FCF7 | Ex 9 | Ex 8 | FC7 | 12000 | 800 |
| FCF8 | Ex 10 | Ex 8 | FC8 | 7300 | 840 |
| FCF9 | Ex 11 | Ex 8 | FC9 | 8700 | 740 |
| FCF10 | Ex 14 | Ex 8 | FC12 | 5300 | 1200 |
| FCF11 | Ex 15 | Ex 7 | FC13 | 28000 | 11000 |
| FCF12 | Ex 15 | Ex 20 | FC14 | 33000 | 6600 |
| FCF13 | Ex 16 | Ex 8 | FC15 | 6100 | 120 |
| FCF14 | Ex 17 | Ex 8 | FC16 | 2500 | 45 |
| FCF15 | Ex 18 | Ex 8 | FC17 | 4100 | 140 |
| FCF16 | Ex 19 | Ex 8 | FC18 | 2300 | 32 |
| FCF17 | Ex 23 | Ex 26 | FC21 | 16000 | 1 |
| FCF18 | Ex 24 | Ex 8 | FC22 | 2400 | 45 |
| FCF19 | Ex 27 | Ex 28 | FC23 | 8600 | 990 |
| FCF20 | Ex 29 | Ex 28 | FC24 | 26000 | 8400 |
| FCF21 | Ex 30 | Ex 28 | FC25 | 3900 | 120 |
| FCF22 | Ex 35 | Ex 36 | FC29 | 2400 | 260 |
| FCF23 | Ex 37 | Ex 36 | FC30 | 6700 | 1900 |
| FCF24 | Ex 38 | Ex 36 | FC31 | 1000 | 31 |
| FCF25 | Ex 118 | Ex 119 | FC98 | 1800 | 39 |
| FCF26 | Ex 120 | Ex 119 | FC99 | 4300 | 210 |
| FCF27 | Ex 121 | Ex 119 | FC100 | 590 | 4 |
| FCF28 | Ex 122 | Ex 123 | FC101 | 2000 | 57 |
| FCF29 | Ex 124 | Ex 123 | FC102 | 4100 | 280 |
| FCF30 | Ex 125 | Ex 123 | FC103 | 840 | 5 |
| FCF31 | Ex 126 | Ex 133 | FC104 | 2300 | 36 |
| FCF32 | Ex 127 | Ex 133 | FC105 | 1400 | 20 |
| FCF33 | Ex 128 | Ex 133 | FC106 | 3200 | 130 |
| FCF34 | Ex 129 | Ex 133 | FC107 | 3300 | 110 |
| FCF35 | Ex 130 | Ex 133 | FC108 | 1200 | 11 |
| FCF36 | Ex 131 | Ex 133 | FC109 | 1100 | 4 |
| FCF37 | Ex 134 | Ex 133 | FC110 | 3600 | 83 |
| FCF38 | Ex 135 | Ex 133 | FC111 | 2100 | 50 |
| FCF39 | Ex 136 | Ex 133 | FC112 | 2300 | 51 |
| FCF40 | Ex 139 | Ex 133 | FC115 | 1200 | 0.02 |
| FCF41 | Ex 140 | Ex 132 | FC116 | 8900 | 940 |
| FCF42 | Ex 140 | Ex 145 | FC117 | 7900 | 520 |
| FCF43 | Ex 141 | Ex 133 | FC118 | 1700 | 10 |
| FCF44 | Ex 142 | Ex 133 | FC119 | 880 | 3 |
| FCF45 | Ex 143 | Ex 133 | FC120 | 1500 | 10 |
| FCF46 | Ex 144 | Ex 133 | FC121 | 680 | 3 |
| FCF47 | Ex 176 | Ex 177 | FC145 | 8900 | 1100 |
| FCF48 | Ex 178 | Ex 177 | FC146 | 33000 | 7400 |
| FCF49 | Ex 179 | Ex 177 | FC147 | 4100 | 120 |
| FCF50 | Ex 180 | Ex 181 | FC148 | 13000 | 1200 |
| FCF51 | Ex 182 | Ex 181 | FC149 | 27000 | 11000 |
| FCF52 | Ex 183 | Ex 181 | FC150 | 5100 | 200 |
| FCF53 | Ex 184 | Ex 185 | FC151 | 17000 | 1800 |
| FCF54 | Ex 186 | Ex 185 | FC152 | 46000 | 13000 |
| FCF55 | Ex 187 | Ex 185 | FC153 | 6900 | 210 |
| FCF56 | Ex 188 | Ex 189 | FC154 | 11000 | 670 |
| FCF57 | Ex 190 | Ex 189 | FC155 | 17000 | 4400 |
| FCF58 | Ex 191 | Ex 189 | FC156 | 4200 | 61 |
| FCF59 | Ex 192 | Ex 193 | FC157 | 12000 | 710 |
| FCF60 | Ex 194 | Ex 193 | FC158 | 26000 | 4600 |
| FCF61 | Ex 195 | Ex 193 | FC159 | 4700 | 70 |

Ex: Example

The flow cell type of fuel cells give higher electric current densities and higher outputs than that of comparative corresponding non-flow type fuel cells employing the corresponding conductive member, carrier, mediator, enzyme, and substrate shown in Table 4 by a factor of about 2.5. This shows the possibility of increasing the outputs of the fuel cell by constructing the fuel cell in a flow cell type. Among the flow cell type of fuel cells, the void size-gradient fuel cells having numerous voids, FCF50 to 55 and FCF59 to 61, give higher electric current densities and higher outputs than that of comparative corresponding fuel cells having no void-size gradient shown in Table 4. This shows the further possibility of increasing the outputs of the flow type fuel cell by employing the void size-gradient conductive member.

### Example 199

Electrochemical reactors are constructed with the enzyme electrodes of Examples as shown in Table 6. Three-electrode cells are used in which an enzyme electrode serves as the working electrode, an Ag/AgCl electrode serves as the reference electrode, and a platinum wire serves as the counter electrode as shown in FIG. 4. The electrolytic solution contains 0.1M NaCl, 20 mM phosphate buffer, 10 mM glucose, and 10 mM ethanol. A potential of 0.3 V vs Ag/AgCl is applied for 100 minutes in the water-jacketed cell in a nitrogen atmosphere. The products are quantitatively determined by high-speed liquid chromatography. In the reactors CR10, CR11, CR18, CR53, CR54, CR83, CR84, CR110, CR111, Cr127, CR128, and CR135 shown in Table 6, the counter electrode is a platinum wire modified by polydimethylsiloxane. Table 6 shows the results.

TABLE 6

| | | | Reaction | | Product |
|---|---|---|---|---|---|
| | Enzyme | Reference | charge | Reaction | quantity |
| Symbol | electrode | reactor | mC | product | μmol |
| CR1 | Ex 1 | CR156 | 5200 | Gluconolactone | 53 |
| CR2 | Ex 2 | CR157 | 4100 | Acetaldehyde | 41 |
| CR3 | Ex 3 | CR158 | 9300 | Gluconolactone | 89 |
| CR4 | Ex 4 | CR159 | 7700 | Acetaldehyde | 79 |
| CR5 | Ex 5 | CR160 | 3300 | Gluconolactone | 33 |
| CR6 | Ex 6 | CR161 | 2500 | Acetaldehyde | 24 |
| CR7 | Ex 9 | CR162 | 8100 | Gluconolactone | 82 |
| CR8 | Ex 10 | CR163 | 5800 | Gluconolactone | 58 |
| CR9 | Ex 11 | CR164 | 6000 | Gluconolactone | 58 |
| CR10 | Ex 12 | CR165 | 4200 | Gluconolactone | 41 |
| CR11 | Ex 13 | CR166 | 990 | Gluconolactone | 10 |
| CR12 | Ex 14 | CR167 | 3100 | Gluconolactone | 32 |
| CR13 | Ex 15 | CR168 | 20000 | Gluconolactone | 190 |
| CR14 | Ex 16 | CR169 | 4500 | Gluconolactone | 43 |
| CR15 | Ex 17 | CR170 | 2000 | Gluconolactone | 20 |
| CR16 | Ex 18 | CR171 | 3700 | Gluconolactone | 37 |
| CR17 | Ex 19 | CR172 | 1600 | Gluconolactone | 16 |
| CR18 | Ex 21 | CR173 | 4100 | Gluconolactone | 41 |
| CR19 | Ex 22 | CR174 | 12000 | Gluconolactone | 120 |
| CR20 | Ex 23 | CR175 | 12000 | Gluconolactone | 120 |
| CR21 | Ex 24 | CR176 | 1700 | Gluconolactone | 16 |
| CR22 | Ex 27 | CR159 | 7500 | Acetaldehyde | 71 |
| CR23 | Ex 29 | CR168 | 20000 | Gluconolactone | 190 |
| CR24 | Ex 30 | CR171 | 3400 | Gluconolactone | 32 |
| CR25 | Ex 31 | CR159 | 9800 | Acetaldehyde | 95 |
| CR26 | Ex 33 | CR168 | 25000 | Gluconolactone | 240 |
| CR27 | Ex 34 | CR171 | 4700 | Gluconolactone | 44 |
| CR28 | Ex 35 | CR159 | 2100 | Acetaldehyde | 20 |
| CR29 | Ex 37 | CR168 | 5500 | Gluconolactone | 57 |
| CR30 | Ex 38 | CR171 | 980 | Gluconolactone | 9 |
| CR31 | Ex 39 | CR159 | 1600 | Acetaldehyde | 16 |
| CR32 | Ex 41 | CR168 | 3700 | Gluconolactone | 37 |
| CR33 | Ex 42 | CR171 | 710 | Gluconolactone | 7 |
| CR34 | Ex 43 | CR159 | 2100 | Acetaldehyde | 21 |
| CR35 | Ex 45 | CR168 | 5400 | Gluconolactone | 52 |
| CR36 | Ex 46 | CR171 | 950 | Gluconolactone | 10 |
| CR37 | Ex 47 | CR176 | 410 | Gluconolactone | 4 |
| CR38 | Ex 48 | CR159 | 1300 | Acetaldehyde | 12 |
| CR39 | Ex 50 | CR168 | 3200 | Gluconolactone | 30 |
| CR40 | Ex 51 | CR171 | 550 | Gluconolactone | 5 |
| CR41 | Ex 52 | CR159 | 2000 | Acetaldehyde | 20 |
| CR42 | Ex 54 | CR168 | 5200 | Gluconolactone | 52 |
| CR43 | Ex 55 | CR171 | 870 | Gluconolactone | 9 |
| CR44 | Ex 56 | CR156 | 3000 | Gluconolactone | 29 |
| CR45 | Ex 57 | CR157 | 2500 | Acetaldehyde | 24 |
| CR46 | Ex 58 | CR158 | 5600 | Gluconolactone | 55 |
| CR47 | Ex 59 | CR159 | 5000 | Acetaldehdyde | 49 |
| CR48 | Ex 60 | CR160 | 2100 | Gluconolactone | 21 |
| CR49 | Ex 61 | CR161 | 1600 | Acetaldehdyde | 15 |
| CR50 | Ex 64 | CR162 | 5100 | Gluconolactone | 50 |
| CR51 | Ex 65 | CR163 | 3800 | Gluconolactone | 38 |
| CR52 | Ex 66 | CR164 | 3900 | Gluconolactone | 38 |
| CR53 | Ex 67 | CR165 | 2800 | Gluconolactone | 28 |
| CR54 | Ex 68 | CR166 | 590 | Gluconolactone | 6 |
| CR55 | Ex 69 | CR167 | 2000 | Gluconolactone | 19 |
| CR56 | Ex 70 | CR168 | 12000 | Gluconolactone | 120 |
| CR57 | Ex 71 | CR169 | 2700 | Gluconolactone | 26 |
| CR58 | Ex 72 | CR170 | 1300 | Gluconolactone | 12 |
| CR59 | Ex 73 | CR171 | 2200 | Gluconolactone | 22 |
| CR60 | Ex 74 | CR172 | 1000 | Gluconolactone | 10 |
| CR61 | Ex 76 | CR159 | 1100 | Acetaldehyde | 11 |
| CR62 | Ex 78 | CR168 | 2900 | Gluconolactone | 29 |
| CR63 | Ex 79 | CR171 | 510 | Gluconolactone | 5 |
| CR64 | Ex 80 | CR159 | 1400 | Acetaldehyde | 13 |
| CR65 | Ex 82 | CR168 | 3400 | Gluconolactone | 35 |
| CR66 | Ex 83 | CR171 | 620 | Gluconolactone | 6 |
| CR67 | Ex 84 | CR159 | 3100 | Acetaldehyde | 31 |
| CR68 | Ex 86 | CR168 | 7300 | Gluconolactone | 70 |
| CR69 | Ex 87 | CR171 | 1400 | Gluconolactone | 13 |
| CR70 | Ex 88 | CR159 | 1500 | Acetaldehyde | 14 |
| CR71 | Ex 90 | CR168 | 3800 | Gluconolactone | 37 |
| CR72 | Ex 91 | CR171 | 720 | Gluconolactone | 7 |
| CR73 | Ex 92 | CR176 | 320 | Gluconolactone | 3 |
| CR74 | Ex 93 | CR156 | 2300 | Gluconolactone | 22 |
| CR75 | Ex 94 | CR157 | 1700 | Acetaldehyde | 17 |
| CR76 | Ex 95 | CR158 | 3900 | Gluconolactone | 38 |
| CR77 | Ex 96 | CR159 | 3600 | Acetaldehyde | 35 |
| CR78 | Ex 97 | CR160 | 1400 | Gluconolactone | 15 |
| CR79 | Ex 98 | CR161 | 980 | Acetaldehyde | 10 |
| CR80 | Ex 101 | CR162 | 3400 | Gluconolactone | 35 |
| CR81 | Ex 102 | CR163 | 2600 | Gluconolactone | 25 |
| CR82 | Ex 103 | CR164 | 2700 | Gluconolactone | 25 |
| CR83 | Ex 104 | CR165 | 1700 | Gluconolactone | 18 |
| CR84 | Ex 105 | CR166 | 440 | Gluconolactone | 4 |
| CR85 | Ex 106 | CR167 | 1300 | Gluconolactone | 12 |
| CR86 | Ex 107 | CR168 | 8500 | Gluconolactone | 88 |
| CR87 | Ex 108 | CR169 | 1900 | Gluconolactone | 18 |
| CR88 | Ex 109 | CR170 | 900 | Gluconolactone | 9 |
| CR89 | Ex 110 | CR171 | 1700 | Gluconolactone | 17 |
| CR90 | Ex 111 | CR172 | 690 | Gluconolactone | 7 |
| CR91 | Ex 113 | CR159 | 1800 | Acetaldehyde | 18 |
| CR92 | Ex 115 | CR168 | 4800 | Gluconolactone | 49 |
| CR93 | Ex 116 | CR171 | 830 | Gluconolactone | 8 |
| CR94 | Ex 117 | CR176 | 350 | Gluconolactone | 3 |
| CR95 | Ex 118 | CR159 | 1200 | Acetaldehyde | 12 |
| CR96 | Ex 120 | CR168 | 3100 | Gluconolactone | 30 |
| CR97 | Ex 121 | CR171 | 590 | Gluconolactone | 6 |
| CR98 | Ex 122 | CR159 | 1400 | Acetaldehyde | 13 |
| CR99 | Ex 124 | CR168 | 3400 | Gluconolactone | 34 |
| CR100 | Ex 125 | CR171 | 680 | Gluconolactone | 7 |
| CR101 | Ex 126 | CR156 | 1700 | Gluconolactone | 16 |
| CR102 | Ex 127 | CR157 | 1300 | Acetaldehyde | 13 |
| CR103 | Ex 128 | CR158 | 2900 | Gluconolactone | 29 |
| CR104 | Ex 129 | CR159 | 2600 | Acetaldehyde | 26 |
| CR105 | Ex 130 | CR160 | 930 | Gluconolactone | 9 |
| CR106 | Ex 131 | CR161 | 770 | Acetaldehyde | 7 |
| CR107 | Ex 134 | CR162 | 2800 | Gluconolactone | 27 |
| CR108 | Ex 135 | CR163 | 1800 | Gluconolactone | 18 |
| CR109 | Ex 136 | CR164 | 1900 | Gluconolactone | 20 |
| CR110 | Ex 137 | CR165 | 1300 | Gluconolactone | 13 |
| CR111 | Ex 138 | CR166 | 330 | Gluconolactone | 3 |
| CR112 | Ex 139 | CR167 | 960 | Gluconolactone | 9 |
| CR113 | Ex 140 | CR168 | 6700 | Gluconolactone | 63 |
| CR114 | Ex 141 | CR169 | 1200 | Gluconolactone | 12 |
| CR115 | Ex 142 | CR170 | 660 | Gluconolactone | 7 |
| CR116 | Ex 143 | CR171 | 1200 | Gluconolactone | 11 |
| CR117 | Ex 144 | CR172 | 530 | Gluconolactone | 5 |
| CR118 | Ex 146 | CR159 | 11000 | Acetaldehyde | 100 |
| CR119 | Ex 148 | CR168 | 29000 | Gluconolactone | 280 |
| CR120 | Ex 149 | CR171 | 5000 | Gluconolactone | 47 |
| CR121 | Ex 150 | CR159 | 12000 | Acetaldehyde | 120 |
| CR122 | Ex 152 | CR168 | 33000 | Gluconolactone | 330 |
| CR123 | Ex 153 | CR171 | 5600 | Gluconolactone | 58 |
| CR124 | Ex 154 | CR159 | 13000 | Acetaldehyde | 140 |
| CR125 | Ex 156 | CR168 | 31000 | Gluconolactone | 300 |
| CR126 | Ex 157 | CR171 | 6800 | Gluconolactone | 65 |
| CR127 | Ex 158 | CR159 | 5100 | Acetaldehyde | 51 |
| CR128 | Ex 160 | CR168 | 12000 | Gluconolactone | 110 |
| CR129 | Ex 161 | CR171 | 2400 | Gluconolactone | 24 |
| CR130 | Ex 162 | CR159 | 6200 | Acetaldehyde | 62 |
| CR131 | Ex 164 | CR168 | 15000 | Gluconolactone | 150 |
| CR132 | Ex 165 | CR171 | 2700 | Gluconolactone | 26 |
| CR133 | Ex 166 | CR159 | 1400 | Gluconolactone | 14 |
| CR134 | Ex 168 | CR168 | 3700 | Acetaldehyde | 38 |
| CR135 | Ex 169 | CR171 | 650 | Gluconolactone | 7 |
| CR136 | Ex 170 | CR176 | 300 | Gluconolactone | 3 |
| CR137 | Ex 171 | CR159 | 1800 | Acetaldehyde | 17 |
| CR138 | Ex 173 | CR168 | 4700 | Gluconolactone | 46 |
| CR139 | Ex 174 | CR171 | 820 | Gluconolactone | 9 |
| CR140 | Ex 175 | CR176 | 370 | Gluconolactone | 4 |
| CR141 | Ex 176 | CR159 | 9200 | Acetaldehyde | 87 |
| CR142 | Ex 178 | CR168 | 20000 | Gluconolactone | 190 |
| CR143 | Ex 179 | CR171 | 4000 | Gluconolactone | 40 |
| CR144 | Ex 180 | CR159 | 9800 | Acetaldehyde | 94 |
| CR145 | Ex 182 | CR168 | 24000 | Gluconolactone | 240 |
| CR146 | Ex 183 | CR171 | 4400 | Gluconolactone | 43 |
| CR147 | Ex 184 | CR159 | 12000 | Acetaldehyde | 110 |
| CR148 | Ex 186 | CR168 | 27000 | Gluconolactone | 270 |
| CR149 | Ex 187 | CR171 | 5500 | Gluconolactone | 56 |
| CR150 | Ex 188 | CR159 | 6500 | Acetaldehyde | 64 |
| CR151 | Ex 190 | CR168 | 16000 | Gluconolactone | 150 |
| CR152 | Ex 191 | CR171 | 2900 | Gluconolactone | 29 |
| CR153 | Ex 192 | CR159 | 7900 | Acetalsehyde | 75 |
| CR154 | Ex 194 | CR168 | 20000 | Gluconolactone | 190 |
| CR155 | Ex 195 | CR171 | 3600 | Gluconolactone | 37 |
| CR156 | Comp. Ex 1 | | 620 | Gluconolactone | 6 |
| CR157 | Comp. Ex 2 | | 520 | Acetaldehyde | 5 |
| CR158 | Comp. Ex 3 | | 1200 | Gluconolactone | 12 |
| CR159 | Comp. Ex 4 | | 970 | Acetaldehyde | 10 |
| CR160 | Comp. Ex 5 | | 390 | Gluconolactone | 4 |
| CR161 | Comp. Ex 6 | | 300 | Acetaldehyde | 3 |
| CR162 | Comp. Ex 9 | | 980 | Gluconolactone | 9 |
| CR163 | Comp. Ex | | 840 | Gluconolactone | 8 |
| | 10 | | | | |
| CR164 | Comp. Ex | | 720 | Gluconolactone | 7 |
| | 11 | | | | |
| CR165 | Comp. Ex | | 480 | Gluconolactone | 5 |
| | 12 | | | | |
| CR166 | Comp. Ex | | 120 | Gluconolactone | 1 |
| | 13 | | | | |
| CR167 | Comp. Ex | | 380 | Gluconolactone | 4 |
| | 14 | | | | |
| CR168 | Comp. Ex | | 2600 | Gluconolactone | 27 |
| | 15 | | | | |
| CR169 | Comp. Ex | | 520 | Gluconolactone | 5 |
| | 16 | | | | |
| CR170 | Comp. Ex | | 270 | Gluconolactone | 3 |
| | 17 | | | | |
| CR171 | Comp. Ex | | 500 | Gluconolactone | 5 |
| | 18 | | | | |
| CR172 | Comp. Ex | | 200 | Gluconolactone | 2 |
| | 19 | | | | |
| CR173 | Comp. Ex | | 470 | Gluconolactone | 5 |
| | 21 | | | | |
| CR174 | Comp. Ex | | 1500 | Gluconolactone | 14 |
| | 22 | | | | |
| CR175 | Comp. Ex | | 1400 | Gluconolactone | 14 |
| | 23 | | | | |
| CR176 | Comp. Ex | | 210 | Gluconolactone | 2 |
| | 24 | | | | |

Ex: Example
Comp. Ex: Comparative Example

From the reaction solution of the reactor employing an enzyme electrode having an enzyme utilizing glucose as the substrate (glucose oxidase, and glucose dehydrogenase), gluconolactone is detected without detection of acetaldehyde. From the reaction solution of the reactor employing an enzyme electrode having an enzyme utilizing an alcohol as the substrate (alcohol dehydrogenase), acetaldehyde is detected without detection of gluconolactone. Thus in any of the reactor employing the enzyme electrode, the reaction proceeds selectively with the substrate. Further, in any of the reactor, the reaction charge quantity and the formed substance are in high correlation, showing the quantitativeness of the reaction. With the reactors CR1 to 120, CR127 to 129, CR133 to 136, CR141 to 143, and CR150 to 152 in Table 6 employing the enzyme electrode with the void-containing conductive member give larger reaction charge quantity than the comparative reactors employing a flat gold electrode with the corresponding carrier, mediator, enzyme, and substrate. This shows possibility of shortening of the reaction time by use of the void-containing conductive member. Further, the chemical reactors employing the enzyme electrode having a void size-gradient conductive member having numerous voids denoted in Table 6 as CR121 to 126, CR130 to 132, CR137 to 140, CR144 to 149, and CR153 to 155 give a larger reaction charge quantity and a larger product quantity than the comparative apparatuses employing a conductive member having no void-size gradient. This shows the possibility of further shortening of the reaction time by use of the void size-gradient conductive member.

### Example 200

Flow cell type reactors are constructed with the electrochemical reactors designated as CR1 to 9, CR12 to 17, CR19 to 24, CR28 to 30, CR95 to 109, CR112 to 117, and CR141 to 155 in the above Table. In the flow cell, an enzyme electrode is employed as the working electrode, a platinum net (Nilaco, 150 mesh) is employed as the counter electrode. As shown in FIG. 8, five sets of a working electrodes and a counter electrode are arranged alternately with interposition of porous polypropylene films (thickness: 20 μm, porosity: 80%) in an acrylic case. Gold wires of 0.1 mm diameter are connected to the electrodes through the case for electric contact, and fixed to the case with a silicone resin to the case. The measurement is conducted by allowing the electrolytic solution to circulate through tubes attached to holes of the acrylic case at a flow rate of 0.5 mL/sec by a precision pump at 37° C. The electrolytic solution contains 0.1M NaCl, 20 mM phosphate buffer, 10 mM glucose, and 10 mM ethanol. In a nitrogen atmosphere, a voltage of 1.5 V is applied for 100 minutes. The products are quantitatively determined by high-speed liquid chromatography. Table 7 shows the results.

TABLE 7

| | | Reference | | | |
|---|---|---|---|---|---|
| | | non- | | | |
| | | flow | Reaction | | Product |
| | Enzyme | type | charge | Reaction | quantity |
| Symbol | electrode | reactor | Mc | product | μmol |
| CRF1 | Ex 1 | CR1 | 53000 | Gluconolactone | 540 |
| CRF2 | Ex 2 | CR2 | 53000 | Acetaldehyde | 500 |
| CRF3 | Ex 3 | CR3 | 130000 | Gluconolactone | 1300 |
| CRF4 | Ex 4 | CR4 | 100000 | Acetaldehyde | 990 |
| CRF5 | Ex 5 | CR5 | 42000 | Gluconolactone | 410 |
| CRF6 | Ex 6 | CR6 | 29000 | Acetaldehyde | 270 |
| CRF7 | Ex 9 | CR7 | 88000 | Gluconolactone | 910 |
| CRF8 | Ex 10 | CR8 | 78000 | Gluconolactone | 800 |
| CRF9 | Ex 11 | CR9 | 72000 | Gluconolactone | 680 |
| CRF10 | Ex 14 | CR12 | 49000 | Gluconolactone | 490 |
| CRF11 | Ex 15 | CR13 | 12000 | Gluconolactone | 110 |
| CRF12 | Ex 16 | CR14 | 34000 | Gluconolactone | 340 |
| CRF13 | Ex 17 | CR15 | 230000 | Gluconolactone | 2300 |
| CRF14 | Ex 18 | CR16 | 48000 | Gluconolactone | 460 |
| CRF15 | Ex 19 | CR17 | 21000 | Gluconolactone | 200 |
| CRF16 | Ex 22 | CR19 | 39000 | Gluconolactone | 370 |
| CRF17 | Ex 23 | CR20 | 19000 | Gluconolactone | 180 |
| CRF18 | Ex 24 | CR21 | 56000 | Gluconolactone | 530 |
| CRF19 | Ex 27 | CR22 | 140000 | Acetaldehyde | 1300 |
| CRF20 | Ex 29 | CR23 | 150000 | Gluconolactone | 1500 |
| CRF21 | Ex 30 | CR24 | 19000 | Gluconolactone | 190 |
| CRF22 | Ex 35 | CR28 | 88000 | Acetaldehyde | 830 |
| CRF23 | Ex 37 | CR29 | 270000 | Gluconolactone | 2800 |
| CRF24 | Ex 38 | CR30 | 36000 | Gluconolactone | 340 |
| CRF25 | Ex | CR95 | 130000 | Acetaldehyde | 1200 |
| | 118 | | | | |
| CRF26 | Ex | CR96 | 350000 | Gluconolactone | 3500 |
| | 120 | | | | |
| CRF27 | Ex | CR97 | 52000 | Gluconolactone | 520 |
| | 121 | | | | |
| CRF28 | Ex | CR98 | 24000 | Acetaldehyde | 240 |
| | 122 | | | | |
| CRF29 | Ex | CR99 | 61000 | Gluconolactone | 600 |
| | 124 | | | | |
| CRF30 | Ex | CR100 | 12000 | Gluconolactone | 120 |
| | 125 | | | | |
| CRF31 | Ex | CR101 | 17000 | Gluconolactone | 170 |
| | 126 | | | | |
| CRF32 | Ex | CR102 | 42000 | Acetaldehyde | 420 |
| | 127 | | | | |
| CRF33 | Ex | CR103 | 9300 | Gluconolactone | 95 |
| | 128 | | | | |
| CRF34 | Ex | CR104 | 29000 | Acetaldehyde | 290 |
| | 129 | | | | |
| CRF35 | Ex | CR105 | 61000 | Gluconolactone | 620 |
| | 130 | | | | |
| CRF36 | Ex | CR106 | 11000 | Acetaldehyde | 110 |
| | 131 | | | | |
| CRF37 | Ex | CR107 | 4200 | Gluconolactone | 40 |
| | 134 | | | | |
| CRF38 | Ex | CR108 | 14000 | Gluconolactone | 140 |
| | 135 | | | | |
| CRF39 | Ex | CR109 | 44000 | Gluconolactone | 450 |
| | 136 | | | | |
| CRF40 | Ex | CR112 | 6100 | Gluconolactone | 58 |
| | 139 | | | | |
| CRF41 | Ex | CR113 | 25000 | Gluconolactone | 240 |
| | 140 | | | | |
| CRF42 | Ex | CR114 | 69000 | Gluconolactone | 700 |
| | 141 | | | | |
| CRF43 | Ex | CR115 | 9400 | Gluconolactone | 96 |
| | 142 | | | | |
| CRF44 | Ex | CR116 | 41000 | Gluconolactone | 400 |
| | 143 | | | | |
| CRF45 | Ex | CR117 | 31000 | Gluconolactone | 310 |
| | 144 | | | | |
| CRF46 | Ex | CR141 | 110000 | Acetaldehyde | 1000 |
| | 176 | | | | |
| CRF47 | Ex | CR142 | 240000 | Gluconolactone | 2400 |
| | 178 | | | | |
| CRF48 | Ex | CR143 | 47000 | Gluconolactone | 470 |
| | 179 | | | | |
| CRF49 | Ex | CR144 | 99000 | Acetaldehyde | 990 |
| | 180 | | | | |
| CRF50 | Ex | CR145 | 250000 | Gluconolactone | 2400 |
| | 182 | | | | |
| CRF51 | Ex | CR146 | 53000 | Gluconolactone | 530 |
| | 183 | | | | |
| CRF52 | Ex | CR147 | 140000 | Acetaldehyde | 1400 |
| | 184 | | | | |
| CRF53 | Ex | CR148 | 290000 | Gluconolactone | 2900 |
| | 186 | | | | |
| CRF54 | Ex | CR149 | 58000 | Gluconolactone | 590 |
| | 187 | | | | |
| CRF55 | Ex | CR150 | 87000 | Acetaldehyde | 830 |
| | 188 | | | | |
| CRF56 | Ex | CR151 | 190000 | Gluconolactone | 2000 |
| | 190 | | | | |
| CRF57 | Ex | CR152 | 30000 | Gluconolactone | 290 |
| | 191 | | | | |
| CRF58 | Ex | CR153 | 85000 | Acetaldehyde | 810 |
| | 192 | | | | |
| CRF59 | Ex | CR154 | 210000 | Gluconolactone | 2100 |
| | 194 | | | | |
| CRF60 | Ex | CR155 | 45000 | Gluconolactone | 440 |
| | 195 | | | | |

Ex: Example

The flow cell type electrochemical reactor gives a larger reaction charge quantity and a larger reaction product quantity than the comparative corresponding ones shown in Table 6 employing a corresponding conductive member, carrier, mediator, enzyme, and substrate by a factor of nearly 3. This shows the possibility of shortening of the reaction time by the flow cell structure. Further, among the chemical reactors of the flow cell structure, the chemical reactors employing a void size-gradient conductive member having numerous voids designated as CRF49 to 54 and CRF58 to 60 give a larger reaction charge quantity and a larger product quantity than the comparative corresponding fuel cells having no void-size gradient. This shows possibility of still further shortening the reaction time by use of the void size-gradient conductive member with the flow cell type of the chemical reactor.

This application claims priority from Japanese Patent Application Nos. 2004-216287 filed Jul. 23, 2004 and 2005-023520 filed Jan. 31, 2005, which are hereby incorporated by reference herein.

1. An enzyme electrode having a conductive member and an enzyme, wherein the conductive member has a porous structure, and the enzyme is immobilized through a carrier in pores constituting the porous structure.

2. The enzyme electrode according to claim 1, wherein the size of the pores on the surface side of porous structure of the conductive member is larger than the size of the pores in the interior of the conductive member.

3. The enzyme electrode according to claim 1, wherein the enzyme electrode contains a mediator for promoting transfer of electrons between the enzyme and the conductive member.

4. The enzyme electrode according to claim 1 or 2, wherein the conductive member comprises at least one of materials selected from metals, conductive polymers, metal oxides, and carbonaceous materials.

5. The enzyme electrode according to claim 1, wherein the enzyme is a redox enzyme.

6. The enzyme electrode according to claim 1, wherein the conductive member has at least two working faces opposing each other, and a liquid is permeable through the numerous voids between the two faces.

7. An enzyme electrode device, comprising the enzyme electrode set forth in claim 6, and wiring connected to the conductive member of the enzyme electrode.

8. The enzyme electrode device according to claim 7, wherein plural enzyme electrodes are laminated with the working faces thereof opposed.

9. A sensor, employing the enzyme electrode device set forth in claim 7 or 8 as a detector for detecting a substance.

10. A fuel cell having an anode and a cathode, and a region for retaining an electrolytic solution between the anode and cathode, wherein at least one of the anode and the cathode is the enzyme electrode device set forth in claim 7 or 8.

11. An electrochemical reactor having a reaction region, and an electrode for causing an electrochemical reaction of a source material introduced to the reaction region, wherein the electrode is the enzyme electrode device set forth in claim 7 or 8.

12. A process for producing an enzyme electrode, comprising steps of:
providing a conductive member having numerous voids communicating with each other and communicating with the outside, and a carrier for immobilizing an enzyme for transfer of electrons to or from the conductive member; and
immobilizing the enzyme in the voids with immobilization of the carrier in the voids.

13. A fuel cell, wherein an anode and a cathode have a porous structure, and at least one of the anode and the cathode is an enzyme electrode having an enzyme in pores constituting the porous structure.

14. The fuel cell according to claim 13, wherein the size of the pores on the surface side of the enzyme structure is larger than the size of the pores in the interior of the enzyme electrode.
